(19) United States
(12) Patent Application Publication
(10) Pub. No.: US 2006/0122881 A1
(43) Pub. Date: Jun. 8, 2006

(54) Systems and methods for vending promotions

(76) Inventors: Jay S. Walker, Ridgefield, CT (US); Daniel E. Tedesco, Huntington, CT (US); Paul T. Breitenbach, Wilton, CT (US); Paul D. Signorelli, Ridgefield, CT (US); Sih Y. Lee, Northvale, NJ (US)

Correspondence Address: WALKER DIGITAL, 2 HIGH RIDGE PARK, STAMFORD, CT, 06905, US

(21) Appl. No.: 11/282,525

(22) Filed: Nov. 18, 2005

Related U.S. Application Data
(63) Continuation-in-part of application No. 10/855,247, filed on May 27, 2004.
(63) Continuation-in-part of application No. 10/902,397, filed on Jul. 29, 2004.
(63) Continuation-in-part of application No. 09/713,001, filed on Nov. 17, 2000, now abandoned.
Application No. 10/902,397 is a continuation-in-part of application No. 09/218,085, filed on Dec. 22, 1998.
Application No. 09/218,085 is a continuation-in-part of application No. 08/947,798, filed on Oct. 9, 1997.
Application No. 09/218,085 is a continuation-in-part of application No. 08/920,116, filed on Aug. 26, 1997, now Pat. No. 6,119,099.
Application No. 08/920,116 is a continuation-in-part of application No. 08/822,709, filed on Mar. 21, 1997, now Pat. No. 6,267,670.
Application No. 09/218,085 is a continuation-in-part of application No. 09/012,163, filed on Jan. 22, 1998, now Pat. No. 6,397,193.
Application No. 09/012,163 is a continuation-in-part of application No. 08/947,798, filed on Oct. 9, 1997.
Application No. 09/012,163 is a continuation-in-part of application No. 08/920,116, filed on Aug. 26, 1997, now Pat. No. 6,119,099.
Application No. 08/920,116 is a continuation-in-part of application No. 08/822,709, filed on Mar. 21, 1997, now Pat. No. 6,267,670.
Application No. 10/902,397 is a continuation-in-part of application No. 10/095,372, filed on Mar. 11, 2002.
Application No. 10/095,372 is a continuation-in-part of application No. 09/012,163, filed on Jan. 22, 1998, now Pat. No. 6,397,193.
Application No. 09/012,163 is a continuation-in-part of application No. 08/947,798, filed on Oct. 9, 1997.
Application No. 09/012,163 is a continuation-in-part of application No. 08/920,116, filed on Aug. 26, 1997, now Pat. No. 6,119,099.
Application No. 08/920,116 is a continuation-in-part of application No. 08/822,709, filed on Mar. 21, 1997, now Pat. No. 6,267,670.
(60) Provisional application No. 60/473,815, filed on May 28, 2003.
(60) Provisional application No. 60/560,960, filed on Apr. 9, 2004.
(60) Provisional application No. 60/491,215, filed on Jul. 30, 2003.
(60) Provisional application No. 60/536,277, filed on Jan. 13, 2004.
(60) Provisional application No. 60/226,830, filed on Aug. 22, 2000.
(60) Provisional application No. 60/243,153, filed on Oct. 25, 2000.

(51) Int. Cl. G06Q 30/00

(52) U.S. Cl. 705/14

(57) ABSTRACT

According to some embodiments, systems, methods, and/or articles of manufacture are associated with determining a mystery package, wherein the mystery package comprises a first mystery product and a second mystery product. In some embodiments, the first and second mystery products are selected based at least in part on sales data associated with a plurality of products sold via a vending machine. Some embodiments describe determining a price for the mystery package. In some embodiments, the price for the mystery package is different than the sum of individual respective prices of the first and second mystery products. Some embodiments describe offering the mystery package for the determined mystery package price to a customer of the vending machine. Some embodiments describe receiving an indication of an acceptance of the mystery package offer by the customer and dispensing the at least two mystery products to the customer.

### CROSS-REFERENCE TO RELATED APPLICATIONS

This application is a continuation-in-part that claims priority and benefit under 35 U.S.C. §120 to:

(I) commonly owned, co-pending U.S. patent application Ser. No. 10/855,247 entitled “METHOD AND APPARATUS FOR MANAGING VENDING MACHINE OFFERS” filed May 27, 2004, which claims priority to: (A) U.S. Patent Application Ser. No. 60/473,815 entitled “METHOD AND APPARATUS FOR MANAGING VENDING MACHINE OFFERS” filed on May 28, 2003, and

(II) commonly owned, co-pending U.S. patent application Ser. No. 10/902,397 entitled “PRODUCTS AND PROCESSES FOR VENDING A PLURALITY OF PRODUCTS” filed Jul. 29, 2004, which claims priority to: (A) U.S. Patent Application Ser. No. 60/560,960 entitled “PRODUCTS AND PROCESSES FOR VENDING A PLURALITY OF PRODUCTS VIA DEFINED GROUPS” filed Apr. 9, 2004, (B) U.S. Patent Application Ser. No. 60/491,215 entitled “APPARATUS, SYSTEM AND METHOD FOR VENDING A COMBINATION OF PRODUCTS” filed Jul. 30, 2003, and (C) U.S. Patent Application Ser. No. 60/536,277 entitled “APPARATUS, SYSTEM AND METHOD FOR VENDING A COMBINATION OF PRODUCTS” filed Jan. 13, 2004, and is a continuation-in-part of: (D) U.S. patent application Ser. No. 09/713,001 entitled “SYSTEM FOR VENDING PHYSICAL AND INFORMATION ITEMS” filed on Nov. 17, 2000, now abandoned, which claims priority to: (i) U.S. Patent Application Ser. No. 60/226,830 entitled “METHOD AND APPARATUS FOR OPERATING A VENDING MACHINE” filed on Aug. 22, 2000, and (ii) U.S. Patent Application Ser. No. 60/243,153 entitled “SYSTEM FOR VENDING PHYSICAL AND INFORMATION ITEMS” filed on Oct. 25, 2000, (E) U.S. patent application Ser. No. 09/218,085 entitled “METHOD AND APPARATUS FOR VENDING PRODUCTS” filed on Dec. 22, 1998, which is a continuation-in-part of: (i) U.S. patent application Ser. No. 08/947,798 entitled “METHOD AND APPARATUS FOR DYNAMICALLY MANAGING VENDING MACHINE INVENTORY PRICES” filed on Oct. 9, 1997, (ii) U.S. patent application Ser. No. 08/920,116 entitled “METHOD AND SYSTEM FOR PROCESSING SUPPLEMENTARY PRODUCT SALES AT A POINT-OF-SALE TERMINAL” filed on Aug. 26, 1997, which issued as U.S. Pat. No. 6,119,099 on Sep. 12, 2000, and which is a continuation-in-part of: (a) U.S. patent application Ser. No. 08/822,709 entitled “SYSTEM AND METHOD FOR PERFORMING LOTTERY TICKET TRANSACTIONS UTILIZING POINT-OF-SALE TERMINALS” filed on Mar. 21, 1997, which issued as U.S. Pat. No. 6,267,670 on Jul. 31, 2001, and (iii) U.S. patent application Ser. No. 09/012,163 entitled “METHOD AND APPARATUS FOR AUTOMATICALLY VENDING A COMBINATION OF PRODUCTS” filed on Jan. 22, 1998, which issued as U.S. Pat. No. 6,397,193 on May 28, 2002, and which is a continuation-in-part of: (a) U.S. patent application Ser. No. 08/947,798 entitled “METHOD AND APPARATUS FOR DYNAMICALLY MANAGING VENDING MACHINE INVENTORY PRICES” filed on Oct. 9, 1997, and (b) U.S. patent application Ser. No. 08/920,116 entitled “METHOD AND SYSTEM FOR PROCESSING SUPPLEMENTARY PRODUCT SALES AT A POINT-OF-SALE TERMINAL” filed on Aug. 26, 1997, which issued as U.S. Pat. No. 6,119,099 on Sep. 12, 2000, and which is a continuation-in-part of: (1) U.S. patent application Ser. No. 08/822,709 entitled “SYSTEM AND METHOD FOR PERFORMING LOTTERY TICKET TRANSACTIONS UTILIZING POINT-OF-SALE TERMINALS” filed on Mar. 21, 1997, which issued as U.S. Pat. No. 6,267,670 on Jul. 31, 2001, and (F) U.S. patent application Ser. No. 10/095,372 entitled “METHOD AND APPARATUS FOR VENDING A COMBINATION OF PRODUCTS” filed on Mar. 11, 2002, which is a continuation-in-part of: (i) U.S. patent application Ser. No. 09/012,163 entitled “METHOD AND APPARATUS FOR AUTOMATICALLY VENDING A COMBINATION OF PRODUCTS” filed on Jan. 22, 1998, which issued as U.S. Pat. No. 6,397,193 on May 28, 2002, and which is also a continuation-in-part of: (a) U.S. patent application Ser. No. 08/947,798 entitled “METHOD AND APPARATUS FOR DYNAMICALLY MANAGING VENDING MACHINE INVENTORY PRICES” filed on Oct. 9, 1997, and (b) U.S. patent application Ser. No. 08/920,116 entitled “METHOD AND SYSTEM FOR PROCESSING SUPPLEMENTARY PRODUCT SALES AT A POINT-OF-SALE TERMINAL” filed on Aug. 26, 1997, which issued as U.S. Pat. No. 6,119,099 on Sep. 12, 2000, and which is a continuation-in-part of: (1) U.S. patent application Ser. No. 08/822,709 entitled “SYSTEM AND METHOD FOR PERFORMING LOTTERY TICKET TRANSACTIONS UTILIZING POINT-OF-SALE TERMINALS” filed on Mar. 21, 1997, which issued as U.S. Pat. No. 6,267,670 on Jul. 31, 2001.

The entirety of each of the above-referenced applications is incorporated by reference herein.

### BACKGROUND

Traditional vending machines provide sellers with the ability to offer products to consumers in an automated fashion, thereby allowing the sale of products at places where face-to-face retailing efforts are not practical (e.g., the lobby of an office building) and at times inconvenient for traditional retailers (e.g., 3:00 AM on a Tuesday morning). However, traditional vending machines do not permit the flexibility enjoyed by human retailers in dynamically responding to changes in supply and demand.

Applicants have previously recognized that significant benefits ensue from vending machines configured to dynamically respond to market forces. For example, Applicants' co-pending U.S. patent application Ser. No. 08/947,798 entitled “METHOD AND APPARATUS FOR DYNAMICALLY MANAGING VENDING MACHINE INVENTORY PRICES” filed Oct. 9, 1997, enables the automated, dynamic pricing of vended products based on stored rules that consider up-to-date supply and demand data gathered when no human salesperson is present. Further, Applicant's co-pending U.S. patent application Ser. No. 10/095,372 entitled “METHOD AND APPARATUS FOR VENDING A COMBINATION OF PRODUCTS” filed Mar. 11, 2002, enables the automated, dynamic configuration of promotional product combinations based on supply and demand data. Further still, Applicant's co-pending U.S. patent application Ser. No. 09/218,085 entitled “METHOD AND APPARATUS FOR VENDING PRODUCTS” filed Dec. 22, 1998, enables the automatic selection of products for customers based on supply and demand data.

The advantages of the inventions described in the above-referenced applications are significant. However, given the complexity of the marketplace, an ongoing need exists for vending machine systems and methods that dynamically respond to market forces. An ongoing need exists, for example, for vending machine systems and methods that dynamically institute promotional tactics in a beneficial manner (e.g., in a manner that increases overall machine profit). More specifically, an ongoing need exists for systems and methods for vending mystery promotions, particularly in a manner that preserves the effectiveness of a mystery promotion. Further, an ongoing need exists for providing intelligent dispensing of multiple products associated with a promotion.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2A, FIG. 2B, and FIG. 2C are block diagrams of various configurations of a system according to some embodiments;

FIG. 3 is a diagram illustrating an example of the external appearance of a vending machine according to some embodiments;

FIG. 4 is a block diagram of a system according to some embodiments;

FIG. 5A and FIG. 5B are schematic block diagrams of exemplary configurations of software architecture according to some embodiments;

FIG. 6A and FIG. 6B are data table diagrams illustrating an example data structure according to some embodiments;

FIG. 7A is a data table diagram illustrating an example data structure according to some embodiments;

FIG. 7B is a block diagram of an exemplary vending machine inventory-dispensing configuration according to some embodiments;

FIG. 8 is a data table diagram illustrating an example data structure according to some embodiments;

FIG. 9A and FIG. 9B are data table diagrams illustrating an example data structure according to some embodiments;

FIG. 10 is a data table diagram illustrating an example data structure according to some embodiments;

FIG. 11 is a data table diagram illustrating an example data structure according to some embodiments;

FIG. 12 is a data table diagram illustrating an example data structure according to some embodiments;

FIG. 13 is a data table diagram illustrating an example data structure according to some embodiments;

FIG. 14 is a flow diagram of a method according to some embodiments;

FIG. 15 is a flow diagram of a method according to some embodiments;

FIG. 16 is a flow diagram of a method according to some embodiments;

FIG. 17 is a flow diagram of a method according to some embodiments;

FIG. 18 is a flow diagram of a method according to some embodiments; and

FIG. 19 is a flow diagram of a method according to some embodiments.

### DETAILED DESCRIPTION

### I. INTRODUCTION

Applicants have recognized that, in some situations, it may be advantageous to output a mystery promotion to a customer of a vending machine, the mystery promotion being distinct from a general offer to sell specified products from the vending machine at posted prices. Applicants have further recognized that, in some situations, such a mystery promotion may be utilized to manage the profitability of a vending machine. Applicants have further recognized that, in some situations, taking into account certain information when determining such a mystery promotion may aid in the management of the profitability of the vending machine. Such information may comprise, for example, information regarding a current inventory of a vending machine, an expected restocking of the vending machine, a current coin inventory of the vending machine, at least one transaction previously completed at the vending machine (such as a previous transaction with an identified customer), and/or a transaction currently initiated at the vending machine.

Applicants have yet further recognized that, in some situations, multiple such mystery promotions may be possible and thus it can be beneficial to have software and/or other means operable to select which, if any, of the possible mystery promotions to output. Such means may, for example, enable an efficient process for selecting the mystery promotion that is likely to result in the most profit and/or revenue for a vending machine and/or that is most likely to be accepted by a customer of the vending machine.

Applicants have yet further recognized that, in some situations, such mystery promotions may become predictable by virtue of the ways in which products comprising the mystery promotions may be selected. Applicants have recognized that it may be desirable to preserve and/or enhance the effectiveness of a mystery promotion by substantially reducing the possibility that the same or similar (e.g., same category) products will be included in a mystery promotion (e.g., at least with respect to a mystery promotion offered to a repeat customer).

Applicants have yet further realized that, in some situations, when multiple products are dispensed from a vending machine (or multiple vending machines) pursuant to a single transaction, such products may collide (e.g., causing damage and/or mechanical failure) and/or may otherwise encounter difficulties or complications. Applicants have recognized that, in such situations, intelligent vending procedures should be utilized to reduce the possibility of (and/or prevent) such collisions and/or complications.

With these and other advantages and features of some embodiments that will become hereinafter apparent, the nature of these embodiments may be more clearly understood by reference to the following detailed description of the invention, the appended claims, and to the several drawings included herein.

In the following description, reference is made to the accompanying drawings that form a part hereof, and in which is shown, by way of illustration, specific embodiments in which the invention may be practiced. These embodiments are described in sufficient detail to enable those skilled in the art to practice the invention, and it is to be understood that other embodiments may be utilized and that structural, logical, software, firmware, electrical, and/or other changes may be made without departing from the scope of the present invention. The following description is, therefore, not to be taken in a limiting sense.

According to some embodiments, a mystery promotion redeemable at a vending machine is determined, the mystery promotion comprising an offer distinct from a general offer to sell particular products from the vending machine at posted prices. The mystery promotion is then caused to be output. In some embodiments, the mystery promotion may comprise an offer of a mystery package promotion. According to some embodiments, various products comprising and/or associated with a mystery promotion (such as mystery products comprising a mystery package promotion) may be dispensed in an intelligent manner. Multiple products may be dispensed, for example, in a manner that substantially avoids product collisions (e.g., in mid-air, on shelving, in a delivery bin, and/or in a product hopper) and/or other dispensing complications.

According to some embodiments, a peripheral device associated with a vending machine may determine, based on current inventory and/or sales data associated with the products available from the vending machine, that it may be desirable to promote the sale of a certain slow-selling, low or high margin, short shelf life, and/or unpopular product in order to increase the profits of the vending machine for a current sales period. Accordingly, the peripheral device may determine that it would be beneficial to promote the slow-selling (and/or otherwise categorized) product by either (i) promoting the slow-selling product as an alternate product to a product selected by a customer (e.g., as a mystery product promotion) or (ii) by offering the slow-selling product in a package (e.g., a mystery package promotion) along with a more popular, longer shelf life, and/or higher or lower margin product.

In some embodiments, the mystery package price may be less than the sum of the retail prices of the two or more component products. The peripheral device may select one of these possible mystery promotions by, for example, calculating an expected profit value for each and selecting the one with the highest expected profit value. The peripheral device may then output, via an output device of the peripheral device, an indication of the selected mystery promotion informing customers of the vending machine that the products (e.g., unidentified products and/or products identified only by type, class, or group) are available for a mystery package price. In some embodiments, the identities of the individual products may be concealed from the customer prior to (i) the acceptance of the mystery promotion, (ii) the purchase of the mystery promotion, (iii) the dispensing of the products, and/or (vi) opening of at least one product wrapper or packaging of the products by the customer. According to some embodiments, the peripheral device may direct a processor of the vending machine to cause an output device of the vending machine to output the mystery promotion.

According to some embodiments, an occurrence of a predetermined event may be determined. An instance of a mystery promotion may be constructed in response to the determination of the predetermined event. The instance of the mystery promotion may comprise an offer distinct from a general offer to sell products from the vending machine at posted prices. The instance of the mystery promotion may be constructed based on (i) at least one of data associated with transactions completed at a vending machine and data associated with a transaction currently initiated at the vending machine; and (ii) a predetermined goal stored in a memory. The instance of the mystery promotion may then be output via an output device of the vending machine.

For example, it may be determined that a coin inventory of a vending machine is lower than a predetermined threshold. Accordingly, in order to conserve the current inventory of coins and avoid requiring “exact change only” for future transactions, it may be determined that an offer for an additional product (e.g., a mystery product or package) in exchange for any change due should be output to a customer who deposits more money than required for a selected product. Thus, when a customer inputs one dollar ($1.00) and selects for purchase a product associated with a retail price of sixty-five cents ($0.65), the vending machine may determine a mystery promotion that offers to the customer an additional product (a mystery product) and/or a mystery package in exchange for the thirty-five cents ($0.35) that is otherwise due the customer. The additional mystery product and/or mystery package may be determined, for example, based on the selected product. For example, a complementary mystery product may be selected (e.g., if the customer selects a snack, the additional product may be a mystery drink).

In accordance with some embodiments, systems, methods, articles of manufacture, and apparatus are disclosed for managing the profitability of a vending machine by constructing mystery promotions and/or creating mystery packages based on an evaluation of sales data in light of criteria including but not limited to stored, or dynamically generated, rules.

According to some embodiments, sales and/or cost data is monitored and compared to a profit goal. If a forecast based on the sales and/or cost data indicates that the profit goal will likely not be reached within a predefined period (e.g., by a restock date), a determination is made as to which of several possible mystery promotion types (and/or products to include in a package promotion) may be appropriate for the circumstances based on stored rules. Several mystery promotion types are disclosed herein, including (i) combination product promotions (including fixed and open-ended combinations), (ii) subscription promotions, (iii) dynamically priced upsell promotions, in which customers are offered the opportunity to purchase products for an amount equal to the change due from a first, triggering transaction, (iv) fixed-price upsell promotions, in which customers are offered the opportunity to purchase products for an amount that may require more or less than the change due from a first, triggering transaction, and (v) alternate product promotions, which may attempt to cause the customer to switch to a product offered by the vending machine. For each potential mystery promotional type, a hypothetical mystery promotion instance may be constructed based on stored rules (e.g., a potential offer to sell an additional candy bar for thirty-five cents ($0.35)), and an expected profit associated with each hypothetical mystery promotion instance may be calculated (e.g., ten cents ($0.10)). According to the relative expected profitability of the constructed hypothetical mystery promotion instances, at least one promotional instance is selected and used as the basis for a mystery promotion to a customer.

Specifically and in accordance with one embodiment, the mystery promotion may be executed by (a) determining a mystery package, wherein the mystery package comprises at least two mystery products having individual respective prices, and wherein the at least two mystery products are selected based at least in part on sales data associated with a plurality of products sold via a vending machine, (b) determining a price for the mystery package, wherein the price for the mystery package is different than the sum of the individual respective prices of the at least two mystery products, (c) offering the mystery package for the determined mystery package price to a customer of the vending machine, wherein the identities of the at least two mystery products comprising the mystery package are concealed from the customer, (d) receiving an indication of an acceptance of the mystery package offer by the customer, (e) dispensing the at least two mystery products to the customer, and (f) recording sales data. The recorded sales data may in turn be used in subsequent promotion construction processes.

In some embodiments, the determination of whether a mystery promotion is appropriate is made periodically or substantially continuously, so that promotional offers can be offered to prospective customers before a transaction is initiated (“proactive promotions”). In other embodiments, the determination of whether a mystery promotion is appropriate may be made following the initiation of a transaction by a customer (“reactive promotions”).

Thus, utilizing embodiments described herein, a vending machine's profit per fill period may be increased. Specifically, rules for determining available mystery promotion types, selecting products to form mystery package promotions, constructing hypothetical mystery promotion instances, and/or selecting a mystery promotion from several hypothetical mystery promotion instances are designed to, in some embodiments, (i) increase sales volume and/or velocity while not undermining overall machine profitability through “dilution” and/or “diversion” effects, and/or (ii) preserve an available coin inventory so that change can be provided to an increased number of customers during a fill period.

### II. TERMS AND DEFINITIONS

Throughout the description that follows and unless otherwise specified, the following terms may include and/or encompass the example meanings provided in this section. These terms and illustrative example meanings are provided to clarify the language selected to describe embodiments both in the specification and in the appended claims.

Some embodiments described herein are associated with a “control system”. As used herein, the term “control system” may generally refer to any combination of hardware, software, firmware, and/or microcode that is operative to carry out and/or facilitate embodiments described herein. For example, a control system may comprise a processor performing instructions of a program to offer various promotions such as mystery package promotions to a customer. The control system may also or alternatively be configured to incorporate logic and/or rules to intelligently dispense vending machine products. The control system may comprise, according to some embodiments, a single device and/or component or may comprise any practicable number of networked devices.

Some embodiments described herein are associated with a “network device”. As used herein, the term “network device” may generally refer to any device that can communicate via a network. Examples of network devices include a Personal Computer (PC), a workstation, a server, a printer, a scanner, a facsimile machine, a copier, a Personal Digital Assistant (PDA), a storage device (e.g., a disk drive), a hub, a router, a switch, and a modem or a wireless phone. In some embodiments, network devices may comprise one or more network components, such as a Static Random Access Memory (SRAM) device or module, a network processor, and/or a network communication path, connection, port, or cable. Some examples of network devices may include, but are not limited to, servers or controllers, customer devises, vending machines, input devices, output devices, and peripheral devices.

As used herein, the terms “server” and “controller” may be used interchangeably and may generally refer to any device that may communicate with one or more vending machines, one or more third-party servers, one or more remote controllers, one or more customer devices, one or more peripheral devices and/or other network nodes, and may be capable of relaying communications to and/or from each such device. A controller or sever may, for example, comprise one or more network devices and/or components.

As used herein, the terms “customer device” and “user device” may be used interchangeably and may generally refer to any device owned and/or operated by, or otherwise associated with a customer, which device is capable of accessing and/or outputting online and/or offline content. Customer devices may communicate with one or more servers or controllers, one or more vending machines, one or more third-party service provider servers, one or more user terminals, and/or other network devices or nodes. In some embodiments, customer devices may, for example, include gaming devices, PC devices, PDA devices, Point-Of-Sale (POS) terminals, point of display terminals, kiosks, telephones, cellular phones, Automated Teller Machines (ATM) devices, pagers, and/or combinations of such devices.

As used herein, the term “vending machine” may generally refer to any system, apparatus, and/or module that is operable to provide and/or facilitate the provision of goods and/or services to customers. Vending machines may include, but are not limited to, for example, one or more stand-alone, networked, automated, mechanical, and/or electrical devices coupled to dispense products such as beverages and/or snacks to customers. In some embodiments, vending machines may comprise, be coupled to, and/or may be otherwise associated with one or more input devices, output devices, and/or peripheral devices (e.g., to operate in accordance with embodiments described herein).

As used herein, the terms “product,” “good,” “item”, “merchandise,” and “service” may be used interchangeably and may generally refer to anything licensed, leased, sold, available for sale, available for lease, available for licensing, and/or offered or presented for sale, lease, or licensing including individual products, packages of products (such as mystery packages), subscriptions to products, contracts, information, services, and intangibles. Examples of goods sold at vending machines may include, but are not limited to: beverages (e.g., cans or bottles of soda or water), snacks (e.g., candy bars), and recordable media (e.g., pre-recorded and/or dynamically-recorded disks or tapes). Examples of services sold by vending machines include car washes, photography services and access to digital content (e.g., permitting the downloading of digital picture, video, and/or audio files such as audio “ring tunes” and/or wallpapers to a handheld device).

As used herein, the term “input device” may generally refer to a device that is used to receive input. An input device may communicate with and/or be part of another device (e.g. a point of sale terminal, a point of display terminal, a customer terminal, a server, a customer device, a vending machine, a controller, and/or a peripheral device). Some examples of input devices include, but are not limited to: a bar-code scanner, a magnetic stripe reader, a computer keyboard, a point-of-sale terminal keypad, a touch-screen, a microphone, an infrared sensor, a sonic ranger, a computer port, a video camera, a motion detector, a digital camera, a network card, a Universal Serial Bus (USB) port, a Global Positioning System (GPS) receiver, a Radio Frequency IDentification (RFID) receiver, a RF receiver, a thermometer, a pressure sensor, and a weight scale or mass balance.

As used herein, the term “output device” may generally refer to a device that is used to output information. An output device may communicate with and/or be part of another device (e.g. a vending machine, a point of sale terminal, a point of display terminal, a customer device, and/or a controller). Possible output devices may include, but are not limited to: a Cathode Ray Tube (CRT) monitor, a Liquid Crystal Display (LCD) screen, a Light Emitting Diode (LED) screen, a printer, an audio speaker, an Infra-red Radiation (IR) transmitter, an RF transmitter, and/or a product hopper, dispenser, and/or data port.

As used herein, the term “peripheral device” may refer to any device associated with one or more vending machines, the peripheral device being operable to perform in accordance with embodiments as described herein. For example, in one embodiment a traditional vending machine may be retrofitted with a peripheral device that comprises a processor, memory, and/or an output device for facilitating promotions such as mystery package promotions in accordance with embodiments described herein. A peripheral device may or may not be attached or coupled to a vending machine. A peripheral device may or may not be operable to direct the associated vending machine to perform certain functions. A peripheral device, or portions thereof, may be housed inside the casing of the associated vending machine. Further, a peripheral device may be operable to detect one or more events at a vending machine. For example, a peripheral device may be operable to detect one or more signals output by a processor of a vending machine. Further still, a peripheral device may be operable to communicate with a processor of an associated vending machine. According to some embodiments, a peripheral device (and/or a vending machine itself) may be configured to conserve coins and/or to facilitate intelligent dispensing of products.

As used herein, the term “coin conservation” may generally refer to the practice of managing the working capital stored in a vending machine, such as by managing an inventory of coins and/or other currency so as to reserve or preserve a minimum amount that can be used to provide customers with change when appropriate. In some embodiments, a vending machine can engage in coin conservation efforts by configuring and outputting one or more promotions to a customer. For example, where a forecast based on current sales patterns indicates that an insufficient number of coins remains in the machine to make correct change for every anticipated transaction, a vending machine control system may execute dynamically priced upsell promotions (where customers are offered additional products for their change due), and thereby engage in coin conservation.

As used herein, the term “intelligent dispensing” may generally refer to any method or device that is operable to substantially reduce or prevent problems associated with the dispensing of products from a vending machine. In the case that physical products are dropped or released from rows or bins of a vending machine into a product hopper accessible to a customer, for example, intelligent dispensing mechanisms may be implemented to substantially prevent multiple dispensed products from colliding with one another. In the case that a service and/or electronic product (such as a music file, ring tone, “skin”, or wallpaper) is dispensed and/or provided via a vending machine, intelligent dispensing mechanisms may be implemented to manage the distribution of services and/or files in a manner that substantially avoids any foreseeable conflicts such as scheduling conflicts, bottlenecks, and/or bandwidth concerns.

In the case that digital files are dispensed, for example, multiple files purchased as a package and/or group may be downloaded, stored, and/or may be accessible together. As opposed to providing multiple download locations, Uniform Resource Locator (URL) addresses, and/or multiple units of recordable media such as Compact Disk (CD) and/or Digital Video Disk (DVD), for example, multiple products may be grouped, stored, packaged, and/or dispensed together. Similarly, multiple digital products may be dispensed separately and/or otherwise in a manner that substantially prevents physical and/or temporal conflicts associated with the dispensing or delivery of the products.

Some embodiments described herein are associated with an “operator”. As used herein, the term “operator” may generally refer to the owner of a vending machine or an agent or associate thereof (e.g., a route driver or lessee of a vending machine). In some embodiments, an operator may also be associated with a server or controller and/or customer devices utilized to implement embodiments described herein. Operators may also or alternatively be associated with the manufacture and/or distribution of one or more products or services provided via a vending machine. According to some embodiments, an operator may be associated with restocking one or more vending machines (e.g., on a restock date and/or at a restock time).

As used herein, the terms “restock date”, “restock time”, “restock event” and “pick-up” may be used interchangeably and may generally refer to the time and/or date that a vending machine is scheduled to be (and/or is) restocked by an operator (or employee or agent thereof) of a vending machine. Physical products (such as soda and snacks) may generally be re-filled locally, while services and digital media products may, according to some embodiments, be replenished and/or restocked remotely. Vending machines may be restocked at pre-defined intervals (e.g., once a week) and/or when one or more products are determined to have low or no remaining inventories.

Some embodiments described herein are associated with a “fill period” or “sales period”. As used herein, the terms “fill period” and “sales period” may be used interchangeably and may generally refer to the period of time between restocking events at a vending machine. The fill period may generally refer to a period associated with all products of a vending machine and/or may be defined in terms associated with a subset of products within the vending machine. In some embodiments, fill periods may be defined separately for each product and/or type of product provided via a vending machine.

Some embodiments described herein are associated with a “full price” or “retail price”. As used herein, the terms “full price” and “retail price” may be used interchangeably and may generally refer to the normal price charged for the purchase of a given product. Typically, promotions present customers with the opportunity to purchase products at less than full price.

Some embodiments described herein are associated with a “minimum selling price”. As used herein, the term “minimum selling price” may refer to the lowest price at which a product may be sold. The minimum selling price may not necessarily reflect the cost of the product to the operator of a vending machine. Thus, the minimum selling price may include an acceptable profit margin. Conversely, the minimum selling price may be set less than the cost of a product to the operator of a vending machine, as may be the case where a promotion or series of promotions would sufficiently offset any loss associated with selling the particular product below cost.

Some embodiments described herein are associated with a “product cost”, “item cost”, or “cost”. As used herein, the terms “product cost”, “item cost”, and “cost” may be used interchangeably and may generally refer to the cost to the operator of a unit of selling a given product. The product cost may reflect the fixed cost and/or the variable cost in selling a unit of the product. In some embodiments, stored rules may instruct a vending machine control system to not sell a product or products unless the cost of the product(s) is equal to or less than a certain price (e.g., a retail price, a package price). In other embodiments, stored rules may instruct a vending machine control system to sell a product or products even though the cost of the product or products is greater than a retail price or package price, as may be the case where the product or products' actual sales rates are above a certain threshold (e.g., where actual sales rates exceed target sales rates).

As used herein, the terms “ideal product velocity”, “target product velocity”, and “target velocity” may be used interchangeably and may generally refer to the desired rate at which a given product should be sold by a vending machine during a period of time (e.g., during a sales period). Thus, in some embodiments, an ideal velocity may be set or calculated for each product indicating the rate at which products must be sold in order to deplete the inventory to a certain level by the end of a given sales period (i.e., by the next restocking event at the vending machine).

For example, an ideal product velocity may be calculated by a vending machine control system after an operator inputs a restock date and a desired remaining inventory for the date. For example, an operator may wish to have only one of each product remaining at the next restocking event so that the vending machine sells as many products as possible without completely selling out and thereby disappointing customers. Thus, in the preceding example, if an operator (a) stocks fifty (50) units of Soda A, (b) inputs a restock date fourteen days away, and (c) indicates that only one unit of Soda A should remain at the restock date, the control system may divide forty-nine (49) by fourteen (14) to conclude that, on average, three and one half (3.5) units must be sold per day within the sales period in order to realize the ideal product velocity.

As described herein, a vending machine control system may periodically, substantially continuously, or otherwise evaluate the difference between a product or products' actual product velocity and ideal product velocity for the purpose of making package offer decisions (e.g., in proactive inventory grouping embodiments, determining which products to assign to a certain inventory group). The actual rate at which a given product should be sold may be expressed in various forms, including units of the product sold per time, sales revenue from sales of units of the product per time, and profit from sales of units of the product per time. An ideal product velocity may be further set so that if such a velocity is reached, the increase in volume will sufficiently offset any discounts afforded to customers through promotions, thereby eliminating or reducing the potential for dilution.

Some embodiments described herein are associated with an “actual product velocity” or an “actual sales rate”. As used herein, the terms “actual product velocity” and “actual sales rate” may be used interchangeably and may generally refer to an actual rate at which a given product is sold by a vending machine during a period of time (e.g., during a sales period). The actual rate may be expressed in various forms such as units sold per time, sales revenue per time, and/or gross profit per time.

As used herein, the term “baseline velocity demand” may generally refer to the total number of products sold at retail price within a particular period of time (e.g., during a particular sales period).

As used herein, the terms “target profit” and “ideal profit” may be used interchangeably and may generally refer to a desired profit to be achieved by a vending machine or group of vending machines. In some embodiments, the profit goal set by an operator of a vending machine.

Some embodiments described herein are associated with an “income contribution factor” or “profit contribution factor”. As used herein, the terms “income contribution factor” and “profit contribution factor” may be used interchangeably and may generally refer to a measure of the revenue or profit realized due to the sale of a particular product. In some embodiments, a product's income contribution factor may be defined by the total amount of revenue or the total amount of profit generated by the product during a certain time period (e.g., during a fill period, between certain dates, every twenty four hours). In other embodiments, a product's income contribution factor may be represented as a percentage, such as that which may be calculated by dividing the amount of profit generated by the product in a certain period of time by the total amount of profit generated by some or all products sold through the vending machine in the time period. For example, if a vending machine realized one hundred dollars ($100) in total profit during a fill period, and a certain product was responsible for generating twelve dollars ($12) of the profit, that product's income contribution factor could be represented as twelve percent (12% or 0.12). In some embodiments, an income contribution factor may be used for the purpose of determining how to allocate a product to one or more inventory groups.

As used herein, the term “Profit Inventory Management (PIM)” may generally refer to the practice of managing the sale of products so as to increase a vending machine's profitability during a period of time (e.g., during a sales period). In some embodiments, a vending machine is programmed to evaluate sales data in light of stored rules indicative of a profit goal. For example, stored rules may indicate an ideal product velocity that would tend to increase the machine's profitability. The machine may determine that, based on current sales data, the ideal product velocity (for a given product or group of products) will not be achieved based on current promotions, prices, or other sales parameters. In response, the vending machine may execute multi-variant equations to identify, construct and offer a promotion to a customer with the goal of achieving the ideal product velocity (for a given product or group of products). In some embodiments, PIM may be utilized to facilitate avoidance and/or reduction of negative profitability factors such as dilution and/or diversion.

As used herein, the terms “dilution” and “price dilution” may be used interchangeably and may generally refer to the negative effect on profitability that ensues when a product is sold for a price lower than a given customer otherwise would have paid for the product. In some embodiments, the potential for dilution is factored into stored rules for constructing promotion instances. Thus, in some embodiments, vending machines may be programmed to eliminate or reduce the effects of dilution by picking those promotion instances that are less likely to result in dilution, or are more likely to result in less dilution.

As used herein, the term “diversion” may generally refer to the negative effect on profitability that ensues when a lower price or lower profit product is sold to a customer instead of a higher price or higher profit product that the customer otherwise would have purchased. In some embodiments, the potential for diversion is factored into stored rules for constructing promotion instances. Thus, in some embodiments, vending machines may be programmed to eliminate or reduce the effects of diversion by picking those promotion instances that are less likely to result in diversion.

As used herein, the term “promotion” may generally refer to a message that is output, regarding some product, distinct from a general offer to sell products from a vending machine at retail prices. For example, a promotion may comprise a message intended to increase machine profitability. Typically, a promotion allows customers to purchase one or more products under terms that are generally more favorable to the customer than standard retail terms (e.g., at prices less than or equal to the corresponding product's full price(s), but greater than or equal to the corresponding product's minimum price(s)).

As used herein, the term “promotion instance” may generally refer to an instance of a potential or hypothetical promotion that may be output (e.g., as a promotion offer to a particular customer). A promotion instance may be constructed and compared to other potential or hypothetical promotion instances for the purpose of determining which one or more promotions will be presented and/or offered to a customer for acceptance. In one or more embodiments, promotion instances are constructed by populating promotion types with data representing inventory in a vending machine.

As used herein, the term “promotion type” may generally refer to the form, format or category of a promotion, as distinguished from the products and/or prices that may be included in a promotion. For example, the form of a promotion may be a “dynamically priced upsell”, meaning that a particular product will be offered to a customer in exchange for the customer's change due from a first, triggering transaction. Thus, one dynamically priced upsell promotion may include Product A, whereas another such promotion may include Product B, but both promotions may be of the “dynamically priced upsell” promotion type.

As used herein, the term “reactive promotion” may generally refer to a promotion that is offered to a customer in response to a customer action, such as the purchase of a product or a request for a promotion. Examples of reactive promotions include dynamically priced upsell offers and fixed-price upsell offers.

As used herein, the terms “fixed price upsell promotion” and “upsell promotion” may be used interchangeably and may generally refer to a promotion to a customer of a first product for the purchase of an additional product in exchange for an additional amount that is not necessarily correlated with an amount of change due back to the customer as a result of the customer's purchase of the first product. In some embodiments, a customer who has purchased a first product and is thereby due change may be required to deposit additional currency in order to accept a fixed price upsell promotion. Thus, the fixed price upsell promotion may require that the customer pay an amount equal to his or her change due plus an additional amount of currency.

As used herein, the terms “dynamically priced upsell promotion”, “dynamic priced upsell promotion”, “roundup deal”, “roundup promotion”, and “spare-change upsell promotion” may be used interchangeably and may generally refer to a promotion to a customer of a first product for the purchase of an additional product in exchange for an additional amount that is equal to an amount of change due back to the customer as a result of the customer's purchase of the first product.

As used herein, the term “proactive promotion” may generally refer to a promotion provided to one or more customers irrespective of customer actions (e.g., promotions offered to customers independent of a first, triggering transaction). For example, a proactive promotion may comprise the offering of a combination product promotion and/or a mystery package promotion to all customers via an output device such as an LCD screen. A proactive promotion may be output, for example, constantly, periodically, randomly and/or only when the presence of a customer is detected at the vending machine.

As used herein, the terms “package deal”, “combination deal”, “package promotion”, “combination promotion”, “combination product promotion”, ““load-up deal”, “value combo deal”, and combo deal” may be used interchangeably and may generally refer to any offer enabling a customer to purchase at least two products. In many embodiments the at least two products are sold for a single price. In many embodiments, the two products are dispensed to the customer essentially simultaneously (e.g., within seconds of each other). Typically, package offers are configured so the price of the at least two products is less than the sum of the prices of the two products, and thus the customer saves money compared to the sum of the individual component products' retail prices. According to some embodiments, customers may be presented with package offers representing one or more package instances determined by a vending machine.

As used herein, the terms “package instance” and “potential package” may be used interchangeably and may generally refer to any combination of specific component products utilized to form a package offer. Thus, a package offer defines one or more (but typically many) package instances. In some embodiments, package instances are constructed and compared to other package instances for the purpose of determining which products may be made available for selection by a customer pursuant to a package offer. In some proactive inventory grouping embodiments, package instances are constructed and compared in order to determine how to apportion inventory between two inventory groups. In some reactive inventory grouping embodiments, package instances are constructed and compared in order to determine the composition of an inventory group from which a customer may select a second component product after a first component product has been selected. In some embodiments, a package instance and/or a package deal may comprise a mystery package deal or instance.

As used herein the term “mystery promotion” may generally refer to any promotion offered to a customer where at least one product comprising and/or associated with the promotion is unknown, at the time of purchase, payment, and/or acceptance, to the customer. In some embodiments, the quantity of items purchased may be a mystery. While a typical package or combination offer may be comprised of a multiple component products, for example, a “mystery” version of the package offer may only comprise a single product (such as one more expensive product as opposed to two lower priced products). Similarly, a mystery promotion may simply comprise a single mystery product. In some embodiments, the type of product and/or products may be a mystery to the customer (e.g., the customer may simply be offered a mystery package for a certain price, without being privy to any more information regarding the package) and/or the specific product identity and/or brand of the product may be a mystery (e.g., the customer may be offered a mystery soda for a certain price, but may not know which brand of soda will be ultimately received by the customer). According to some embodiments, mystery promotions may comprise and/or be associated with upsells, alternate product offers, and the like.

As used herein, the term “package price” may generally refer to the price that is charged (typically in a single transaction) for the units of products purchased pursuant to a package offer (e.g., associated with one or more package instances). Typically, package prices reflect a net-savings to the customer when compared to the sum of the respective retail prices of the individual component products.

Some embodiments described herein are associated with an “inventory group”, “inventory control group”, or a “package group”. As used herein, the terms “inventory group”, “inventory control group”, and “package group” may be used interchangeably and may generally refer to any grouping, set, combination, and/or other association of one or more products. An inventory group may include a single product, or more than one product. In many embodiments, a customer may select a component product from an inventory group. In certain proactive inventory grouping embodiments, pursuant to a package offer, customers may select at least two component products, a component product selected from each of at least two inventory groups, for a single price (e.g., a package price). In reactive inventory grouping embodiments, pursuant to a package offer, customers may select a second component product from an inventory group that is revealed after a first component product is selected from a first inventory group.

In one or more embodiments, inventory groups may be communicated to customers through colored LED devices located proximately to inventoried products (e.g., products in a “red” group may be communicated via proximately located red LED devices; products in a “green” group may be communicated via proximately located green LED devices). In proactive and reactive inventory grouping embodiments, inventory groups may be determined by a vending machine control system during a sales period. In some embodiments, inventory groups are not determined automatically (as in proactive or reactive inventory grouping embodiments), but are rather determined prior to a sales period by an operator or other person, and are stored (e.g., as rules in a database) accessible to a vending machine control system.

According to a “proactive inventory grouping” embodiment, for example, on a periodic, substantially continuous or event-triggered basis, sales and/or cost data is monitored and evaluated against stored rules for the purpose of determining how to apportion inventory among at least two inventory groups from which, pursuant to a package offer, a customer may select and purchase at least two products for a single price. In determining how to apportion inventory to the different inventory groups, a vending machine may consider a value rating of one or more products. For example, products having a relatively high value rating may be allocated to a first inventory group, while products having a relatively low value rating may be allocated to a second inventory group. Thereafter, package offers encouraging the purchase of at least two products (e.g., at least one product from each of at least two inventory groups) may be output to prospective customers through one or more output devices. For example, a scrolling LED display may read “Pick any item from the red group and any item from the green group for $1.00!”, and shelf-mounted LED displays located adjacent to the various qualifying products may contemporaneously flash in red and/or green to indicate the products' inventory grouping statuses (e.g., green or red). The vending machine may be further configured to process package offer transactions in accordance with such advertised package offers by (i) receiving, through an input device, an indication of customer acceptance and (ii) dispensing a combination of products consistent with the advertised package offer.

According to a “reactive inventory grouping” embodiment, a customer is offered the ability to purchase a combination of products for a single price by the customer selecting a first product from a first group of inventoried products, and then the customer picking a second product from a second inventory group that is revealed to the customer after the first product is selected. In determining which inventoried products will be included in the second inventory group, a vending machine may consider a value rating of one or more products.

Further, according to some embodiments, a value rating of one or more products may be determined by considering one or more of (i) the time remaining until a restock date, (ii) the time remaining until an expiration date of a product or products, (iii) an actual sales rate of a product or products, (iv) a target or ideal sales rate of a product or products, (v) the cost of a product or products, (vi) the retail price of an individual unit of a product or products, (vii) the profit margin of a product or products at a given sale price such as the retail price, (viii) the historical acceptance rate of package instance comprising a given combination of products, and/or (ix) one or more products' income or profit contribution factor(s) (e.g., measures of one or more products' historic success in the marketplace).

### III. SYSTEMS AND APPARATUS

### A. Introduction

Generally, a vending machine in accordance with the embodiments described herein may comprise a device, or communicate with a device (e.g., a server, a peripheral device, and/or a peripheral device server), configured to manage sales transactions with customers by, among other things, receiving payment from customers, controlling the pricing and/or distribution of goods and/or controlling entitlements to services.

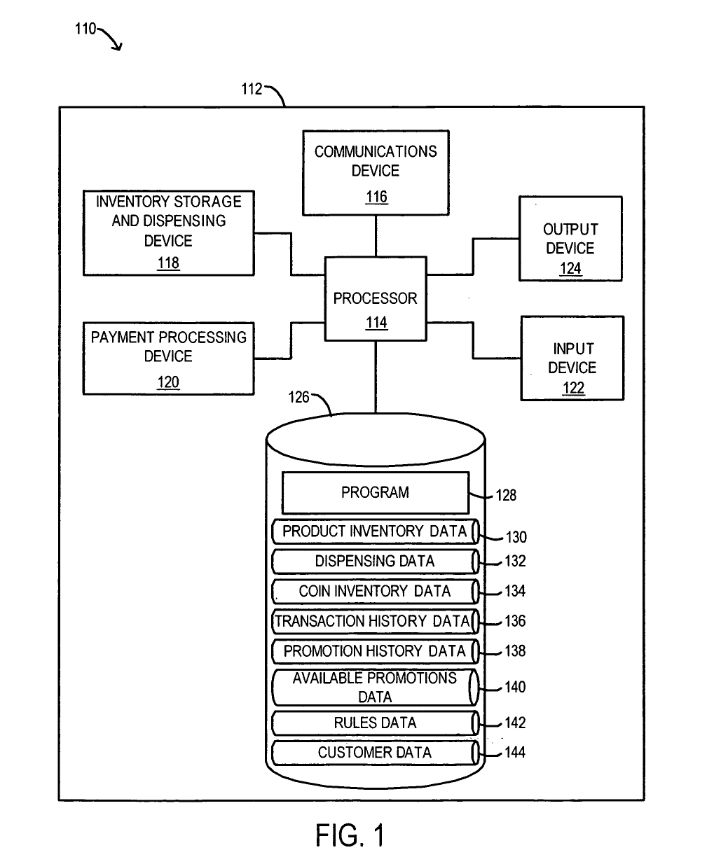

Referring first to FIG. 1, a block diagram of a system 110 according to some embodiments is shown. The system 110 may comprise, for example, a casing 112 enclosing one or more of a processor 114, a communications device 116, an inventory and dispensing device 118, a payment processing device 120, an input device 122, an output device 124, and/or a data storage device 126. According to some embodiments, the system 110 may be a vending machine configured to perform and/or facilitate processes in accordance with embodiments described herein. The vending machine 110 may, for example, be utilized to offer and dispense mystery packages to a customer and/or may be capable of performing intelligent dispensing of products.

### B. Casing/Cabinetry

In some embodiments, a suitable casing 112 and/or cabinetry may be constructed from any suitable material, including but not limited to any combination of (1) commercial grade sixteen-gauge steel (e.g., for exterior panels and internal shelving), (2) transparent materials such as glass or Plexiglas (e.g., for product display windows), (3) rubber (e.g., for waterproofing insulation), (4) plastic, and/or (5) aluminum.

Many commercially available casings 112 may be adapted to work in accordance with various embodiments. For example, in snack machine embodiments, a suitable casing 112 may comprise the 129 SnackShop manufactured by Automatic Products International, Ltd. of Saint Paul, Minn., which stands at seventy-two inches (72″/1829 mm) wide, has a width of thirty-eight and seven eighths inches (38⅞″/988 mm), and a depth of thirty-five inches (35″/889 mm). Other suitable snack machine casings 112 include the A La Carte® machine from Automatic Products, and the GPL SnackVendor model #159 from Crane Merchandising Systems/Crane Co. of Stamford, Conn.

In beverage machine embodiments, casings 112 commercially available from Dixie Narco, Inc. of Williston, S.C. may be employed. Beverage machine casings 112 may comprise a “cooler” or “glass front” style front panel, featuring a transparent front panel (e.g., glass) enabling customers to see inventory for sale. Alternatively, beverage machine casings 112 may comprise a “bubble front” style front panel, featuring a decorative front panel, typically used to advertise a logo of a product manufacturer commercially interested in the operation of the vending machine 110.

Other embodiments are contemplated as well, including combination snack and beverage vending machine embodiments, such as those available from Crain Co. Further details concerning the suitability of machine casings 112 and/or cabinetry are well known in the art, and need not be described in further detail herein.

### C. Processor/Controller

According to some embodiments, the vending machine 110 may include the processor 114 that may be or include any type, quantity, and/or configuration of processor that is or becomes known. The processor 114 may comprise, for example, an Intel® IXP 2800 network processor or an Intel® XEON™ Processor coupled with an Intel® E7501 chipset. In some embodiments, the processor 114 may comprise multiple inter-connected processors, microprocessors, and/or micro-engines. According to some embodiments, the processor 114 may include or be coupled to one or more clocks or timers (not explicitly shown) and to the communication device 116 through which the processor 114 may communicate, in accordance with some embodiments, with other devices such as one or more peripheral devices, one or more servers, and/or one or more user devices. The communication device 116 may, for example, comprise any type or configuration of communication port, cable, modem, and/or signal transceiver that is or becomes known or practicable. In some embodiments, the processor 114 may also or alternatively be in communication with and/or coupled to any number of other components of the vending machine 110 such as the inventory and dispensing mechanism 118, the payment processing mechanism 120, the input device 122, the output device 124, and/or the data storage device 126.

### D. Inventory Storage and Dispensing Device

In some embodiments, the vending machine 110 may comprise the inventory storage and dispensing device 118. The inventory storage and dispensing device 118 may, according to some embodiments, comprise any number and/or configuration of devices and/or components that facilitate and/or are associated with the storage and/or dispensing of products or services available via the vending machine 110. Product inventory storage and product dispensing functions of the vending machine 110 configured in accordance with a snack machine embodiment may include, for example, one or more of: (i) a drive motor, (ii) metal shelves, (iii) a product delivery system (e.g., a chute, product tray, and/or product tray door), (iv) dual spiral (e.g., double helix) item dispensing rods, (v) convertible (e.g., extendable) shelves, and/or (vi) a refrigeration unit. In embodiments using the casing 112 of the model 129 SnackShop manufactured by Automatic Products, three (3) removable shelves may be employed, together providing for thirty (30) product rows and an inventory capacity of between one hundred and eighty-five (185) to five hundred and twenty-two (522) commonly vended snack products.

Inventory storage and distribution functions of the vending machine 110 configured in accordance with a beverage machine embodiment may include one or more conventional components, including: (i) metal and/or plastic shelving, (ii) product dispensing actuators/motors, (iii) product delivery chutes, and/or (iv) a refrigeration unit.

In many types of beverage and snack vending machines, operators will typically stock several units of the same product linearly arranged in a column, allowing individual units to be dispensed upon command. The same product may be stocked in more than one column. Similarly, more than one product may be stocked in a single column. In the case that one or more services are available via the vending machine 110, the inventory storage and dispensing device 118 may comprise any device or component that is associated with the storage, transmission, encoding or decoding (e.g., including encryption and decryption), and/or other processing, routing, or electronic delivery or redemption of such services.

Further details concerning vending machine inventory storage and dispensing devices 118 are well known in the art, and need not be described in further detail herein.

### E. Payment Processing Device

According to some embodiments, the vending machine 110 may comprise the payment processing device 120. The payment processing device 120 may, according to some embodiments, comprise any number and/or configuration of devices and/or components for receiving payment and/or dispensing change, including a coin acceptor, a bill validator, a card reader (e.g., a magnetic stripe reader), and/or a change dispenser.

In some embodiments, a magnetic stripe card reader may read data on a magnetic stripe of a credit or debit card, for example, and it may cooperate with conventional POS credit card processing equipment to validate card-based purchases through a conventional transaction authorization network. Suitable card-based transaction processing systems and methods are available from USA Technologies, Inc.™ of Wayne, Pa. In some embodiments, a coin acceptor, bill validator and/or change dispenser may communicate with and/or be coupled to a currency storage apparatus (a “hopper”; not shown) and may comprise conventional devices such as models AE-2400, MC5000, TRC200 by Mars, Inc.™ of West Chester, Pa., or CoinCO™ model 9300-L.

Coin acceptors and/or bill validators may receive and validate currency that is stored by the currency storage apparatus. Further, a bill validator or coin acceptor may be capable of monitoring stored currency and maintaining a running total of the stored currency, as is discussed with reference to U.S. Pat. No. 4,587,984, entitled “Coin Tube Monitor Means”, the payment and coin-related aspects of which are incorporated by reference herein. According to some embodiments, a change dispenser activates the return of coinage to the customer where appropriate (e.g., where a customer rejects or otherwise fails to accept a dynamically priced upsell offer). Such apparatus may feature Multidrop Bus (MDB) and/or Micromech peripheral capabilities, as are known in the art.

In another embodiment, the vending machine 110 may be configured to receive payment authorization and/or product selection commands or signals through a wireless device communication network (e.g., via the communication device 116), directly or indirectly, from a customer device (e.g., a cellular telephone; not shown). In such an embodiment, the payment processing device 120 may comprise a cellular transceiver operatively connected to the processor 114 to receive, transmit, and/or process such signals. Systems and methods allowing for the selection of and payment for vending machine products via cellular telephones are provided by USA Technologies, Inc.™ Further, in such an embodiment, a customer cellular telephone may serve as an input device 122 and/or an output device 124, as described elsewhere herein.

Further details concerning vending machine payment processing devices 120 are well known in the art, and need not be described in further detail herein.

### F. Input and Output Devices

According to some embodiments, the vending machine 110 may comprise the input device 122 and/or the output device 124. In some embodiments, the input device 122 may be operable to receive input from (i) a customer indicating a product and/or offer selection and/or from (ii) an operator (or agent thereof) during stocking or maintenance of the vending machine 110. Also, the output device may be configured for outputting product and/or offer information (such as mystery promotion information) to a customer or operator.

Many combinations of input devices 122 and output devices 124 may be employed according to various embodiments. In some embodiments, the vending machine 110 may include more than one input device 122. For example, the vending machine 110 may include an exterior input device 122 for receiving customer input and an interior input device 122 (neither shown separately) for receiving operator input. In some embodiments, the input device 122 may provide the dual functionality of receiving input data from both operators and customers. Likewise, a vending machine may comprise more than one output device 124 (e.g., an LCD screen and several LED devices, as described herein). In some embodiments, such as those which feature touch screens (described elsewhere herein), the functionality of both input devices 122 and output devices 124 may be provided by a single device.

Many types of input devices 122 are contemplated. Thus, an input device 122 may comprise one or more of (1) a set of alpha-numeric keys for providing input to the vending machine, such as the Programmable Master Menu® Keypad, (2) a selector dial, (3) a set of buttons associated with a respective set of product dispensers, (4) a motion sensor, (5) a barcode reader, (6) a voice recognition module, (7) a Dual-Tone Multi-Frequency receiver/decoder, (8) a wireless device (e.g., a cellular telephone or wireless PDA), (9) a biometric device, and/or (10) any other type or configuration of input device 122 that may be or become known or practicable.

Likewise, many types of output devices 124 are contemplated. For example, an output device may comprise an LCD screen or device. Alternatively or additionally, the output device 124 may comprise one or more LED displays or devices (e.g., several alphanumeric multi-color or single color LED displays on the shelves of a vending machine associated proximately with each row of product inventory).

In one embodiment, an LED display screen is mounted atop the vending machine (via bolts or other mounting hardware) and is used to communicate offers and other messages (e.g., product advertisements) to prospective customers. A suitable LED display screen for such an embodiment may be housed in an aluminum case having a length of approximately twenty-seven and one half inches (27.5″/698.5 mm), a height of approximately four and one quarter inches (4.25″/107.95 mm), and a depth of approximately one and three quarter inches (1.75″/44.5 mm). Such a display screen may have a display area capable of showing about thirteen (13) alphanumeric and/or graphical characters. Further, such an LED display screen may comprise a serial computer interface, such as an RJ45/RS232 connector, for communicating with the processor 114. Further still, such an LED display may be capable of outputting text and graphics in several colors (e.g., red, yellow, green, black) regarding current and upcoming promotions.

Further, in some embodiments, the output device 124 may comprise a printer. In one embodiment, a printer may be configured to print on card stock paper of approximately one hundredth of an inch or less (e.g., 0.01″/0.15 mm or less) in thickness, such as the EPSON EU-T400 Series Kiosk Printer. Further, a printer may be capable of thermal line printing of various alphanumeric and graphical symbols in various font sizes (e.g., ranging from nine (9) to twenty-four (24) point) on various types of paper. Additionally, such a printer may communicate with the processor 114 via an RS232/IEEE 12834 and/or bi-directional parallel connection. Such a printer may further comprise a data buffer of various practicable sizes, such as approximately four kilobytes (4 KB). According to some embodiments, the output device 124 may comprise an audio module, such as an audio speaker, that outputs information to customers audibly.

As stated, in some embodiments, a touch-sensitive screen may be employed to perform both input device 122 and output device 124 functions. Suitable, commercially available touch screens for use according to various embodiments are manufactured by Elo TouchSystems, Inc., of Fremont, Calif., such as Elo's AccuTouch series touch screens. Such touch screens may comprise: (i) a first (e.g., outer-most) hard-surface screen layer coated with an anti-glare finish, (ii) a second screen layer coated with a transparent-conductive coating, and/or (iii) a third screen layer comprising a glass substrate with a uniform-conductive coating. Further, such touch screens may be configured to detect input within a determined positional accuracy, such as a standard deviation of error less than plus or minus eight hundredths of an inch (±0.08″/2 mm). The sensitivity resolution of such touch screens may be more than one hundred thousand touchpoints per square inch (100,000 touchpoints/in²/15,500 touchpoints/cm²) for a thirteen inch (13″) touch screen. For such touch screens, the touch activation force required to trigger an input signal to the processor 114 via the touch screen may typically be around two to four ounces (2-4 ounces/57-113 g). Additionally, touch screens for use according to various embodiments may be resistant to environmental stressors such as water, humidity, chemicals, electrostatic energy, and the like. These and other operational details of touch screens (e.g., drive current, signal current, capacitance, open circuit resistance, and closed circuit resistance) are well known in the art and need not be described further herein.

### G. Data Storage/Memory

The data storage device 126 may include any appropriate combination of magnetic, optical and/or semiconductor memory, and may include, for example, additional processors, communication ports, RAM, Read-Only Memory (ROM), a compact disc and/or a hard disk. The processor 114 and the storage device 126 may each be, for example: (i) located entirely within a single computer or other computing device; or (ii) connected to each other by a remote communication medium, such as a serial port cable, a Local Area Network (LAN), a telephone line, RF transceiver, a fiber optic connection and/or the like. In some embodiments for example, the vending machine 110 may comprise one or more computers (or processors 114) that are connected to a remote server computer (e.g., via the communication device 116) operative to maintain databases, where the data storage device 126 is comprised of the combination of the remote server computer and the associated databases.

The data storage device 126 may generally store one or more programs 128 for controlling the processor 114. The processor 114 may perform instructions of the program 128, for example, and thereby operate in accordance with some embodiments, and particularly in accordance with the methods described in detail herein. According to some embodiments, the program 128 may comprise any number or type of programs that are or becomes known or practicable. In some embodiments, the program 128 may be developed using an object oriented programming language that allows the modeling of complex systems with modular objects to create abstractions that are representative of real world, physical objects and their interrelationships. However, it would be understood by one of ordinary skill in the art that the embodiments described herein can be implemented in many different ways using a wide range of programming techniques as well as general purpose hardware systems or dedicated controllers.

The program 128 may be stored in a compressed, un-compiled and/or encrypted format. The program 128 furthermore may include program elements that may be generally useful, such as an operating system, a database management system and/or device drivers for allowing the processor 114 to interface with computer peripheral devices and/or the various components of the vending machine 110. Appropriate general purpose program elements are known to those skilled in the art, and need not be described in detail herein.

Further, the program 128 may be operative to execute a number of invention-specific objects, modules and/or subroutines which may include (but are not limited to) one or more subroutines to determine whether a promotion should be output; one or more subroutines to determine a promotion type; one or more subroutines to populate a promotion type (such as a mystery promotion), thereby constructing a promotion instance; one or more subroutines to select a constructed promotion instance from a plurality of hypothetical promotion instances; one or more subroutines to determine an expected value of a promotion being considered for output; and/or one or more subroutines to determine how and/or when products should be dispensed from the vending machine 110. Examples of some of these subroutines and their operation are described in detail with respect to the processes described elsewhere herein.

According to some embodiments, the instructions of the program 128 may be read into a main memory (not explicitly shown) of the processor 114 from another computer-readable medium (such as the data storage device 126), like from a ROM to a RAM. Execution of sequences of the instructions in the program 128 may cause the processor 114 to perform the process steps described herein. In alternative embodiments, hard-wired circuitry or integrated circuits may be used in place of, or in combination with, software instructions for implementation of the processes described herein. Thus, some embodiments are not limited to any specific combination of hardware, firmware, and/or software.

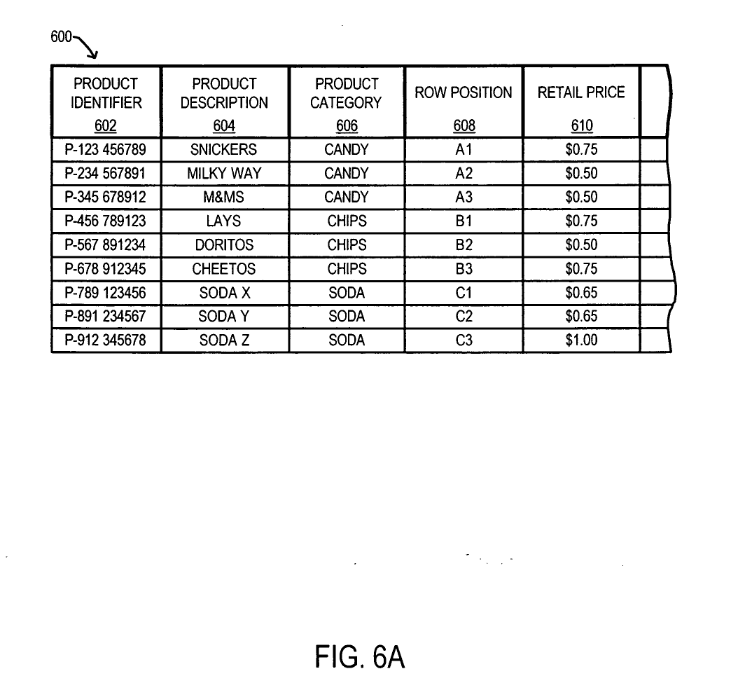

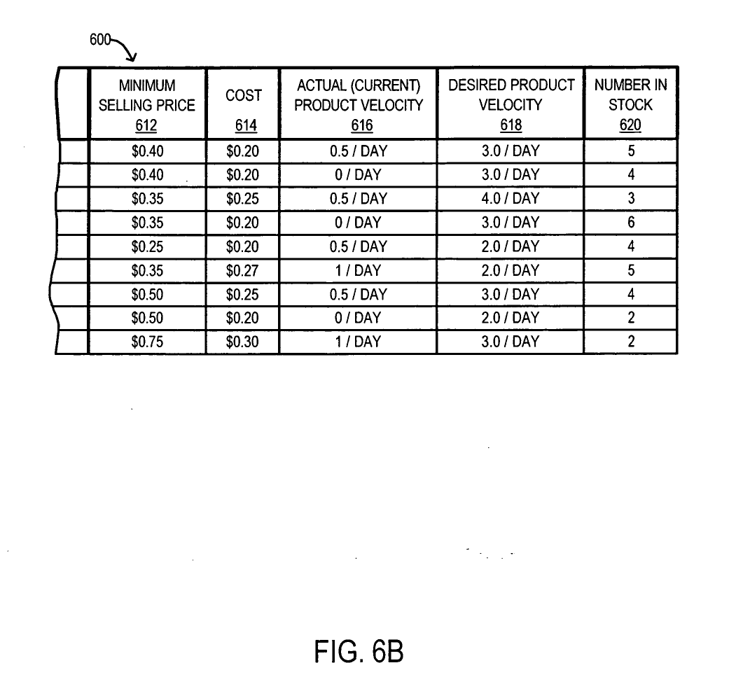

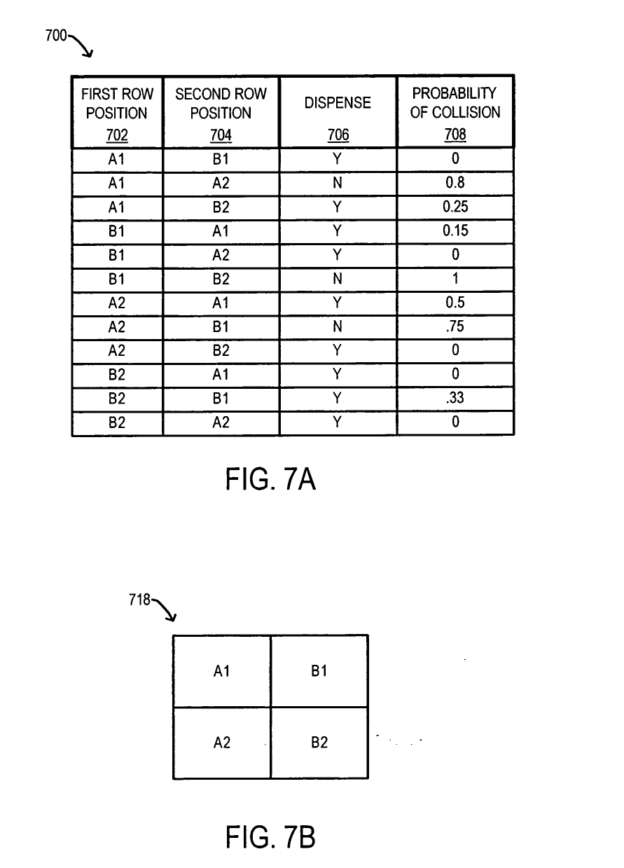

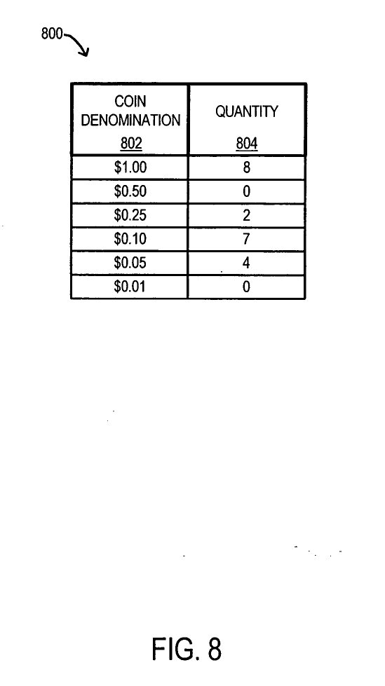

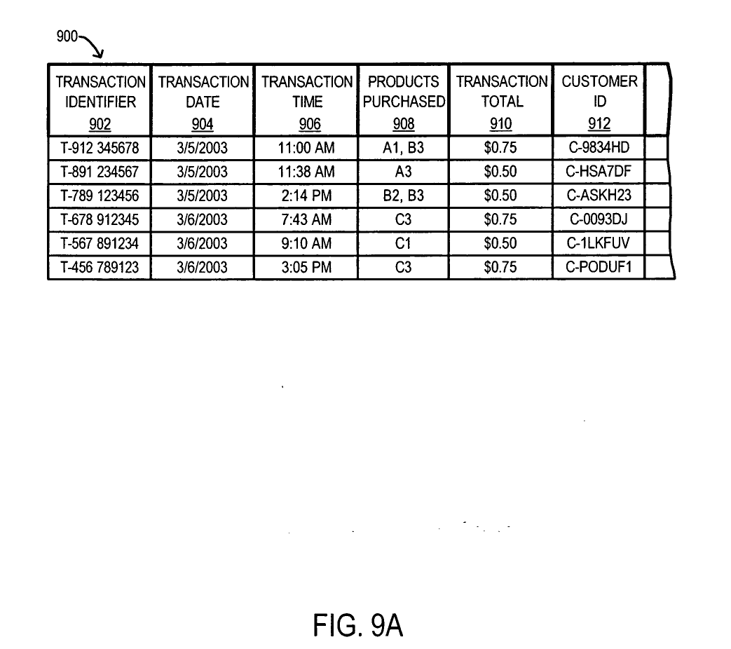

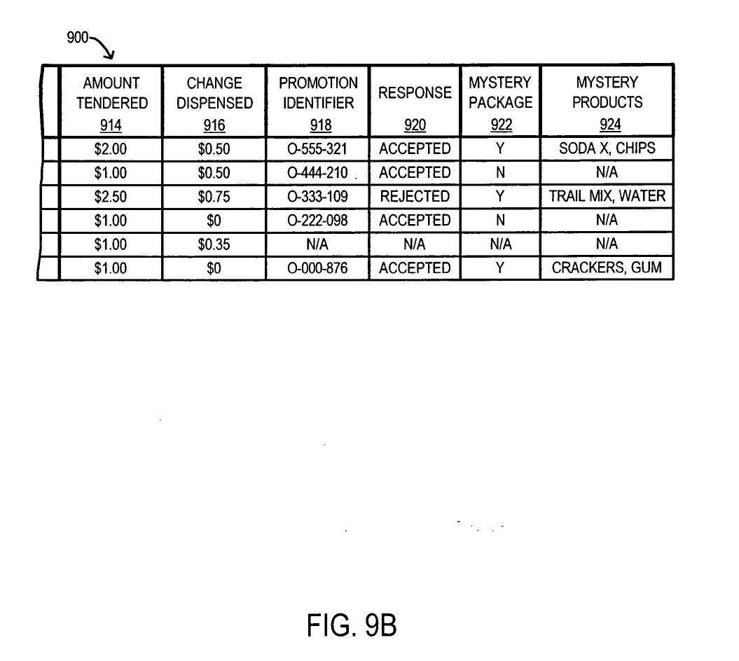

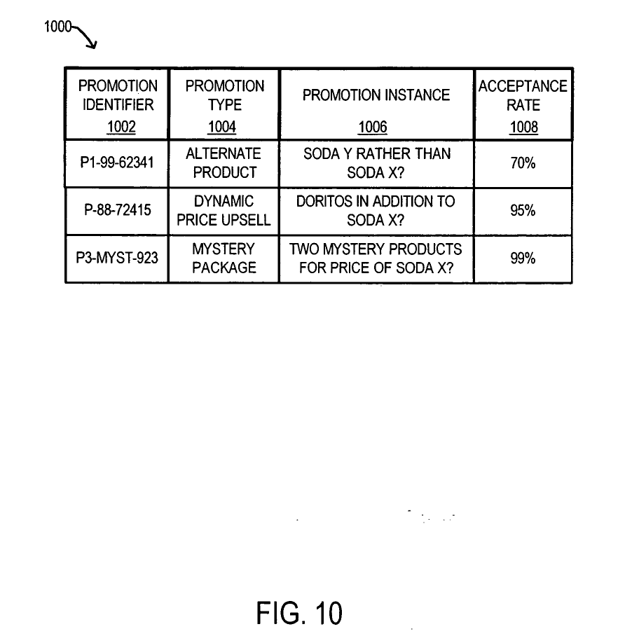

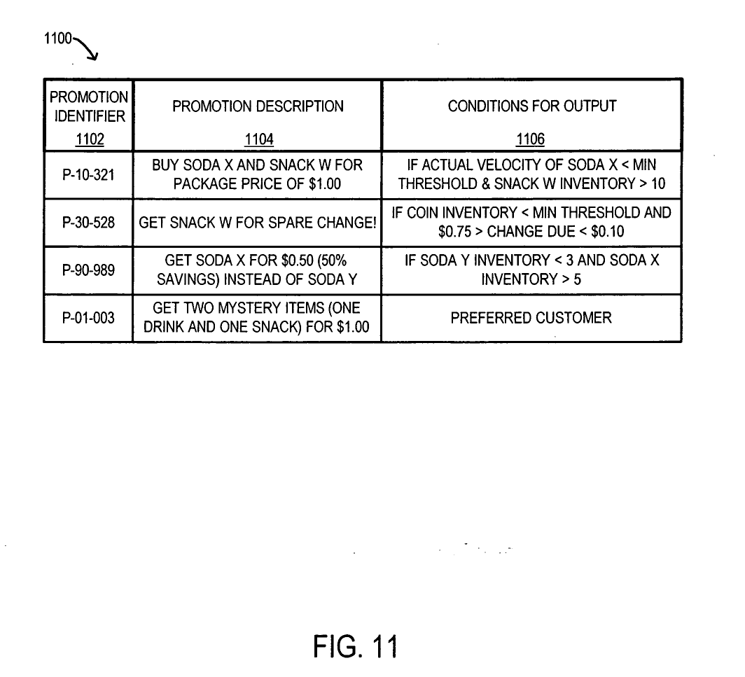

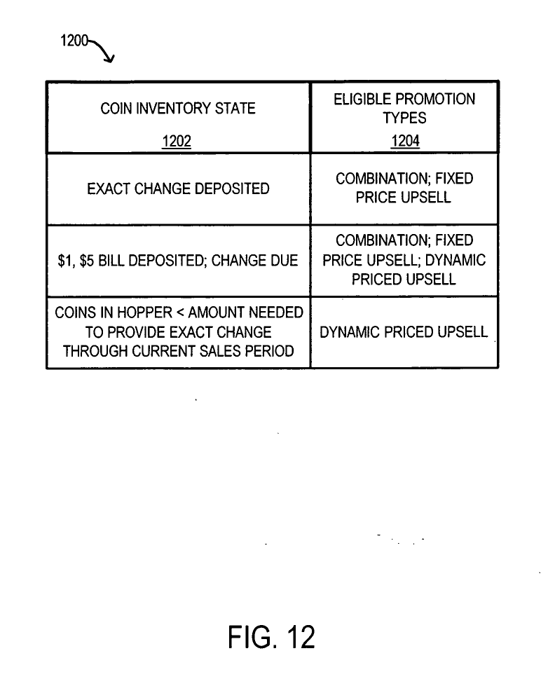

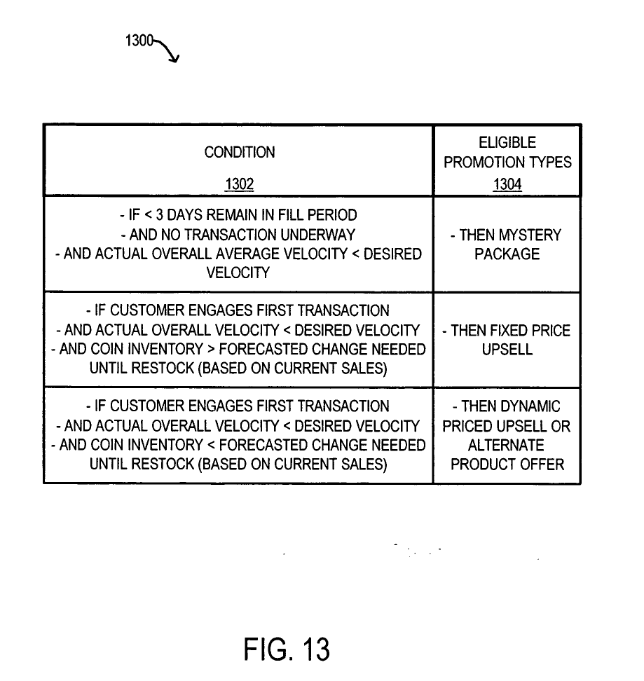

In addition to the program 128, the data storage device 126 may also be operative to store one or more databases, files, and/or tables, containing information such as (i) product inventory data 130, (ii) dispensing data 132, (iii) coin inventory data 134, (iv) transaction history data 136, (v) promotion history data 138, (vi) available promotions data 140, (vii) rules data 142, and/or (viii) customer data 144. Various aspects associated with the exemplary data 130, 132, 134, 136, 138, 140, 142, 144 are described in detail with respect to example structures that are depicted with sample entries in the accompanying figures (e.g., FIG. 6A, FIG. 6B, FIG. 7A, FIG. 8, FIG. 9A, FIG. 9B, FIG. 10, FIG. 11, FIG. 12, and FIG. 13). As will be understood by those skilled in the art, the schematic illustrations and accompanying descriptions of the sample data and associated structures presented herein are exemplary arrangements for stored representations of information. Any number of other arrangements may be employed besides those suggested by the tables shown. For example, even though eight separate data tables, stores, files, and/or databases are illustrated, embodiments may be practiced effectively using fewer or more functionally equivalent databases or similar structures.

Similarly, the illustrated entries of the data represent exemplary information only. Those skilled in the art will understand that the number and content of the entries can be different from those illustrated herein.

Further, despite the depiction of the data as tables, an object-based model could be used to store and manipulate the data types and likewise, object methods or behaviors can be used to implement the processes described herein.

### H. Vending Machine Retrofitting

In one embodiment, one or more of the processor 114, the input device 122, the output device 124, and the data storage device 126 may be included, wholly or partially, in a separate device (e.g., separate from and/or external to the casing 112; not shown), such as the e-Port™ by USA Technologies Inc., that may be in communication with the vending machine 110. The separate devices may also or alternatively be in communication with a network such as the Internet (e.g., via the communication device 116).

The e-Port™ is a credit and smart card-accepting unit that controls access to office and MDB vending equipment, and serves as a point of purchase credit card transaction device. The e-Port™ includes an LCD that allows for the display of color graphics, and a touch sensitive input device (touch screen) that allows users to input data to the device. The display may be used to prompt users interactively with, e.g., offers and information about their transaction status.

The separate device may alternatively be a programmed computer running appropriate software for performing various functions described herein. The separate device may be operable to receive input from customers, receive payment from customers, exchange information with a remotely located server and/or display messages to customers (e.g., mystery package promotions). The separate device may be operable to instruct the vending machine that appropriate payment has been received (e.g., via a credit card read by the separate device), that a particular product or products should be dispensed by the vending machine, and/or how and/or when those products should be dispensed (e.g., to avoid product collisions and/or other complications). Further, a separate device may be operable to instruct the vending machine to execute mystery promotions (package or single product mystery promotions), price changes, or the like.

Thus, a separate device may be operatively connected to the vending machine 110 to perform the inventive processes described herein. In this manner, for example, conventional vending machines may be retrofitted with such separate devices so as to perform the processes described herein.

### I. Network Embodiments

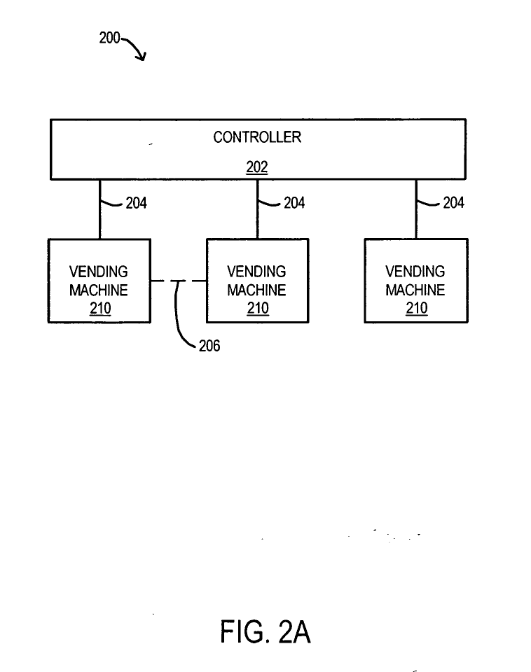

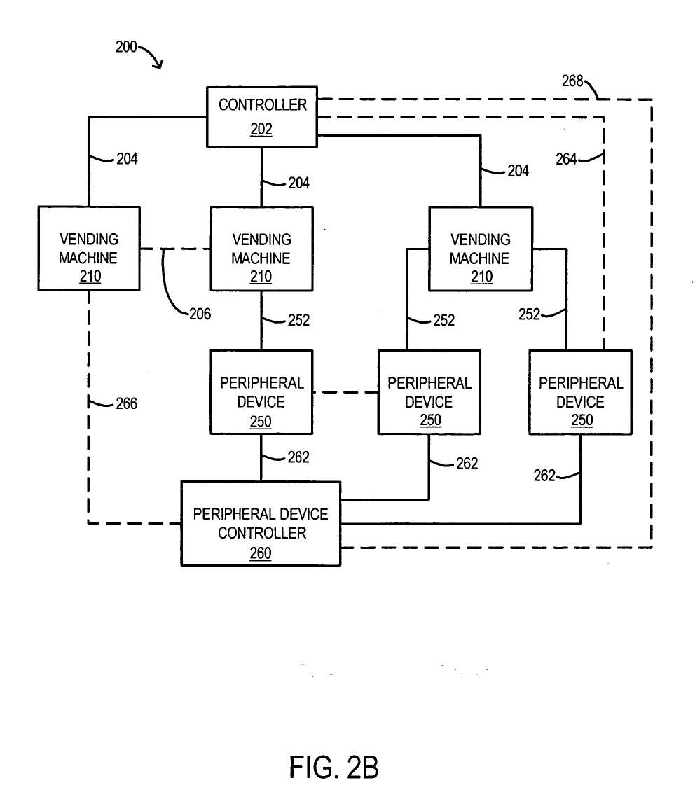

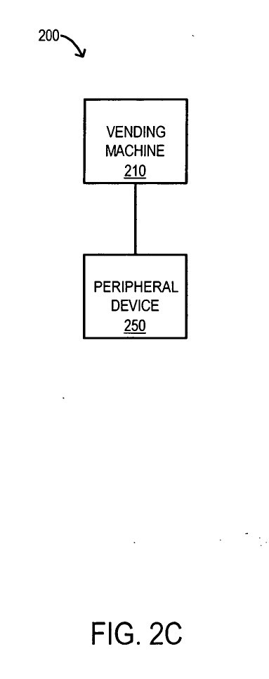

Referring now to FIG. 2A, FIG. 2B, and FIG. 2C, block diagrams of various configurations of a system 200 according to some embodiments are shown.

In some embodiments, such as shown in FIG. 2A for example, a controller 202 may be in communication (e.g., via a first and/or second communication network 204, 206) with one or more vending machines 210. The controller 202 may communicate with the vending machines 210 directly or indirectly, via a wired or wireless medium such as the Internet, LAN, WAN or Ethernet, Token Ring, or via any appropriate communications means or combination of communications means. Each of the vending machines 210 may comprise computers, such as those based on the Intel® Pentium® processor, that are adapted to communicate with the controller 202. Any number and type of vending machines 210 may be in communication with the controller 202. According to some embodiments, one or more of the vending machines 210 may be similar in configuration and/or functionality to the vending machine 110 described in conjunction with FIG. 1. In some embodiments, fewer or more controllers 202, networks 204, vending machines 210, and/or other components may be included in the system 200.

According to some embodiments, communication between the vending machines 210 and the controller 202 and/or among the vending machines 210 (e.g., via the second communications network 206), may be direct or indirect, such as over the Internet through a Web site maintained by controller 202 on a remote server and/or over an on-line data network including commercial on-line service providers, bulletin board systems and the like. In yet other embodiments, the vending machines 210 may communicate with one another and/or controller 202 over RF, cable TV, Bluetooth®, satellite links and the like.

Some, but not all, possible communication networks that may comprise either or both of the first and second communications networks 204, 206 and/or may otherwise be part of the system 200 include: a LAN, a WAN, the Internet, a telephone line (e.g., a Public Switched Telephone Network (PSTN)), a cable line, a radio channel, an optical communications line, and/or a satellite communications link. Possible communications protocols that may be part of system 200 include: Ethernet (or IEEE 802.3), SAP, ATP, Bluetooth™, and TCP/IP. Communication may be encrypted to ensure privacy and prevent fraud in any of a variety of ways well known in the art.

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet may not transmit data to the other device for weeks at a time.

In some embodiments, the controller 202 may not be necessary and/or preferred. One or more embodiments, for example, may be practiced on a stand-alone vending machine 210 and/or a vending machine 210 in communication only with one or more other vending machines 210. In such an embodiment, any functions described as performed by the controller 202 or data described as stored on the controller 202 may instead be performed by or stored on one or more vending machines 210.

It should be noted that, in the embodiments of FIG. 2A. FIG. 2B, and/FIG. 2C, some or all of the functionality described with reference to FIG. 1 as being performed by vending machine 110 may instead or in addition be performed by the controller 202. For example, the controller 202 may determine a mystery promotion type to be used as the basis for construction of a mystery promotion instance and/or may construct a mystery promotion instance. Similarly, any data described with reference to FIG. 1 as being stored in the data storage device 126 of the vending machine 110 may, in some embodiments, be instead or in addition stored in a memory (not shown) of controller 202. For example, data associated with past transactions completed at a vending machine 110, 210 may be stored in a database associated with and/or coupled to the controller 202.

It should further be noted that controller 202 may comprise one or more computing devices (e.g., working in cooperation with one another) that may or may not be located remotely to one another or remotely to one or more of the vending machines 210.

Referring now to FIG. 2B, a different exemplary configuration of the system 200 is shown. A difference between the configuration of the system 200 shown in FIG. 2B and that shown in FIG. 2A is that in the configuration of the system 200 in FIG. 2B, at least one vending machine 210 is also in communication with one or more peripheral devices 250 (e.g., via a third communications network 252). A peripheral device 250 may, in turn, be in communication with other peripheral devices 250 (e.g., via fourth communication network 254) and/or with a peripheral device controller 260 (e.g., via fifth communication network 262). In some embodiments, a peripheral device 250 may also or instead be in communication with the controller 202 (e.g., via sixth communication network 264 and/or one or more user devices (not shown). In one or more embodiments the peripheral device controller 260 may also or alternatively be in communication with one or more vending machines 210 (e.g., via seventh communication network 266) and/or the controller 202 (e.g., via eighth communication network 268).

Any of the controller 202, the vending machines 210, the peripheral devices 250 and/or the peripheral device server 260 may communicate with one another directly or indirectly, via a wired or wireless medium such as the Internet, LAN, WAN or Ethernet, Token Ring, or via any appropriate communications means or combination of communications means. For example, the controller 202 may communicate directly with one of the vending machines 210 (e.g., via a LAN) and indirectly (e.g., via a vending machines 210) with a peripheral device 250. In another example, the controller 202 may communicate with one of the vending machines 210 via a LAN and with another of the vending machines 100 via the Internet.

Any or all of the controller 202, the vending machines 210, the peripheral devices 250 and the peripheral device controller 260 may comprise computers, such as those based on the Intel® Pentium® processor. Further, in one or more embodiments, each of the peripheral devices 250 may comprise an external or internal module (not shown) associated with one or more of the vending machines 210 that is capable of communicating with one or more of the vending machines 210 and of directing the one or more vending machines 210 to perform one or more functions.

Any number of vending machines 210 may be in communication with the controller 202. Any number and type of peripheral devices 250 may be in communication with a vending machine 210, peripheral device controller 260 and/or the controller 202.

Communication between any of the controller 202, the vending machines 210, the peripheral devices 250 and the peripheral device controller 260, among the vending machines 210 and/or among the peripheral devices 250 may be direct or indirect, such as over the Internet through a Web site maintained by controller 202 on a remote server or over an on-line data network including commercial on-line service providers, bulletin board systems and the like. In yet other embodiments, any and all of controller 202, the vending machines 210, the peripheral devices 250 and/or the peripheral device controller 260 may communicate with one another over RF, cable TV, satellite links and the like.

Some, but not all, possible communication networks that may comprise any or all of the first, second, third, fourth, fifth, sixth, seventh, and/or eighth networks 204, 206, 252, 254, 262, 264, 266, 268, or that otherwise may be part of system 200 include (but are not limited to): a LAN, a WAN, the Internet, a telephone line, a cable line, a radio channel, an optical communications line, and/or a satellite communications link. In some embodiments, any or all of the communication networks 204, 206, 252, 254, 262, 264, 266, 268 may comprise the same network or network component and/or may otherwise be related or coupled. Possible communications protocols that may be part of system 200 may include (but are not limited to): Ethernet (or IEEE 802.3), SAP, ATP, Bluetooth™, and TCP/IP. Communication may be encrypted to ensure privacy and prevent fraud in any of a variety of ways well known in the art.

In some embodiments, the controller 202 may not be necessary and/or preferred. For example, one or more embodiments may be practiced on a stand-alone vending machine 210, one or more vending machines 210 in communication with one or more peripheral devices 250, one or more vending machines 210 in communication with peripheral device controller 260, one or more peripheral devices 250 in communication with peripheral device controller 260, and/or a vending machine 210 in communication only with one or more other vending machines 210. In such embodiments, any functions described as performed by a particular device (e.g., by a vending machine 210) or data described as stored in a memory of a particular device (e.g., in a memory of a vending machine 210) may instead or in addition be performed by or stored in another of the devices described herein (e.g., a peripheral device 250 and/or peripheral device controller 260).

Similarly, the peripheral device controller 260 may not be desired and/or needed in some embodiments. In embodiments that do not involve the peripheral device controller 260, for example, any or all of the functions described herein as being performed by peripheral device controller 260 may instead be performed by controller 202, one or more vending machines 210, one or more peripheral devices 250, or any combinations thereof. Similarly, in embodiments that do not involve the peripheral device controller 260 any data described herein as being stored in a memory of the peripheral device controller 260 may instead be stored in a memory of the controller 202, one or more vending machines 210, one or more peripheral devices 250, or any combinations thereof.

Any or all of the vending machines 210 may, respectively, include or be in communication with a peripheral device 250. A peripheral device 250 may, for example, be a device that obtains (e.g., receives or reads) information from (and/or transmits information to) one or more vending machines 210. For example, a peripheral device 250 may be operable to obtain information about transactions being conducted at a vending machine 210, such as the initiation of a transaction, an amount of money deposited for a transaction and/or a product selected during a transaction. For example, a peripheral device 250 may monitor activities carried out by a processor (e.g., the processor 114) of a vending machine 210.

In one or more embodiments, one or more such peripheral devices 250 may be in communication with the peripheral device controller 260. This allows the peripheral device controller 260 to receive information regarding a plurality of transactions conducted at a plurality of vending machines 210. The peripheral device controller 260, in turn, may be in communication with the controller 202. It should be understood that any functions described herein as performed by a peripheral device 250 may also or instead be performed by the peripheral device controller 260. Similarly, any data described herein as being stored on or accessed by a peripheral device 250 may also or instead be stored on or accessed by the peripheral device controller 260.

A peripheral device 250 may be operable to access one or more databases (e.g., of peripheral device controller 260 or of the peripheral device 250 or a combination thereof) to determine a mystery promotion type based on, for example, one or more transactions initiated and/or completed at a vending machine 210. A peripheral device 250 may also be operable to access one or more databases (e.g., a product inventory database and/or a transaction history database) to construct a mystery promotion instance.

The peripheral device controller 260 may also or alternatively monitor mystery promotions output to customers of vending machines 210 over time to determine acceptance rates for various mystery promotions. For example, in embodiments where a customer is presented with a mystery promotion at a vending machine 210 and responds thereto by providing an acceptance or rejection of the mystery promotion via an input device (such as the input device 122) of the vending machine 210 or an input device (not shown) of a peripheral device 250, the peripheral device controller 260 may track which mystery promotions are accepted by customers and subsequently use that information to present other mystery promotions to a customer and/or to construct mystery promotion instances. Further, information about a transaction obtained or accessed by the peripheral device controller 260 may be analyzed, e.g., to identify the circumstances under which a mystery promotion type is most likely to be accepted by a customer. Based upon desired objectives, the peripheral device controller 260 may direct the appropriate peripheral device 250 to output customized mystery promotions to a customer of a vending machine 210 based on the circumstances of a transaction initiated by the customer.

Information received by a peripheral device 250 from a vending machine 210 may include inventory data such as an actual rate at which a particular product is selling, a number of transactions per unit of time, a coin inventory, a product inventory and/or a selection of a product by a customer currently conducting a transaction at the vending machine. An example of a device that may comprise a peripheral device 250 is the e-Port™ by USA Technologies Inc., described elsewhere herein.

A peripheral device 250 may be operable to receive input from customers, receive payment from customers, exchange information with a remotely located server (e.g., controller 202 and/or peripheral device controller 260) and/or display messages to customers (e.g., mystery promotion content). A peripheral device 250 may be operable to instruct a vending machine 210 that appropriate payment has been received (e.g., via a credit card read by the separate device) and/or that a particular product (e.g., a mystery product) should be dispensed by the vending machine 210. Further, a peripheral device 250 may be operable to instruct the vending machine 210 to execute mystery promotions or price changes.

In one or more embodiments, a peripheral device 250 may be useful for implementing the embodiments described herein into the processing and/or operation of a conventional vending machine (e.g., one or more of the vending machines 210 shown in FIG. 2B). For example, in order to avoid or minimize the necessity of modifying or replacing a program already stored in a memory of a conventional vending machine 210, an external or internal module that comprises a peripheral device 250 may be inserted in or associated with the vending machine 210. For example, a conventional vending machine 210 may be retrofitted with a peripheral device 250 in order to implement one or more embodiments described herein.

A peripheral device 250 may include various components not explicitly shown in FIG. 2B, such as (i) a communications port (e.g., for communicating with one or more vending machines 210, peripheral device controller 260, another peripheral device 250, and/or the controller 202); (ii) a display (e.g., for graphics and/or text associated with a promotion), (iii) another output means (e.g., a speaker and/or light to communicate with a customer), and/or (iv) a benefit providing means (e.g., a printer and paper dispensing means).

In one or more embodiments, the peripheral device 250 may direct a vending machine to perform certain functions. For example, a program stored in a memory of peripheral device 250 may cause a processor of a vending machine 210 to perform certain functions. For example, a program stored in a memory of peripheral device 250 may cause a processor of a vending machine 210 to dispense one or more products, dispense a monetary amount, refrain from dispensing a monetary amount, refrain from outputting a product, and/or communicate with another device.

Note that, in one or more embodiments, a vending machine 210 and a peripheral device 250 that is associated with the vending machine 210 may not communicate with one another at all. In some embodiments, however, each may communicate with a computer or other device. For example, a vending machine 210 may communicate with controller 202 and an associated peripheral device 250 may communicate with a peripheral device controller 260 and/or a controller 202. For example, if both vending machine 210 and peripheral device 250 are in communication with controller 202, each may obtain information associated with the other through controller 202.

It should be noted that in either of the configurations of the system 200 shown in either of FIG. 2A or FIG. 2B, the controller 202 and/or the peripheral device controller 260 may be accessible, directly or indirectly, via another computer (communicating, e.g., over the Internet or other network) by a customer or another entity. Accordingly, a customer or other entity (e.g., an owner of the vending machine) of the other computer could communicate with the controller 202 and/or peripheral device controller 260 via a Web browser. The other computer could, e.g., receive from the controller 202 and/or peripheral device controller 260 messages (e.g., mystery promotions and/or advertisements) described herein as being output by the vending machine 210 and/or the peripheral device 255, and/or transmit to the controller 202 and/or peripheral device controller 260 input described herein as being provided to the vending machine 210. Similarly, various data described herein as received through an input device of a vending machine 210 and/or peripheral device 250 may be received through a Web browser communicating with the controller 202 and/or peripheral device controller 260, which in turn communicates with the vending machine 210. Thus, an owner/operator of the vending machine 210 may have remote polling and reporting capabilities, may be able to transmit new business rules to the vending machine 210, and the like.

Referring now to FIG. 2C, another possible configuration of the system 200 is shown. The configuration shown in FIG. 2C may, for example, comprise a vending machine 210 that is in communication with a peripheral device 250. As described with respect FIG. 2A and FIG. 2B, a standard vending machine 210 may be retrofitted with a peripheral device 250. The peripheral device 250 may be operable to perform at least some of the methods described herein and/or to direct the vending machine 210 to perform at least some of the methods described herein, without requiring a controller 202 and/or a peripheral device controller 260. In one or more embodiments, the vending machine 210 and/or the peripheral device 250 may be accessible from a remote location via a communication port (such as the communication device 116). According to some embodiments, the peripheral device 250 may be included within, coupled to, adjacent to, and/or otherwise associated or in communication with the vending machine 210. The peripheral device 250 may be a hardware and/or software module installed within the vending machine 210, for example, and/or may be a device located on or near the vending machine 210 (such as a camera, a speaker, a touch screen, and/or an advertising or promotional device).

### J. External Appearance

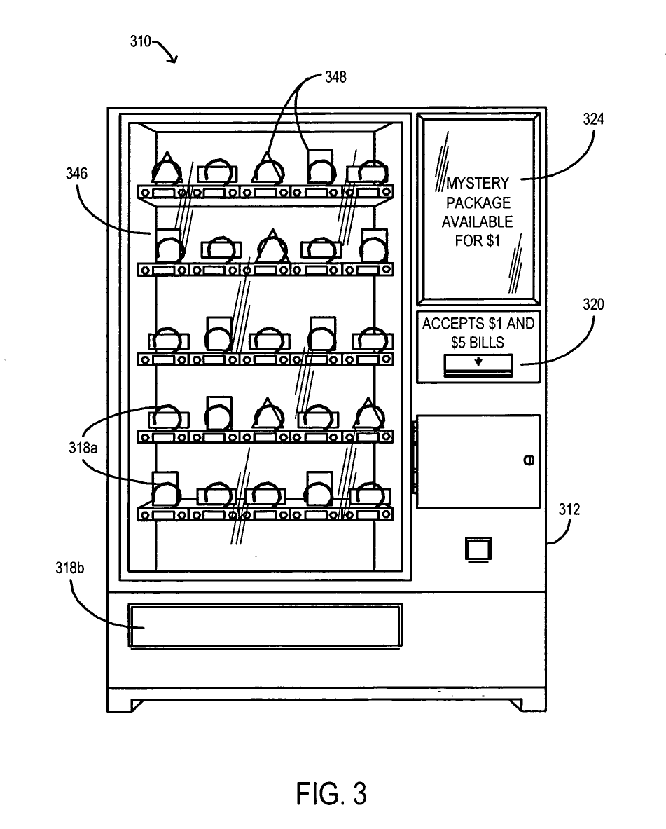

Referring to FIG. 3, a diagram illustrating an example of the external appearance of a vending machine 310 according to some embodiments is shown. In some embodiments, the exemplary vending machine 310 may be similar in configuration and/or functionality to the vending machines 110, 210 described in conjunction with any of FIG. 1, FIG. 2A, FIG. 2B, and/or FIG. 2C. The exemplary vending machine 310 may comprise, for example, (i) a cabinet 312, (ii) an inventory dispensing mechanism 318a-b (comprising a product storage mechanism 318a and/or a product hopper 318b), (iii) a payment processing mechanism 320, (iii) an output device 324 (e.g., for outputting text and/or graphical information about promotions such as mystery promotions to a customer), and (iv) a product display window 346 behind which are visible the products 348 available for sale from the vending machine 310 and the product storage mechanism 318a that holds the products within the vending machine 310. According to some embodiments, the components 312, 318, 320, 324, 346 of the vending machine 310 may be similar in configuration and/or functionality to the similarly named and/or numbered components described in conjunction with any of FIG. 1, FIG. 2A, FIG. 2B, and/or FIG. 2C herein.

The casing 312 may, fore example, comprise any type or configuration of cabinetry or enclosure to at least partially house components of the vending machine 310. As described elsewhere herein, for example, the casing 312 may be constructed of steel, aluminum, plastic, rubber, other metals or composite materials, and/or any combinations thereof. In some embodiments, the casing 312 may be configured for the sale of various products or services such as a typical and/or modified version of a typical snack, beverage, dessert, meal, non-edible object, media, and/or any other vending machine 310. According to some embodiments, the inventory dispensing mechanism 318a-b may comprise various component such as the product storage mechanism 318a and/or the product hopper 318b). The product storage mechanism 318a may, for example, comprise a number of latches, levers, paddles, doors, spirals, and/or other product retention, detention, and/or dispensing mechanisms, as are known in the art.

According to some embodiments, a product selected and/or purchased by a customer may be released by the product storage mechanism 318a so that it falls into the product hopper 318b. The product hopper 318b may, according to some embodiments, comprise one or more doors, holes, and/or other means via which a customer may retrieve a dispensed product. The product hopper 318b may also or alternatively comprise one or more components to facilitate prevention of unauthorized product removal (e.g., from someone reaching up into the vending machine 310 via the product hopper 318b) and/or to facilitate the reduction of impact forces experienced by products dropping from the product storage mechanism 318b above. According to some embodiments, the product storage mechanism 318a may be operated by the vending machine 310 to dispense packages in an intelligent manner (as described elsewhere herein).

In some embodiments, the payment processing mechanism 320 may comprise any practicable type of payment receiving, transmitting, and/or processing device that is or becomes known (such as those described elsewhere herein). The payment processing mechanism 320 may, for example, comprise a currency validator and/or input slot, such as shown in FIG. 3. According to some embodiments, the output device 324 may display various information associated with mystery promotions and/or product or service sales to a customer. As shown in FIG. 3, for example, the output device 324 may comprise a display screen (and/or touch screen) that provides mystery promotions to customer.

### IV. SOFTWARE ARCHITECTURE

In some embodiments, a control system may execute instructions for managing the operation of a vending machine (such as the vending machines 110, 210, 310), and in particular in accordance with various embodiments described herein. Such vending machine functions include, but are not limited to: (1) product pricing (e.g., displaying prices via an LED and/or changing such prices where appropriate), (2) processing vending transactions by (i) receiving customer selections via an input device, (ii) processing payment via a payment processing mechanism, and (iii) actuating corresponding product dispensing mechanisms, (3) selecting mystery promotions or mystery promotion types and constructing mystery promotion instances, (4) outputting mystery promotions to customers via output devices (including display of graphics/content on LCD and LED displays), (5) recording transaction information (inventory levels, acceptance rates for promotions, etc.), and/or (6) intelligently managing product dispensing.

In some embodiments, machine components (e.g., machine hardware, including mechanical hardware such as input devices, output devices, product dispensing devices, and payment processing devices including coin acceptors, bill validators, card readers, and/or change dispensers) may be controlled by the control system through a standard RS-232 serial interface. In such embodiments, embedded Application Programming Interface (API) devices or modules may be used to enable software to actuate and/or control vending machine components via RS-232 connectivity. Such vending machine components may be operatively connected to the control system directly or indirectly, in any manner that is practicable. Alternatively, machine components may communicate with the control system through a USB standard (e.g., USB ports may allow “plug-and-play” installation of machine components).

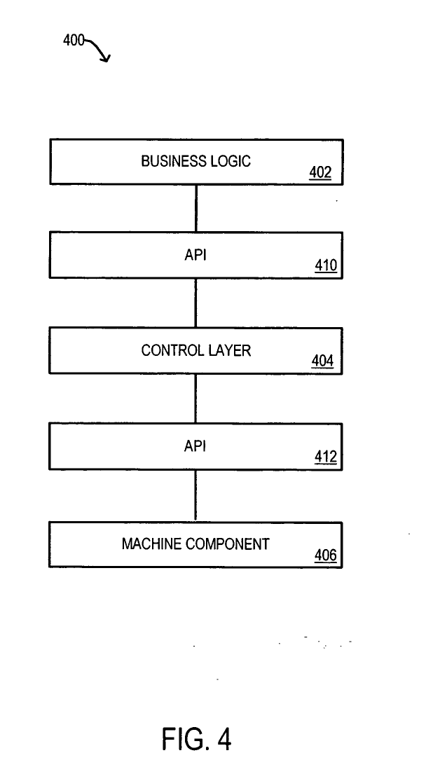

Referring now to FIG. 4, a block diagram of a system 400 according to some embodiments, is shown. The system 400 may, for example, comprise and/or represent an exemplary portion of control software that may be utilized to implement some embodiments. The system 400 illustrates, for example, control software as being divided into three abstract components. Such division may provide a clear partition of tasks, which may be desirable so that any future modification and new programming can be applied without disrupting other components. The three abstract components illustrated include a Business Logic software component 402, a Control Layer software component 404, and an exemplary Machine Components software component 406. As stated earlier, more machine components may be employed in addition to the exemplary one illustrated herein.

The software components are each connected to one another via a respective API. As is known in the art, an API may comprise a set of routines, protocols, and/or tools for building software applications. The Business Logic software component 402 may, according to some embodiments, be connected to the Control Layer software component 404 via an API 410. Similarly, the Control Layer software component 404 may be connected to the Machine Component software component 406 via another API 412.

The Business Logic software component 402 visually represents the portion of the software that selects mystery promotions or mystery promotion type instances and/or constructs mystery promotion instances, as discussed herein. Such a component may, for example, access a rules database and a product inventory database to perform such functions.

The Control Layer software component 404 visually represents the portion of the software which interfaces with at least one Machine Component software component 406, and thereby transmits commands to perform such functions as: (i) outputting mystery promotion information via an output device (e.g., a machine component), (ii) dispensing products via a product dispensing mechanism (e.g., a machine component), and/or (iii) dispensing change due to a customer via a payment processing mechanism, which may include a change dispenser and a currency storage apparatus (e.g., several machine components).

The Machine Component software component 406 generally represents software or machine hardware, including mechanical hardware such as input devices, output devices, inventory dispensing devices, and payment processing devices including coin acceptors, bill validators, card readers, change dispensers, etc.

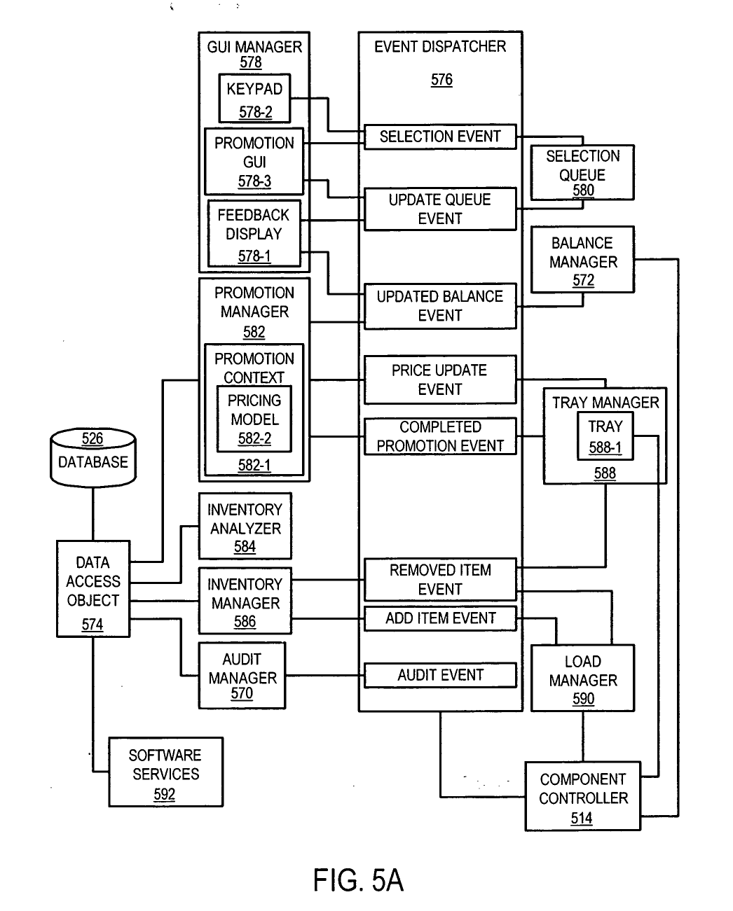

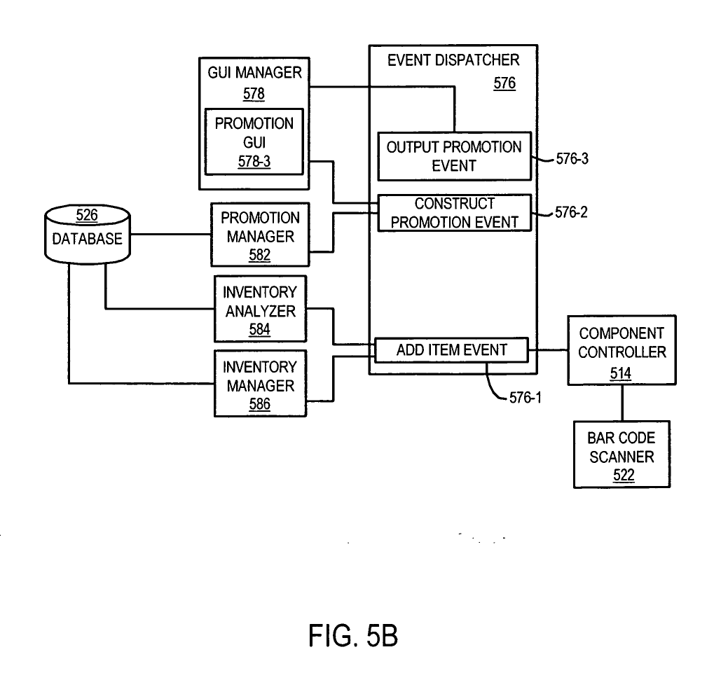

Referring now to FIG. 5A, a schematic block diagram of an exemplary configuration of software architecture 500 according to some embodiments is shown. It should be noted, however, that many architectural configurations are possible to carry out the inventive processes described herein. The software architecture 500 is a model of a software application for use in execution of embodiments described herein, designed using Unified Modeling Language™ (UML). The model comprises various software components and illustrates how the various software components may interact with one another.

According to some embodiments, the software architecture 500 may comprise a component controller 514 and/or a database 526. The component controller 514 may manage (and mask the implementation of) vending machine components. Examples of vending machine components include: input devices, output devices, coin acceptors, bill validators, card readers, change dispensers, product dispensing mechanisms, and bar code readers. In some embodiments, the component controller 514 may be similar in configuration and/or functionality to the processor 114 described in conjunction with FIG. 1. The database 526 may comprise a persistence store (e.g., MySQL, file based, and/or Oracle®). The database 526 may, for example, be similar in configuration and/or functionality to the data storage device 126 described in conjunction with FIG. 1.

In some embodiments, an audit manager 570 listens for audit events fired by other management components and acts on them by persisting meaningful state about the event to audit data structures. This function journals all significant events, transactions, and other meaningful system operations so that they can be used in subsequent analysis and reporting functions. The definition of “meaningful state” can potentially be specified through configuration management. The event/configuration driven approach provides flexibility if auditing/reporting requirements change.

According to some embodiments, a balance manager 572 represents the current monetary balance in the machine. It interacts with the component controller 514 and responds to money insertion by incrementing its balance value. It fires UpdatedBalance events whenever the balance changes. It listens for DrainBalance events and executes processes of the component controller 514 that return funds to the user.

In some embodiments, a data access object 574 may be the layer of abstraction that is responsible for persisting domain objects such as inventory objects and audit data. The data access object 574 may, for example, be in communication with the database 526 and/or one or more other data stores (not shown).

According to some embodiments, an event dispatcher 576 acts as a proxy broker for events so that components do not need to explicitly listen to each other (e.g., have undue knowledge of each other by reference). Some examples of events that may be managed by this component, and that are shown in FIG. 5A, include: a SelectionEvent event, an UpdatedQueueEvent event, an UpdatedBalanceEvent event, a TrayLEDUpdateEvent event, a CompletedPromotionEvent event, a DispensedItemEvent event, an AuditEvent event, and/or an EnterOperatorModeEvent event.

In some embodiments, a Graphical User Interface (GUI) manager 578 is a container for all GUI components and/or sub-components and defines their layout in reference to one another. The GUI manager 578 will also listen for events from the event dispatcher 576. Swing events may be handled by the individual sub-components 578-1, 578-2, 578-3 of the GUI manager 578. According to some embodiments, the sub-components may comprise a feedback display 578-1, a keypad 578-2, and/or a promotion GUI 578-3. The feedback display 578-1 is a sub-component that manages feedback from the keypad 578-2, instructions, and error messages.

The keypad 578-2 is a sub-component that represents the keypad data entry interface (rendered as Swing graphical objects on a touch screen LCD). It forces selection events to be fired that are relevant to the feedback display 578-1 and a selection queue 580.

The promotion GUI 578-3 is a sub-component that represents promotion-related user interface rendering such as graphical selection menus, banners, animation, etc. The promotion GUI 578-2 fires events that can effect the selection queue 580 and also listens for events from a promotion manager 582. The selection queue 580 is a container for cumulative product selections made during the course of user interaction with a mystery promotion. The promotion manager 582 manages all of the mystery promotion-related business rules in play in a vending machine. It can manage multiple mystery promotion contexts simultaneously and executes all rules related to validation, execution, and workflow related to these mystery promotion contexts. This component implements a mystery promotion context factory object that encapsulates business rule logic related to mystery promotion eligibility, selection, pricing and composition.

In some embodiments, the promotion manager 582 may comprise, define, and/or manage one or more components such as a promotion context 582-1 and/or a pricing model 582-2. The promotion context 582-1 may comprise all of the state and workflow rules required by the promotion manager 582 to execute a given mystery promotion. The pricing model 582-2 may, according to some embodiments, be a sub-component of the promotion context 582-1. The pricing model 582-2 may, for example, contain all the product pricing data needed to execute the mystery promotion described by that context.

According to some embodiments, an inventory analyzer 584 performs derivation and aggregation computations on inventory state and audit data. The results of these computations are persisted for use by other components (e.g., the promotion manager 582). The computation functions can be initiated on demand or by a scheduler service when the system is dormant.

In some embodiments, an inventory manager 586 maintains the current state of the machine's inventory. It listens for events that will ask it to update the inventory that was fired by components such as a tray manager 588 and a load manager 590. The tray manager 588 is the container and manager of composite tray components. It is responsible for initiating and coordinating multiple-product dispense operations. According to some embodiments, the tray manager 588 may be a module and/or device that operates and/or manages a tray 588-1. The tray 588-1 may, for example, be a sub-component of the tray manager 588 and/or may represents a product dispensing apparatus and its composite rows/slots in the vending machine. Its responsibilities include dispensing products and displaying LED data through the component controller 514. According to some embodiments, the tray manager 588 and/or associated tray 588-1 may be operable to undertake intelligent dispensing operations (e.g., in relation to the dispensing of package promotions such as mystery package promotions).

According to some embodiments, a load manager 590 manages the inventory load processes. It may interact with a bar code scanner via the component controller 514, such as when an operator restocks the machine's inventory. The load manager 590 may also or alternatively fire inventory change events. Examples of load processors and/or devices are described in commonly owned and co-pending U.S. patent application Ser. No. 10/951,296 entitled “METHODS AND APPARATUS FOR DEFINING AND UTILIZING PRODUCT LOCATION IN A VENDING MACHINE” and filed on Sep. 27, 2004, the load management concepts and descriptions of which are incorporated by reference herein.

In some embodiments, a software service 592 may provide miscellaneous application services, including (but not limited to): configuration management, connection pooling, diagnostic logging, and/or scheduling services.

Referring now to FIG. 5B, a schematic block diagram of another exemplary configuration of the software architecture 500 according to some embodiments is shown. The configuration of the software architecture 500 shown in FIG. 5B is a model of a software application for use in some embodiments, designed using UML. The software architecture 500 may comprise various software components and one or more hardware components. For example, the software architecture 500 may comprise a component controller 514, a barcode scanner 522, a database 526, an event dispatcher 576, a GUI manager 578, a promotion manager 582, an inventory analyzer 584, and/or an inventory manager 586. According to some embodiments, the components 514, 520, 526, 576, 578, 582, 584, 586 of the software architecture 500 may be similar to the similarly named and/or numbered components described in conjunction with any of FIG. 1 and/or FIG. 5A herein.

In some embodiments, the event dispatcher 576 may include and/or define three (or more) exemplary events. The events may comprise, for example, an AddItem event 576-1, a ConstructPromotion event 576-2, and/or an OutputPromotion event 576-3. According to some embodiments, some or all of the events 576-1, 576-2, 576-3 may be triggered by an addition of a product to a vending machine.

As shown in FIG. 5B, the component controller 514 may be in communication with a particular vending machine component such as the bar code scanner 522. In some embodiments, the bar code scanner 522 may be similar in configuration and/or functionality to the input device 122 described in conjunction with FIG. 1. The bar code scanner 522 may, for example, be a particular type of input device 122 (i.e., one that is operable to scan barcodes). In some embodiments, the component controller 514 may be in communication with fewer or more components (such as input devices 122 and/or output devices 124) than are shown in FIG. 5B.

In some embodiments, when an operator of the vending machine adds a product to the inventory of the vending machine, the operator may scan a bar code of the product (e.g., using the bar code scanner 522). The component controller 514 communicates the input of the bar code scanner 522 to the event dispatcher 576, which recognizes the input of the bar code scanner 522 as an AddItem event 576-1. As described above, the event dispatcher 576 may act as a proxy broker for events, alleviating the need for components to listen for events from other components. Thus, the event dispatcher 576 may communicate the AddItem event 576-1 to the inventory manager 586, without the need for inventory manager 582 to listen for events from the component controller 514. The inventory manager 582, in turn, may cause a record of the added item and/or of the AddItem event 576-1 to be stored in the database 526 (e.g., via the data access object 574 from FIG. 5A, which is not illustrated in FIG. 5B for purposes of simplicity).

The inventory analyzer 584, in turn, may analyze the current inventory (e.g., based on the addition of the product or based on another event, such as the occurrence of a predetermined time) and store an indication of a need for a mystery promotion for one or more products based on the current state of the inventory. The indication may be stored in database 526. The promotion manager 582 may, according to some embodiments, access the database 526 and determine the need for a mystery promotion. The promotion manager 582 may then, for example, construct a mystery promotion, based on the need. The event dispatcher 576 may determine the occurrence of the ConstructPromotion event 576-2 and communicate the occurrence of this event to the GUI manager 578. The GUI manager 578 may, in turn, cause the mystery promotion to be displayed via a promotion GUI 578-1 sub-component. The promotion GUI sub-component 578-1 and/or the GUI manager 578 may then, for example, construct the OutputPromotion event 576-3. The event dispatcher 576 may, according to some embodiments, detect the OutputPromotion event 576-3 and communicate the occurrence of this event to another component (e.g., promotion manager 582) and thus, indirectly, cause a record of the output of the mystery promotion to be stored in the database 526.

### V. DATABASES

Some embodiments may be implemented using one or more databases, such as the data storage device 126 and/or the database 526. It should be noted that although the exemplary system depicted in FIG. 1 includes eight particular data items 130, 132, 134, 136, 138, 140, 142, 144 stored in the data storage device 126 of the vending machine 110, other data, data file, data storage, and/or database arrangements may be used which would still be in keeping with the spirit and scope of the embodiments described herein. In other words, the some embodiments could be implemented using any number of different database files or data structures, as instead of or in addition to those eight specific data items 130, 132, 134, 136, 138, 140, 142, 144 depicted in FIG. 1. Further, the individual database files could be stored on different servers (e.g., located on different storage devices in different geographic locations, such as on one of the peripheral devices 250, a controller 202, a peripheral device controller 260, and/or any combination thereof). Likewise, the program 128 may also or alternatively be located remotely from the data storage device 126 and/or on another server. In some embodiments, the program 128 may include instructions for retrieving, manipulating, and storing data in the data storage device 126 and/or in association with any or all of the data items 130, 132, 134, 136, 138, 140, 142, 144 as may be useful or practicable in performing the embodiments described herein.

### A. Product Inventory Database

Turning to FIG. 6A and FIG. 6B, data table diagrams illustrating an exemplary data structure 600 according to some embodiments are shown. In some embodiments, the exemplary data structure 600 may be similar in configuration and/or functionality to, or contain, the product inventory data 130 shown in FIG. 1. The exemplary data structure 600 may, for example, include a number of example records or entries, each of which defines a product available for sale from a vending machine (such as the vending machines 110, 210, 310 described herein). Those skilled in the art will understand that the exemplary data structure 600 may include any number of entries.

The exemplary data structure 600 also defines fields for each of the entries or records. The fields may include, for example: (i) a product identifier field 602 (e.g., that uniquely identifies the product); (ii) a product description field 604 that describes the product; (iii) a product category field 606 into which the product has been categorized; (iv) a row position field 608 that identifies a particular row (and, optionally, a particular position within a particular row) of the vending machine in which the product is located; (v) a retail price field 610 of the product; (vi) a minimum selling price field 612 of the product; (vii) a cost field 614 of the product; (viii) an actual (current) product velocity field 616; (ix) a desired product velocity field 618; and (x) a current number in stock field 620 that indicates a number of the product currently available for sale.

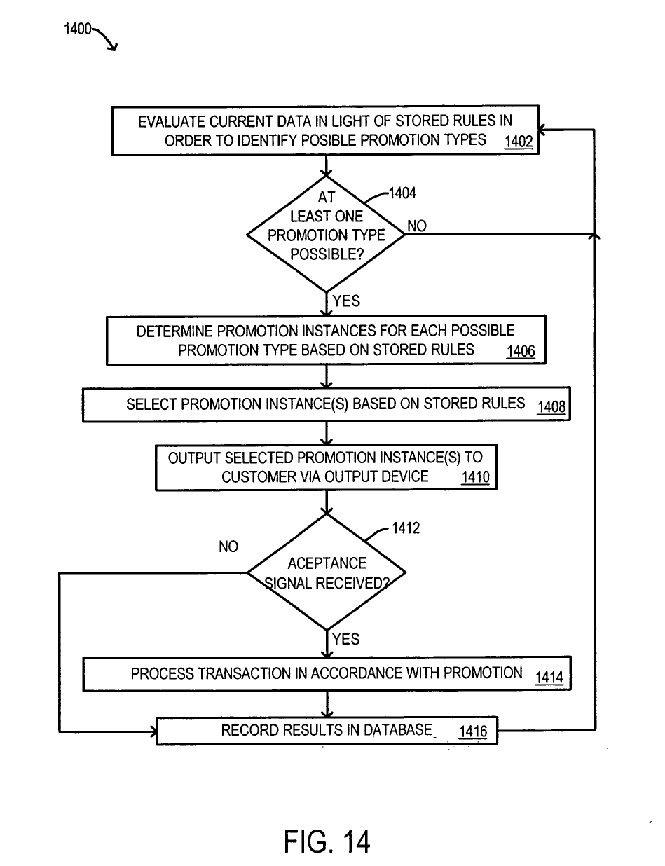

The exemplary data structure 600 may be accessed by various devices and/or for various purposes. For example, a processor (such as the processor 114) of the vending machine may access the exemplary data structure 600 to determine whether a product is currently available for sale from the vending machine (e.g., whether the current number available is greater than zero). In another example, the processor of the vending machine or a processor of a peripheral device may access the exemplary data structure 600 to (i) determine whether a mystery promotion should be output; (ii) identify a type of mystery promotion to be output; (iii) construct a mystery promotion instance, and/or (iv) determine an intelligent dispensing strategy. The usage of the exemplary data structure 600 to construct a mystery promotion instance is described in more detail with respect to FIG. 14.

In some embodiments, the exemplary data structure 600 may be populated, for example, when an operator of the vending machine associated with the exemplary data structure 600 adds products to the vending machine (e.g., the operator may enter a number of each product entered using a keypad of the vending machine or a bar code scanner in communication with the vending machine). The exemplary data structure 600 may also or alternatively be updated when a product is dispensed from the vending machine associated with the exemplary data structure 600.

It should be noted that, in some embodiments, the exemplary data structure 600 may store information associated with more than one vending machine. This may occur, for example, if the exemplary data structure 600 is stored in a controller (such as the controller 202), a peripheral device controller (such as the peripheral device controller 260), and/or a peripheral device (such as a peripheral device 250) that is associated with more than one vending machine 110, 210, 310. In such embodiments, the exemplary data structure 600 may store a vending machine identifier in association with one or more records.

### B. Dispensing Database

Turning to FIG. 7A, a data table diagram illustrating an exemplary data structure 700 according to some embodiments is shown. In some embodiments, the exemplary data structure 700 may be similar in configuration and/or functionality to, or contain, the dispensing data 132 shown in FIG. 1. The exemplary data structure 700 may, for example, include a number of example records or entries, each of which defines information relating to the dispensing of products (e.g., from a vending machine 110, 210, 310 and/or the inventory storage and dispensing device 118, 318a-b described herein). Those skilled in the art will understand that the exemplary data structure 700 may include any practicable number of entries.

The tabular representation of the exemplary data structure 700 also defines fields for each of the entries or records. The fields may include, for example: (i) a first row position field 702, (ii) a second row position field 704, (iii) a dispense field 706, and/or (iv) a probability of collision field 708. According to some embodiments, the exemplary data structure 700 may be utilized to intelligently dispense products from a vending machine. The information stored in the records of the exemplary data structure 700, for example, may be utilized by a processor (such as the processor 114) to cause items to be dispensed from a vending machine in a manner that substantially reduces and/or facilitates reduction of the possibility of product collisions and/or other dispensing complications.

Referring to FIG. 7B (with continued reference to FIG. 7A), for example, an exemplary vending machine inventory-dispensing mechanism configuration 718 is shown. In some embodiments, the exemplary vending machine inventory-dispensing mechanism configuration may be associated with an inventory storage and/or dispensing device such as the inventory storage and dispensing devices 118, 318a-b described herein. The exemplary configuration 718 is provided in an extremely simplified format for ease of description only. For example, the exemplary configuration depicts an embodiment where a vending machine comprises only two rows and two columns of products, labeled columns A and B, from left to right, and rows one (1) through two (2), from top to bottom. The columns and rows are also representative of a simplified two-dimensional cross-section of products available via the vending machine (e.g., more product positions may exist in front of and/or behind those shown). For purposes of this example, and so far as it is applicable and/or relevant, it is to be assumed that the force of gravity acts in a downward direction (i.e., from row one to row two).

In some embodiments, multiple products may be dispensed from a vending machine (e.g., in the case of combination promotions, multiple customer purchases, and/or various upsell promotions). According to some embodiments, it may be desirable to attempt to avoid collisions between such products. In the case that a soda bottle (e.g., glass bottle) or a snack (such as a bag of chips) is dispensed from position A2, for example, a heavy item, such as a drink bottle or can dispensed from position A1 may fall downward to collide with the first product. Such a collision may occur either in the air (e.g., while both items are being substantially simultaneously dispensed) and/or in a product hopper (not shown in FIG. 7B, but presumed to reside underneath the second row). Such a collision may also or alternatively result in damage (i) to either or both products dispensed, (ii) to the vending machine, and/or (iii) to the customer (e.g., via shattered glass), jams, malfunctions, and/or other errors.

According to some embodiments, the first row position field 702 and the second row position field 704 may be illustrative of a matrix of potential combinations of positions from which products may be dispensed. In embodiments where fewer or more product positions are available, the matrix may be smaller or larger, as is or becomes practicable. In some embodiments, the dispense field 706 may store a simple yes or no indicator or flag that is indicative of whether or not a particular combination of dispensing positions is desirable.

In the case that a first product of a package (or otherwise to be dispensed along with one or more other products) is to be dispensed from position A1, for example, and a second product is to be dispensed from position B1, the dispense field 706 may indicate “Y”, as shown. According to some embodiments, a vending machine and/or processor associated therewith (and/or a peripheral device) may determine the value of the dispense field 706 related to the current combination of dispense positions to determine whether the combination of positions is desirable. The “Y” indicator may, for example, cause the vending machine to dispense the products normally and/or substantially simultaneously, as it may be pre-determined that positions A1 and B1 are related in a manner that is not likely to cause a product collision. It is not likely (if even possible) for example, that the horizontally adjacent positions A1 and B1 may dispense products that collide (e.g., since the “fall” paths of products from these positions do not intersect).

If, however, the product positions are situated as positions A1 and A2 in FIG. 7B, the dispense field 706 may indicate an “N” (as shown), to relate to the vending machine that the combination of dispensing positions is undesirable. For example, since the “fall” paths of products dispensed from positions A1 and A2 intersect, product collisions may be possible. To avoid such a potential collision, the vending machine may determine the “N” flag to cause the products to be dispensed in accordance with one or more pre-determined methods. The first product may be dispensed from position A1 or A2, for example, and the vending machine may wait until the occurrence of an event is detected to dispense the second product from the other position.

The dispensing of the second product may be delayed, for example, until (i) the passage of a pre-determined amount of time (e.g., five or ten seconds), (ii) the first product is removed from the hopper (e.g., as detected by one or more door or motion sensors or the like), and/or (ii) an indication is received from the customer (e.g., the customer pushes a button that indicates that it is okay to continue dispensing).

According to some embodiments, such as in the case that a particular product is available in multiple positions in a vending machine, the vending machine may determine a position to dispense the product from. If a first product is available in both positions A1 and B1, for example, and a second product is available in both positions A2 and B2, the vending machine may utilize the information stored in the exemplary data structure 700 to determine which combination or combinations of positions are desirable. The combinations A1 and B2 and/or B1 and A2 (and/or the converse combinations) may be desirable, for example, for they are not likely to result in product collisions. Accordingly, one or more desirable positions for any given product and/or one or more desirable combinations of positions may be utilized to dispense multiple products in a manner that substantially avoids product collisions.

In some embodiments, the values within the dispense field 706 may not all be pre-determined. The values of the dispense field 706 may, for example, be determined periodically and/or on an as-needed or transaction-by-transaction basis. According to some embodiments, standard geometric relationships between positions may not be entirely descriptive of whether or not products may collide. For example, in the case that a vending machine becomes unbalanced (e.g., due to uneven product vending and/or other factors), a product dispensed from position A2 may be hit by a product dispensed from position B1 (such as if the vending machine is tilted to the left). One manner of determining desirable dispensing position combinations may be provided by the probability of collision field 708. Pre-determined and/or dynamically calculated and/or updated probabilities may be calculated and/or otherwise determined, for example, to cause the vending machine to undertake intelligent dispensing measures in the case that products may collide. A threshold may be set or determined, for example, above which products may be too likely to collide to allow and/or attempt normal dispensing of the multiple products.

According to some embodiments, the probabilities and/or flags may be determined based on a particular combination of available product positions associated with a transaction (e.g., as opposed to determining or re-determining such metrics for all products and all positions). A transaction that results in the dispensing of two or more products may, for example, cause the vending machine to determine probabilities and/or flags associated with one or more available positions of the particular purchased products.

In some embodiments, the products themselves may be utilized in determining how to dispense multiple products. Certain types of products may fall differently, for example, and such factors may be utilized to determine desirable dispensing position combinations. It may be known, for example, that a particularly eccentrically shaped product may fall more to the left, and thus positions for other products located to the left may not be desirable and/or as desirable as other available positions. According to some embodiments, the type of product may be utilized to determine whether a potential collision event should trigger intelligent dispensing. In the case that two dispensed products are both bags of chips, for example, a collision may not be an undesirable event for it may not be likely to cause damage (e.g., to the products, vending machine, and/or customer). In some embodiments, the types of products may be analyzed and/or determined to decide whether or not intelligent vending is desirable. The information in the exemplary data structure 700 may not be utilized for a particular transaction, for example, if the product types are deemed compatible to collisions. In one embodiment, the information in the exemplary data structure 700 may be utilized to promote collisions (such as in the case that a customer may desire to see products collide). Similarly, a customer may be given the option of activating or enabling the intelligent dispensing features of a vending machine (e.g., the option may be provided as an incentive or bonus to preferred and/or registered customers).

### C. Coin Inventory Database

Turning to FIG. 8, a data table diagram illustrating an exemplary data structure 800 according to some embodiments is shown. In some embodiments, the exemplary data structure 800 may be similar in configuration and/or functionality to, or contain, the coin inventory data 134 of FIG. 1. The exemplary data structure 800 may, for example, include a number of example records or entries, each of which defines a coin denomination available for dispensing from a vending machine. Those skilled in the art will understand that the exemplary data structure 800 may include any number of entries. The exemplary data structure 800 may also define fields for each of the entries or records. The fields may include, for example: (i) a coin denomination field 802; and (ii) a quantity field 804 representing quantities of the coins of the various coin denominations.

The exemplary data structure 800 may be accessed by various devices and/or for various purposes. For example, the processor 114 of the vending machine 110, 210, 310 may access the exemplary data structure 800 to update a quantity of coins of a particular denomination after receiving an input of coins from a customer and/or after dispensing coins. In another example, a processor of a vending machine or a processor of a peripheral device (e.g., peripheral device 250) may access the exemplary data structure 800 to determine (i) whether a mystery promotion should be output; (ii) identify a type of mystery promotion for output; and/or (iii) construct a mystery promotion instance by populating a parameter of the mystery promotion type with a value determined based on the data in the exemplary data structure 800. An example usage of the coin inventory database is described in more detail with respect to FIG. 14.

The exemplary data structure 800 may be updated, for example, when an operator of the vending machine associated with the database adds coins to the hopper of the vending machine, when a customer inserts coins into the vending machine and/or when the vending machine dispenses coins as change for a transaction.

It should be noted that, in some embodiments, the exemplary data structure 800 may store information associated with more than one vending machine. This may occur, for example, if the exemplary data structure 800 is stored in the controller 202, a peripheral device controller 260 and/or a peripheral device 250 (all as described herein) that is associated with more than one vending machine 110, 210, 310. In such embodiments, the exemplary data structure 800 may store a vending machine identifier in association with one or more records.

### D. Transaction History Database

Referring now to FIG. 9A and FIG. 9B, data table diagrams illustrating an exemplary data structure 900 according to some embodiments are shown. In some embodiments, the exemplary data structure 900 may be similar in configuration and/or functionality to, or contain, any of the transaction history data 136 or the customer data 144 of FIG. 1. The exemplary data structure 900 may, for example, include a number of example records or entries, each of which defines a transaction that has occurred at a vending machine. Those skilled in the art will understand that the exemplary data structure 900 may include any number of entries. The exemplary data structure 900 also defines fields for each of the entries or records. The fields may include, for example: (i) a transaction identifier field 902 (e.g., that uniquely identifies a transaction); (ii) a transaction date field 904 that indicates the date on which the transaction occurred; (iii) a transaction time field 906 that indicates the time at which the transaction occurred; (iv) a products purchased field 908 that stores an indication (e.g., product identifier and/or description) of products purchased during the transaction; (v) a transaction total field 910 that indicates the purchase total for the transaction; (vi) a customer ID field 912 that identifies (e.g., uniquely) various customers of the vending machine; (vii) an amount tendered field 914 that indicates the amount of money input for the transaction by the customer; (viii) a change dispensed field 916 that indicates an amount of change dispensed for the transaction; (ix) a promotion identifier field 918 that uniquely identifies an instance of promotion and/or a promotion type output in association with the transaction (e.g., to the identified customer); (x) a response field 920 of the customer to the instance of the promotion and/or the promotion type; (xi) a mystery package field 922 that indicates whether the promotion is a mystery promotion; and/or (xii) a mystery products field 924 that indicates which products (if any) were given to the customer as mystery products.

The exemplary data structure 900 may be accessed by various devices and/or for various purposes. For example, the processor of the vending machine 110, 210, 310 may access the exemplary data structure 900 to store information about a transaction currently in progress or recently completed at the vending machine. In another example, a processor of a vending machine or a processor of a peripheral device (e.g., the peripheral device 250) may access the exemplary data structure 900 to determine (i) whether a mystery promotion should be output; (ii) identify a type of mystery promotion for output; and/or (iii) construct a mystery promotion instance by populating a parameter of the mystery promotion type with a value determined based on the data in the exemplary data structure 900. An example usage of the transaction history database is described in more detail with respect to FIG. 14.

The exemplary data structure 900 may be updated, according to some embodiments, upon the initiation and/or completion of each transaction at the vending machine associated with the exemplary data structure 900.

It should be noted that, in some embodiments, the exemplary data structure 900 may store information associated with more than one vending machine. This may occur, for example, if the exemplary data structure 900 is stored in the controller 202, a peripheral device controller 260 and/or a peripheral device 250 (all as described herein) that is associated with more than one vending machine 110, 210, 310. In such embodiments, the exemplary data structure 900 may store a vending machine identifier in association with one or more records.

According to some embodiments, the exemplary data structure 900 may be utilized to manage and/or affect the processing of mystery promotions. In the case that mystery promotion instances are populated with products based on revenue management, profitability, inventory, and/or other vending machine metric considerations, for example, a mystery promotion may be populated with the same or similar products a large percentage (or all) of the time. A vending machine located in a particular office building, for example, may commonly sell some products very well, while other certain products may commonly be poor sellers. In the case that such considerations are used to determine which products should populate a mystery promotion, such a promotion may also, accordingly, be commonly populated with certain products. In other words, the “mystery” of which products may be dispensed may be tainted, constrained, and/or limited by consistent, static, and/or unchanging vending machine metrics or characteristics.

In some embodiments, the population of products into mystery packages may be based at least in part on products that have previously been dispensed as components of mystery promotions. The repetition of certain products within mystery promotions may be limited, for example, to decrease the likelihood that a customer may be able to predict the identity of mystery products. Such mystery product management may be incorporated for an entire vending machine or series of vending machines so that all customers coming to the machines may be less likely to be able to guess mystery product identities. In some embodiments, the management of mystery products may be conducted on a per-customer basis.

Since a new customer has no information on which to base a guess of a mystery product identity (other than the list of available products from the vending machine), for example, mystery products (such as mystery package components) may be selected in accordance with the instance population embodiments described herein. In the case that the customer is a repeat customer, however, such as a repeat customer that has previously received mystery products, the results from the normal instance population embodiments may be analyzed to determine if preliminarily selected mystery products have previously been provided as mystery products to the customer. As shown in FIG. 9B in the first row of data associated with the first unique customer, for example, the customer is shown (in the mystery products field 924) as having previously received both “soda x” and “chips” as mystery products (e.g., in a mystery package, such as a mystery package upsell).

According to some embodiments, products preliminarily selected for a current mystery promotion to the customer may be analyzed and/or managed to avoid giving the same product or products to the same customer. In the case that available mystery products are selected from a population of available products, for example, the previously purchased mystery products (i.e., “soda x” and “chips”) may be excluded from the population of potential mystery products (e.g., to avoid having them included in a current mystery promotion). In some embodiments, preliminarily selected mystery products may simply be analyzed to determine if one or more of the products have been previously dispensed as mystery products to the customer. If it is determined that a product has previously been dispensed as a mystery product to the customer, than another product may be substituted for that previously dispensed mystery product in the current mystery product selection. In such a manner, for example, the “mystery” to the customer of what products may be included in a mystery product may remain effective.

### E. Promotion History Database

Referring now to FIG. 10, a data table diagram illustrating an exemplary data structure 1000 according to some embodiments is shown. In some embodiments, the exemplary data structure 1000 may be similar in configuration and/or functionality to, or contain, the promotion history data 138 of FIG. 1. The exemplary data structure 1000 may, for example, include a number of example records or entries, each of which defines a promotion (such as a mystery promotion), redeemable at a vending machine that has been output. Although the embodiments described herein are primarily related to mystery promotions, promotion types may be offered or output that are not mystery in nature (e.g., as shown in FIG. 10). Those skilled in the art will understand that the exemplary data structure 1000 may include any number of entries related to any number or type of promotions practicable. The exemplary data structure 1000 also defines fields for each of the entries or records. The fields may include, for example: (i) a promotion identifier field 1002 that uniquely identifies a promotion (e.g., a promotion type and/or a promotion instance; e.g., the first few digits of the identifier may identify the promotion type and the remaining digits may uniquely identify the promotion instance of the promotion type); (ii) a promotion type field 1004 that indicates the type of the promotion (note that this field may be unnecessary if the promotion identifier field 1002 includes this information), such as a description of the promotion type; (iii) a promotion instance field 1006 that indicates the values included in the parameters of the promotion type; and (iv) an acceptance rate field 1008 of the promotion (e.g., the acceptance rate of the promotion instance or the acceptance rate of the promotion type).

The exemplary data structure 1000 may be accessed by various devices and/or for various purposes. For example, the processor of the vending machine 110, 210, 310 (or controller 202) may access the exemplary data structure 1000 to store information about a promotion output and/or responded to at the vending machine (e.g., the acceptance rate may be updated). In another example, a processor of a vending machine or a processor of a peripheral device (such as the peripheral device 250) may access the exemplary data structure 1000 to determine (i) whether a mystery promotion should be output; (ii) identify a type of mystery promotion for output; and/or (iii) construct a mystery promotion instance by populating a parameter of the mystery promotion type with a value determined based on the data in the exemplary data structure 1000. An example usage of the promotion history database is described in more detail with respect to FIG. 14.

The exemplary data structure 1000 may be updated, for example, upon the construction, acceptance and/or rejection of a mystery promotion. In some embodiments, where the output of a mystery promotion is tracked, the data structure 1000 may be updated upon the output of a mystery promotion (and/or other promotion).

It should be noted that, in some embodiments, the exemplary data structure 1000 may store information associated with more than one vending machine. This may occur, for example, if the exemplary data structure 1000 is stored in the controller 202, a peripheral device controller 260 and/or a peripheral device 250 (all as described herein) that is associated with more than one vending machine 110, 210, 310. In such embodiments, the exemplary data structure 1000 may store a vending machine identifier in association with one or more records.

### F. Available Promotions Database

Referring now to FIG. 11, a data table diagram illustrating an exemplary data structure 1100 according to some embodiments is shown. In some embodiments, the exemplary data structure 1100 may be similar in configuration and/or functionality to, or contain, the available promotions data 140 of FIG. 1. The exemplary data structure 1100 may, for example, include a number of example records or entries, each of which defines a promotion (such as a mystery promotion) that is available for output. Although the embodiments described herein are primarily related to mystery promotions, promotion types may be offered or output that are not mystery in nature (e.g., as shown in FIG. 11). Those skilled in the art will understand that the exemplary data structure 1100 may include any number of entries. The exemplary data structure 1100 also defines fields for each of the entries or records. The fields may include, for example: (i) a promotion identifier field 1102; (ii) a promotion description field 1104; and (iii) a conditions for output field 1106 that describe the conditions under which the promotion may be output. In some embodiments, a rules database may store rules for selecting an available promotion (such as a mystery promotion) for output. In such embodiments, the conditions for output field 1106 may not be included in the exemplary data structure 1100.

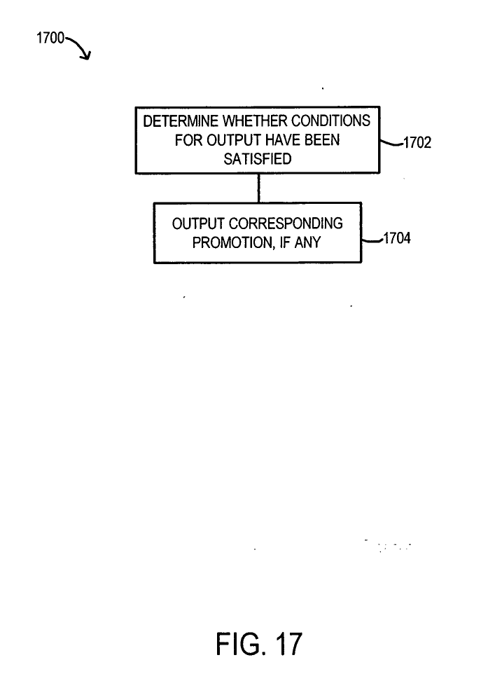

The exemplary data structure 1100 may be accessed by various devices and/or for various purposes. For example, the processor 114 of the vending machine 110, 210, 310 may access the exemplary data structure 1100 to select a mystery promotion for output to a customer conducting a transaction at the vending machine. In another example, a processor of a vending machine or a processor of a peripheral device (such as the peripheral device 250) may access the exemplary data structure 1100 to add a mystery promotion constructed by the processor. A usage of the exemplary data structure 1100 is described in more detail with respect to FIG. 17.

Promotions (such as mystery promotions) may be added or removed from the exemplary data structure 1100 by, for example, an operator of the vending machine associated with the exemplary data structure 1100 (e.g., the operator may access the exemplary data structure 1100 remotely and add or delete promotions as desired). Alternatively or additionally, a device (e.g., the vending machine 110, 210, 310, a peripheral device 250, a controller 202, a peripheral device controller 260, and/or a combination thereof) may add or remove available promotions (e.g., based on availability of products, coins, or success rates of promotions).

It should be noted that, in some embodiments, the exemplary data structure 1100 may store information associated with more than one vending machine. This may occur, for example, if the exemplary data structure 1100 is stored in the controller 202, a peripheral device controller 260 and/or a peripheral device 250 (all as described herein) that is associated with more than one vending machine 110, 210, 320. In such embodiments, the exemplary data structure 1100 may store a vending machine identifier in association with one or more records (e.g., to indicate which promotions are available at which vending machines).

### G. Rules Database

A database of rules may be useful for various processes, in accordance with embodiments described herein. For example, rules may be used to select a mystery promotion for output from a list of pre-constructed mystery promotions. In another example, a rules database may be used to determine which of a plurality of mystery promotion types are eligible for output. In yet another example, a rules database may be used to select a mystery promotion type from a plurality of eligible mystery promotion types. Various types of mystery promotions that may be available in accordance with some embodiments are described elsewhere herein. In some embodiments, other non-mystery promotions may also or alternatively be provided by a vending machine by utilizing various pre-defined and/or stored rules.

In one example, rules may be used to construct an offer by providing guidance for the selection of a value to populate a parameter of a mystery promotion type. In some embodiments, rules may be utilized to implement intelligent dispensing procedures as described herein. According to some embodiments, rules may be utilized (as described elsewhere herein) to increase the effectiveness of mystery promotions (such as by managing mystery products to ensure customers do not often receive the same products as mystery products). At least two embodiments of a rules database are described with respect to exemplary data structures shown in FIG. 12 and FIG. 13. Other uses for one or more rules databases are described with reference to FIG. 14.

Turning to FIG. 12, a data table diagram illustrating an exemplary data structure 1200 according to some embodiments is shown. In some embodiments, the exemplary data structure 1200 may be similar in configuration and/or functionality to, or contain, the rules data 142 of FIG. 1. The exemplary data structure 1200 may, for example, include a number of example records or entries, each of which defines a rule for determining an eligible mystery promotion type, based on a state of coin inventory of a vending machine. Those skilled in the art will understand that the exemplary data structure 1200 may include any number of entries. The exemplary data structure 1200 also defines fields for each of the entries or records. The fields may include, for example: (i) a coin inventory state field 1202 which describes a state of coin inventory of a vending machine; and (ii) an eligible promotion types field 1204 that may be output if the corresponding state of coin inventory is determined to have occurred.

As stated, stored rules that consider available currency data may dictate which mystery promotion types are eligible to potentially serve as the basis for a mystery promotion instance. For example, such rules may dictate that various coin inventory states (e.g., total hopper balance, customer credit balance) should instruct a processor of a vending machine and/or a processor of a peripheral device to identify corresponding mystery promotion types as eligible promotions.

The exemplary data structure 1200 may be accessed by various devices and/or for various purposes. For example, the processor 114 of the vending machine 110, 210, 310 (or the controller 202) may access the exemplary data structure 1200 to determine whether a current state of coin inventory satisfies any of the conditions described in the coin inventory state field 1202, thereby determining whether there are any mystery promotions eligible for output. For example, as illustrated in the exemplary data structure 1200, customers who deposit exact change may be eligible for a combination promotion and/or a fixed price upsell promotion. As also illustrated in the exemplary data structure 1200, customers who are due change after depositing a one dollar ($1.00) or five dollar ($5.00) bill and selecting one or more products may be offered various mystery promotion types such as a combination promotion, a fixed price upsell promotion, and/or a dynamically priced upsell promotion. Also, when the coins in the machine's hopper are less than that which is expected to be required in order to provide all customers with correct change during the sales period, the machine may construct and output dynamically priced upsell promotions. Such mystery promotions would be useful as a coin conservation tactic because customers would be offered additional products (mystery products) in lieu of their change due, which would function to preserve coin inventory in the hopper.

The exemplary data structure 1200 may store rules programmed by, for example, an operator of a vending machine associated with the exemplary data structure 1200 and/or another entity (e.g., a manufacturer of one or more products or an agent of the operator).

Turning to FIG. 13, a data table diagram illustrating an exemplary data structure 1300 according to some embodiments is shown. In some embodiments, the exemplary data structure 1300 may be similar in configuration and/or functionality to, or contain, the rules data 142 of FIG. 1. The exemplary data structure 1300 may, for example, include a number of example records or entries, each of which defines a condition which, if satisfied, dictate one or more promotions that are eligible for output. Unlike the exemplary data structure 1200 of FIG. 12, in which the rules data comprises conditions pertaining only to coin inventory state, the exemplary data structure 1300 may include conditions pertaining to various states of a vending machine that may be considered in combination to determine a promotion type (e.g., a mystery promotion) eligible for output. Those skilled in the art will understand that the rules database may include any number, type, and/or configuration of format of entries.

The exemplary data structure 1300 also defines fields for each of the entries or records. The fields may include, for example: (i) a condition field 1302 that must be satisfied in order for a corresponding promotion type to be eligible for output, and (ii) an eligible promotion types field 1304 that may indicate the one or more mystery promotion types corresponding to the condition.

The exemplary data structure 1300 may be accessed by various devices and/or for various purposes. In some embodiments, the exemplary data structure 1300 may store information associated with more than one vending machine and thus may store a vending machine identifier in association with one or more records.

### VI. MYSTERY PROMOTION TYPES

It should be noted that various mystery promotion types have been referenced with respect to FIG. 12 and FIG. 13. Provided below is a description of each of the referenced mystery promotion types, along with an exemplary rule set for constructing a mystery promotion instance based on each mystery promotion type.

It should further be noted that, in accordance with one or more embodiments, various data parameters may be available to a device (e.g., a vending machine 110, 210, 310, a peripheral device 250, a controller 202, a peripheral device controller 260, and/or a combination thereof) for use in determining eligibility of various mystery promotion types as well as for use in other decisions described herein. The following table (Table 1) includes names and descriptions of many different data parameters that may be available for such decisions.

TABLE 1
Data Parameters

| Parameter Name | Description |
|---|---|
| MinSellingPriceAll | The lowest of the Minimum Selling Prices for |
| | items currently in stock. |
| MinSellingPriceItem | The lowest price at which at which an operator |
| | wishes to sell a particular product. |
| HowManyPromotionsHaveBeenPresented | The number of times that a mystery promotion |
| | has been presented as a promotion to a |
| | customer (such as a particular customer) in one |
| | transaction period. |
| Planned Inventory (PI) | Average Velocity * Time Left in Fill Period (e.g., |
| | hours). |
| Current Inventory (CI) | The number of items currently remaining in the |
| | Vending Machine. |
| Reserved Inventory (RI) | The number of products that are “committed” or |
| | reserved for future purchase through a future |
| | subscription/bulk promotion, as described |
| | herein. |
| CI to PI Indicator (Current Inventory to Planned | (CI − (0.1 * RI) − PI)/CI |
| Inventory Indicator) | Example: If the average velocity of Doritos is |
| | 0.07 bags per hour and there are 168 hours left |
| | until next stock replenishment, the PI is 11.76. If |
| | the current inventory is 18 and reserved |
| | inventory is 5, the CI to PI indicator is then |
| | 31.89%. |
| | Lower indicators tend to indicate that an item or |
| | items are selling at an acceptable pace. |
| | Conversely, higher indicators tend to indicate |
| | that items are selling at a slow pace, and |
| | promotions may be necessary to increase the |
| | pace, as described herein. |
| AmountChangeDue | The amount inserted minus the price of a |
| | selected item or items. |
| ProximityToGoal | This data point serves as a logical “barometer” |
| | that helps the System understand how close its |
| | operation is to the goal that was set forth by the |
| | Operator. For example, if the Operator instructs |
| | the System that the Goal is to have $300.00 |
| | Profit for this Fill Period, then this indicator will |
| | denote the System's performance and provide |
| | feedback as to how close it is to meeting the |
| | Goal. |
| | The indicator may be expressed in terms of % |
| | reached. For example, if the current Profit is |
| | $200.00 and the Goal is $300.00, then the |
| | ProximityToGoal is 66%. The Goal can also be |
| | expressed in more granular period increments. |
| | That is, the Goal of having $300.00 Profit per |
| | Fill Period can also be expressed as $21.42 |
| | Profit per Day (assuming 14 days in a Fill |
| | Period). |
| | This indicator is constantly updated and |
| | evaluated by the system to determine which |
| | mystery promotion is most suitable given the |
| | situation and other influences. |
| AvailableChange | The current inventory of coins available in the |
| | coin mechanism. |
| OverridePromotion | This will indicate whether there is a mystery |
| | promotion type that must be used as the basis |
| | for a promotion, regardless of the conditions. |
| | For example, an Operator may input commands |
| | to always offer Diet Coke ® as an upsell when a |
| | customer purchases Dasani ™ water. |
| TargetValueComboPrice | The price at which a particular mystery package |
| | or combination promotion will be sold. For |
| | example, a mystery combination promotion may |
| | be priced at $1.00 combo or $1.25. |
| TargetValueComboCount | The number of items that the machine has |
| | made available for a given mystery combination |
| | promotion. For example, two or three items can |
| | be included in a mystery combination |
| | promotion. |
| MinBulkPrice | The lowest price at which a particular bulk deal, |
| | contract, etc., or subscription can be sold. |
| MinSellingPriceCategory | This is the average minimum selling price for a |
| | specific category. |
| ItemCost | The cost of a particular item. |
| PromotionTakeRate | (Number of times a mystery promotion has |
| | been presented/Number of times that mystery |
| | promotion has been taken) |
| | This data parameter reflects the rate at which |
| | customers accept particular mystery |
| | promotions. |
| ExpectedPromotionProfit | Sum of (margin of all products in mystery |
| | promotion instance) * promotionTakeRate |

Several embodiments of advantageous processes are described below to illustrate the wide breadth of the embodiments contemplated herein. Many of the embodiments below are described as being performed wholly by a vending machine (such as the vending machines 110, 210, 310 described herein). However, it will be readily apparent to one of ordinary skill in the art that these processes may be performed, in whole or part, by a vending machine, by components of a vending machine and/or peripheral devices, and/or by a device in communication with a vending machine.

Further, although the description herein refers to a vending machine as dispensing units of products, a plurality of vending machines may cooperate to provide units of products. Typically, more than one vending machine may be employed to provide units of different types of products (e.g., a first vending machine which sells snack food and a second vending machine which sells carbonated beverages).

Examples of types of mystery promotions that may be implemented in accordance with some embodiments will now be described, along with an exemplary rule for determining when each respective mystery promotion type should be selected for potential output.

### A. Combination Promotions

According to some embodiments, a memory stores instructions that, when executed by a processor, direct a vending machine or other apparatus to identify, output and/or process mystery package (combination) offers. Although one or more embodiments are described herein as enabling the sale of mystery packages comprising two component products, it should be understood that package offers may provide for the sale of fewer or more component products.

In some embodiments, a mystery package or combination promotion may be constructed and/or output. As stated, a combination promotion allows a customer to purchase at least two products for a single price. In some embodiments though (e.g., because the combination or package is a “mystery”), the number of products included in a combination may not be revealed to or known by the customer. Further, as previously stated, a mystery package combination may, according to some embodiments, comprise only a single product and/or product type.

Applicants have recognized many effects that, when exploited according to many disclosed embodiments, can significantly increase the profit per time period realized by a vending machine. Applicants have recognized that by, for example, selling products at a lower margin, but at a higher velocity or volume, the overall profitability of a vending machine can be increased. Accordingly, in some embodiments, the vending machine may define, output and process mystery combination or package offers enabling customers to purchase a combination of products (from one or more vending machines) for a single price.

By encouraging the sale of at least two mystery products (particularly for a single price, for a discounted price, or with a single payment) according to various disclosed embodiments, both vending machine operators and customers can benefit.

As customers are encouraged, through mystery package offers, to purchase more products than they otherwise would, operators can benefit through increased sales volume. Operators further can benefit from the increased profitability (e.g., per time period, per transaction, per customer interaction) that results when such increases in sales volume sufficiently offset any discount from the packaged products' individual retail prices. Additionally, operators may economically configure machines to accept alternative payment forms that have higher transaction costs (e.g., credit cards) than conventional payment forms (e.g., cash) because of the higher per-transaction revenue and profit that results from selling combinations of mystery products. Such alternate payment forms can prompt customers to spend more than they would have spent otherwise.

Customers can benefit through (i) the net-savings that often results when package prices are compared to the sum of the individual component products' retail prices, and/or (ii) the added convenience gained from the ability to purchase several products in a single transaction. Customers may also benefit by experiencing the “thrill” and/or uncertainty associated with mystery promotions. Further, as vending machines may be configured to economically offer alternate payment forms, customers may benefit from the flexibility provided by an increased number of payment options. Further yet, through mystery package promotions (and mystery promotions in general), operators and product manufacturers may realize the benefit of promoting trials of new products, which may be critical to the success of a product launch (e.g., Coca-Cola® Zero™).

1. Fixed Combination Promotions

In some mystery combination promotion embodiments, mystery promotions may be “fixed” in the sense that the mystery products in a package are pre-selected. In other words, in fixed mystery combination promotion embodiments, customers do not have the ability to select any of the products that will be included in the mystery package. Fixed mystery combination promotions may be desirable as they allow for the pairing of low velocity products with high velocity products, and can accordingly be used to increase overall inventory velocity (i.e., the baseline velocity demand for all products in inventory).

For example, a fixed mystery combination promotion may be constructed when Items A and B are selling below their ideal product velocities, and Item C is selling at or above its ideal product velocity. In such a case, all three products may be offered as a part of a mystery package for a single price, reflecting a discount from that which could be realized if a customer purchased all three products individually. Thus, if the retail prices of Items A and B are fifty cents ($0.50) and seventy-five cents ($0.75), respectively, and the retail price of Item C is set at seventy-five cents ($0.75), the system may construct a mystery combination promotion for the sale of all three products for one dollar and fifty cents ($1.50), reflecting a fifty cent ($0.50) savings to the customer. Such a mystery promotion may be output to customers through one or more output devices (such as the output devices 124, 324 described herein). For example, an LCD display located next to a keypad may read “Get three flashing items for $1.50—a 25% savings!”, and shelf-mounted LED displays located adjacent to various products such as Items A, B and C may flash (e.g., after the mystery promotion is accepted). In some embodiments, the customer may simply be told that three mystery items will be dispensed for the package price, without any indication of a subset of vending machine inventory from which the mystery products may be selected.

Fixed combination promotions are described at length in Applicant's U.S. patent application Ser. No. 09/012,163, filed on Jan. 22, 1998, and which issued as U.S. Pat. No. 6,397,193 on May 28, 2003 as “METHOD AND APPARATUS FOR AUTOMATICALLY VENDING A COMBINATION OF PRODUCTS”, as well as Applicant's co-pending U.S. patent application Ser. No. 10/095,372, filed on Mar. 11, 2002, and published as U.S. Publication No. 2002/0161653 on Oct. 31, 2002, entitled “METHOD AND APPARATUS FOR VENDING A COMBINATION OF PRODUCTS”, the combination promotion concepts and descriptions of each being incorporated by reference herein for all purposes.

2. Open-Ended Combination Promotions

In one embodiment, some or all products selling at or below their corresponding ideal product velocities may be offered for sale to customers at a single, discounted price. For example, the vending machine 110, 210, 310 and/or peripheral device 250 may identify Products W, X, Y and Z as selling below their corresponding ideal product velocities, and may output a mystery combination promotion that provides customers with the ability to purchase an unknown combination of any two of the four products for one dollar ($1.00). More specifically, an LCD display may read “You will get 2 of the red flashing items for $1.00”, and LED displays located proximately to the Products W, X, Y and Z may flash in red.

Once the actual product velocity of an included mystery product increases to a favorable level (e.g., to the ideal product velocity), the control system may cease offering that product in open-ended mystery combination promotions.

The following table (Table 2) illustrates an exemplary rule for determining when a mystery combination promotion should be constructed. Such a rule may be stored, for example, in a rules database configured in accordance with either of the exemplary data structures 1200 and/or 1300 described in conjunction with any of FIG. 12 and FIG. 13.

TABLE 2
Exemplary Combination Promotion Rule

| | |
|---|---|
| If | proximityToGoal is < 85% |
| And | MoneyInserted is null and selectionMade is null. |
| Or | minBulkPrice > moneyInserted >= targetValueComboCount |
| And | overridePromotion is null |
| And | The count of howManyPromotionsHaveBeenPresented < 3 |
| And | Result from Value Combo query is > 4 records |
| Then | Construct Value Combo Promotion |

3. Inventory Group Combination Promotions

According to one embodiment, a vending machine defines at least one inventory group, which includes at least two products that are available for sale by the vending machine. For example, the vending machine may define an inventory group that includes three specific products (e.g., a Snickers® candy bar, a Milky Way® candy bar, and a Twix® candy bar). The vending machine may define an inventory group by storing appropriate data in a database or other memory structure. For example, Table 3 immediately below discloses one manner of defining an inventory group.

TABLE 3
Example Inventory Group Definition Database

| Inventory Group Identifier | Products Included in the Inventory Group |
|---|---|
| G001 | P34 |
| G001 | P35 |
| G001 | P17 |
| G001 | P22 |

In Table 3, the group identified by code “G001” includes the four products identified by codes “P34′, “P35”, “P17′, and “P22”. One of ordinary skill in the art will readily understand any other ways to define an inventory group.

In an embodiment, an inventory group may include one or more products. Furthermore, in an embodiment, a product may be included in more than one group. Furthermore, in an embodiment, a product may be included in no group. In some embodiments, the vending machine defines at least two inventory groups, and each of the at least two inventory groups includes at least one respective product that is available for sale.

As described in detail herein, there are many ways to advantageously determine which products are included in which groups. In one embodiment, for example, products may be ranked according to a profitability and/or sales metric (such as profit contribution factor). Products from a top portion of the ranking (e.g., products that contribute substantially to the machine's profitability) may comprise one inventory control group, for example, while products from a bottom portion of the ranking may comprise (e.g., products that do not contribute substantially to the machine's profitability) another inventory control group. Products may thus be selected from the inventory control groups such that one profitable product and one less-profitable product may be provided in a mystery package. In some embodiments, the inventory control groups may be defined as the top and bottom quartiles and/or other portions of the rankings. According to some embodiments, it may be advantageous to define the inventory control groups as upper and lower percentages of the ranking such as the upper and lower forty percent (40%) of the ranking.

An offer is particularly enticing, and thus is more likely to be accepted, if the offer provides the customer with a discount or other benefit. For example, the vending machine could provide, to the customer, an offer to sell to the customer, for one predetermined price, (i) one unit of any product that is included in a first inventory group, and (ii) one unit of any product that is included in a second inventory group. The predetermined price could reflect a discount over the retail prices of the component products. In other words, the predetermined price could be less than the sum of (a) a price of one unit of any product that is included in the first inventory group, and (b) a price of one unit of any product that is included in the second inventory group.

According to an embodiment, the vending machine outputs an indication of products that the at least one inventory group includes. For example, in an embodiment the vending machine may control an output device to communicate (e.g., to a potential customer near the vending machine) the products that the at least one inventory group includes. When there is more than one inventory group, the vending machine may output, for each of the inventory groups, an indication of products that the respective inventory group includes.

If employed, an output device may comprise a flat panel monitor, CRT, LCD device, or a like device that displays text and/or images (e.g., still graphics, animated graphics) as directed by the vending machine (e.g., that a group includes “any candy bar” or “anything in the top row”). Alternatively or additionally, the output device may comprise an audio output device such as a speaker that is operated by the vending machine to output the appropriate sounds (e.g., synthesized sound, pre-recorded sound), typically verbal instructions/offers to potential customers. Sounds may be output with reference to one or more data files (e.g., wave tables and/or MP3 files).

Alternatively or additionally, the output device may comprise a plurality of colored lighting devices (e.g., LED devices, light bulbs, and/or LCD panels), in which each colored lighting device is located proximate to one product column. The vending machine could selectively illuminate the plurality of colored lighting devices to indicate the products that a particular inventory group includes. For example, each product column may have proximate thereto a pair of LED devices, each a different color (e.g., red and green respectively). To indicate the products that a first inventory group includes, the vending machine could illuminate only the red LED devices that are proximate to the product columns of those included products. To indicate the products that a second inventory group includes, the vending machine could similarly illuminate the appropriate green LED devices.

Several variations may be readily made to the above-described method for indicating an inventory group. For example, each product column may include more than two LED devices. Similarly, each product column could include a single LED device that is capable of displaying more than one color, or otherwise indicating more than one inventory group, as directed by the vending machine. In an embodiment, the products that are included in an inventory group may be indicated by any means for denoting product columns. For example, a sticker, sign, flag or the like could be applied to certain product columns to indicate that the products of that column are included in an inventory group. In such an embodiment, the “mystery” may simply be which of the products of the inventory group may be dispensed as a mystery product or mystery package component.

In an embodiment, the products that are included in an inventory group may be indicated by any means of communicating product information to a customer. For example, a sign (e.g., located atop a vending machine) or advertising (displayed or communicated to the customer in any manner whether or not proximate to the vending machine) may inform a customer that an inventory group includes, e.g., all products of a certain type (e.g., candy bars, snack foods, Mars® products), all products of a certain location (all products in the top row of the vending machine, any product from the right hand vending machine of a connected pair of vending machines, any product in any machine on the fourth floor of a building) and/or otherwise defined groups of products (such as defined by the population of all products available at one or more vending machines). In some embodiments, little or no indication of inventory groups may be provided to the customer to enhance the “mystery” associated with a mystery promotion.

In some embodiments, the indication of inventory groups may be advantageously combined with the provision of an offer to the customer. For example, the vending machine may provide, to the customer, an offer to sell to the customer, for one predetermined price, (i) at least one unit of any product that is included in a first inventory group, and (ii) at least one unit of any product that is included in a second inventory group. According to some embodiments, the customer may not be provided information regarding the definitions, bounds, and/or contents of either or both inventory control groups. The inventory control groups may simply be utilized, for example, to construct mystery package offers, the specific contents of which are unknown to the customer (at least prior to purchase).

a) Proactive Inventory Grouping

In “proactive inventory grouping” embodiments, various data (e.g., product sales data, product cost data, and/or profitability data) may be employed to determine how to apportion inventory among inventory groups (typically at least two inventory groups) before a customer selects any product. After the apportioning of products to inventory groups is complete, mystery package offers encouraging the purchase of at least two mystery products (e.g., from at least two inventory groups) may be output by a vending machine to prospective customers.

Of course, steps performed in a proactive inventory-grouping embodiment do not imply that those steps may only be performed in a proactive inventory-grouping embodiment. A proactive inventory grouping process by which one or more inventory groups are each defined to include one or more respective products may be initiated periodically, substantially continuously or after an event (e.g., a transaction, a restocking, a power-up). It can be desirable that customers throughout each day will receive the same ability to purchase products from the same inventory groups (e.g., one customer will not be provided mystery packages with substantially lesser quality product components than another customer on the same day). Thus, in embodiments where the process is initiated periodically, it may be desirable to set the time interval between process executions (i.e., defining inventory groups) so that the process is executed at convenient times (e.g., every twenty-four (24) hours starting at midnight).

Alternatively or additionally, in embodiments where the process is executed after a triggering event such as a transaction with a customer, it may be desirable that the process is initiated a number of minutes after a transaction, when no intervening transaction has been processed (e.g., the process is initiated thirty (30) minutes after a transaction, provided no intervening transaction has been consummated). In this manner, it may be safe to assume that the machine is experiencing a lull in sales, and that customers accordingly may not witness any change of inventory groupings/apportionments (i.e., assuming at least one inventory control group is displayed via LED devices, a customer is unlikely to walk up to the machine and witness any reallocation of inventory from a “red” group to a “green” group).

b) Reactive Inventory Grouping

In “reactive inventory grouping” embodiments, a customer is offered the ability to purchase a combination of a selected product and a mystery product for a single price by selecting a first product from a first group of inventoried products, and then receiving a mystery product from a second inventory group which is, in some embodiments, revealed to the customer only after the first product is selected. According to some embodiments, the second inventory group may be known to the customer, but the specific product (or products) selected from the second mystery inventory group will typically not be revealed to the customer until after the purchase is made. Indeed, in reactive inventory grouping embodiments, the mystery product may be selected by the machine based upon the first product selected by the customer, and thus may not be determinable until after the purchase is complete and/or after the first product is selected (e.g., and the mystery promotion is agreed to and/or accepted).

Such an embodiment can be desirable because it can provide customers with an entertaining way of interacting with a vending machine. In other words, because in this embodiment the second inventory group is not revealed to the customer until a first product is selected, customers may experience feelings of hopeful anticipation until such a second inventory group is revealed. Similarly, customers may gleefully anticipate the revelation of the mystery product that will dispense from the second inventory group. This feeling may be analogous to the excitement and exhilaration some customers receive when gambling or playing a chance-based game.

Thus, in some embodiments, game-themed messages may be output through the one or more output devices prior to the revealing of the second inventory group and/or the mystery product there from, thereby incorporating a game-like feel into the customers experience with the vending machine. In other words, in some reactive inventory grouping embodiments, output devices may be configured to output game-themed animations, such as spinning slot machine reels, roulette wheels, or the like, before a second inventory group (and/or mystery product) is revealed to the customer. Accordingly, such machines can present customers with the appearance that an ostensibly randomly determined resolution or outcome of a game determines the products that the second inventory group includes and/or the mystery products that are dispensed. In this manner, the second inventory group may be presented as a “prize showcase” from which customers may select a prize.

Further, in some embodiments, reactive inventory grouping may be less computationally intensive or otherwise require less computing resources than, e.g., certain types of proactive inventory grouping, and accordingly can be more desirable to some vending machine operators (particularly in certain hardware environments).

### B. Subscription (or “Bulk”) Promotions

In some embodiments, a mystery promotion for a subscription to one or more products offered at a vending machine may be constructed and/or output. Such subscriptions would allow customers to purchase at least two units of a mystery product, and redeem the mystery products at different points in time (e.g., one the first day, another the following day). Such mystery subscription promotions typically would provide customers with the ability to purchase the mystery products at a discount relative to the total of the retail prices of all the units. For example, a customer may be offered the opportunity to purchase a “subscription” to six (6) cans of a soda, redeemable one per day (1/day), for the price equivalent of five (5) cans. Mystery subscription promotions are a useful mystery promotion type as they allow the system to increase baseline velocity demand for a given mystery product in a predictable way. Thus, any discount provided by the mystery promotion may be offset by the guaranteed increase in volume that results when the customer accepts the mystery subscription promotion, and pays for the subscription.

In general, mystery products associated with a mystery subscription promotion may be selected and/or determined in three ways. First, mystery subscription products may be determined prior to acceptance of the mystery subscription promotion by the customer. Second, the mystery subscription products may be determined after the acceptance of the mystery subscription promotion (e.g., based on current and/or expected machine revenue management parameters). Third, a possibly the most effective option for facilitating enhanced revenue management, each mystery subscription product may be determined upon the occurrence of a subscription event. Each time a customer comes to the vending machine to receive a mystery subscription product, for example, the machine may determine (e.g., based on instantaneous and/or otherwise currently-available revenue management parameters) which product(s) to dispense to the customer. In some embodiments, such as in the brief example provided above, these determinations of mystery subscription products may be at least partially governed by various rules associated with the mystery subscription. The customer may have purchased a mystery subscription directed to only mystery drinks, for example, so however each particular mystery subscription product is determined, it may be required to be a member of the “drink” inventory group and/or product type.

In some embodiments, the system may construct and output a promotion for a mystery subscription to one or more products offered at a vending machine in response to a customer's selection of a particular product.

In an example where a mystery subscription promotion is constructed and/or output in response to a customer's selection of a particular product, a customer may request to purchase Product A for seventy-five ($0.75). In response, the vending machine may output a mystery promotion to purchase a subscription to six (6) units of a product from the same category as Product A, redeemable once per day, for a total mystery subscription price of three dollars ($3.00), or fifty cents per unit ($0.50/unit). In order to realize the savings of one dollar and fifty cents ($1.50), the customer may accept the mystery subscription by depositing three dollars ($3.00) into the vending machine—rather than merely seventy-five cents ($0.75)—and transmitting a signal to the system via an input device to indicate acceptance of the mystery subscription promotion.

In some embodiments, customers who have already deposited the amount necessary for the purchase of a single unit may be offered a mystery subscription for an amount equal to his or her change due. For example, if the customer deposits five dollars ($5.00) and selects an item priced at fifty cents per unit ($0.50/unit), the machine may offer twelve (12) units of a mystery product redeemable over the span of several days (or any other time period) in exchange for the four dollars and fifty cents ($4.50) that otherwise would be returned to the customer. Alternatively, customers who have already deposited the amount necessary for the purchase of a single unit may be prompted to deposit additional currency in order to accept a mystery subscription offer (i.e., a fixed-price upsell offer for a mystery subscription).

Customers who accept mystery subscription promotions may be issued, through a printer (such as described herein), a printout containing mystery subscription information (e.g., an account identifier). The printout may be used by the customer to redeem mystery subscription products upon subsequent visits to the vending machine. For example, the customer may enter a code contained on the printout into the vending machine's keypad. The code may be, for example, assigned to the customer or selected by the customer (e.g., a customer may be allowed to select a personal identification number and/or password and/or may be identified by one or more biometric parameters). The system would in turn determine whether or not the code is valid, and if so, activate a product dispenser corresponding to a determined mystery product, and update an account record in a subscription database. Alternatively, customers who accept subscription promotions may be issued a read/write magnetic stripe card that is updated upon subsequent visits to reflect the redemption of mystery subscription products.

Subscription promotions are described at length in Applicant's U.S. patent application Ser. No. 09/545,596, filed on Apr. 7, 2000, and issued as U.S. Pat. No. 6,298,972 on Oct. 9, 2001, entitled “METHOD AND APPARATUS FOR ESTABLISHING AND MANAGING VENDING MACHINE SUBSCRIPTIONS”, U.S. patent application Ser. No. 09/353,269, filed on Jul. 14, 1999, and issued as U.S. Pat. No. 6,085,888 on Jul. 11, 2000, entitled “METHOD AND APPARATUS FOR ESTABLISHING AND MANAGING VENDING MACHINE SUBSCRIPTIONS”, and U.S. patent application Ser. No. 09/966,608, filed on Nov. 10, 1997, and issued as U.S. Pat. No. 5,988,346 on Nov. 23, 1999, entitled “METHOD AND APPARATUS FOR ESTABLISHING AND MANAGING VENDING MACHINE SUBSCRIPTIONS”, the subscription promotion concepts and descriptions of each being incorporated by reference herein for all purposes.

The following table (Table 4) illustrates an exemplary rule for determining when a mystery subscription (“bulk”) promotion should be constructed. Such a rule may be stored, for example, in a rules database configured in accordance with either of the exemplary data structures 1200 and/or 1300 described in conjunction with any of FIG. 12 and FIG. 13.

TABLE 4
Exemplary Subscription Promotion Rule

| | |
|---|---|
| If | proximityToGoal is < 85% |
| And | moneyInserted is null and selectionMade is null. |
| Or | moneyInserted >= minBulkPrice |
| And | OverridePromotion is null |
| And | The count of howManyPromotionsHaveBeenPresented < 3 |
| And | Result from Bulk query is > 4 records |
| Then | Construct Bulk Purchase Promotion |

### C. Dynamically Priced Upsell Promotions

In some embodiments, a dynamically priced mystery upsell promotion may be constructed and/or output. As stated, a dynamically priced upsell promotion is a promotion to a customer of a first product for the purchase of an additional product for an additional amount that is equal to an amount of change due back to the customer as a result of the customers purchase of the first product. For example, if a customer inserts a one dollar ($1.00) bill into a vending machine and selects a product priced at fifty-five cents ($0.55), the vending machine may automatically prompt the customer that the vending machine will choose an additional product in exchange for their change due (i.e., forty-five cents ($0.45) in the present example).

In some dynamically priced mystery upsell embodiments, customers may be presented with a single mystery product category or type to accept or reject in exchange for their change due. In other dynamically priced mystery upsell embodiments, customers may be presented with several mystery product categories and/or types from which one or more mystery products may be dispensed in exchange for their change due. According to some embodiments, the customer may be offered one or more mystery products in exchange for their spare change. In any case, the system may select one or more products to be included in an upsell offer by considering a variety of data points, including the actual product velocity of a product or products as compared to an ideal product velocity. Similarly, the current inventory to planned inventory ratio (as discussed herein) may be considered.

Using such data, slow moving products can be promoted via dynamically priced upsell promotions. Further, the system may consider the expiration date of perishable products (e.g., as recorded in a product inventory database), so that soon-to-expire products may be offered via dynamically priced mystery upsell promotions. Alternatively or additionally, the category of a product or products may be considered, so that complementary mystery products may be included in dynamically priced mystery upsell promotions (e.g., a mystery salty snack can be offered as an upsell to purchasers of soda). Further, the mystery product or products that may be included in a dynamically priced mystery upsell promotion may be selected by the system according to one or more rules such as those stored in the rules data 142.

A dynamically priced mystery upsell promotion may then be output to the customer in several ways. In embodiments where the customer is provided with the opportunity to accept or reject the purchase of one, pre-selected mystery product category (from which one or more mystery products may be selected by the vending machine) in exchange for the change due, the system may communicate the dynamically priced mystery upsell promotion by outputting promotion content through one or more output devices, including touch screens and LED displays. In embodiments where the customer is provided with the opportunity to select one or more mystery product categories from a plurality of product categories, the dynamically priced mystery upsell promotion may similarly be communicated to the customer on one or more output devices, including touch screens and LED displays. For example, a message may be output to a customer via a touch screen display reading “One of the 3 flashing items will be dispensed for your change due”, and shelf-mounted LED displays corresponding to the qualifying mystery products may accordingly flash. Alternatively or additionally, prices of the qualifying mystery products may be temporarily changed on corresponding LED displays to the amount of change due (i.e., changed to the amount of change due until the customer selects a mystery upsell, rejects the mystery upsell promotion, or does not respond for a threshold period of time, after which the prices would revert back to the corresponding items' retail prices). According to some embodiments, the customer may be presented with a message such as “How about a mystery snack in exchange for your change due?”. One or more mystery products may then be provided to the customer upon acceptance of the mystery promotion. In some embodiments, the mystery product may be selected (e.g., randomly and/or otherwise as described herein) from a subset of products made known to the customer. The LED devices associated with three products in the example above may flash, for example, and the offer may inform the customer that a mystery product will be selected from the group of flashing products (e.g., reducing the uncertainly or perceived uncertainty to the customer).

Further, in yet another alternate embodiment, mystery promotion messages may be provided to the customer through a combination of static, physical means (e.g., on a printed or painted surface on the vending machine) and one or more electronic output devices (e.g., flashing LEDs located next to qualifying products).

In an alternate embodiment, a customer may be provided with the opportunity to receive a coupon or voucher in exchange for their change due. Such a coupon or voucher could be printed via a printer as described herein. The coupon or voucher may allow the customer to redeem an item without depositing additional currency during a subsequent visit. Indeed, such a coupon or voucher may allow the customer to purchase a mystery product (e.g., at a discount) during a subsequent visit to the vending machine. It should be noted that such coupons or vouchers may be redeemable only during a particular sales period, so that overall machine velocity may be increased during the particular sales period.

Various systems and methods for constructing, offering and processing dynamically priced upsell promotions are described in detail with reference to Applicant's U.S. patent application Ser. No. 09/012,163, filed on Jan. 22, 1998, and which issued as U.S. Pat. No. 6,397,193 on May 28, 2003 as “METHOD AND APPARATUS FOR AUTOMATICALLY VENDING A COMBINATION OF PRODUCTS”, as well as Applicant's co-pending U.S. patent application Ser. No. 10/095,372, filed on Mar. 11, 2002, and published as U.S. Publication No. 2002/0161653 on Oct. 31, 2002, entitled “METHOD AND APPARATUS FOR VENDING A COMBINATION OF PRODUCTS”, the upsell concepts and descriptions of each being incorporated by reference herein for all purposes.

Additional systems and methods for constructing, offering and processing dynamically priced upsell promotions are described in detail with reference to Applicant's U.S. patent application Ser. No. 08/920,116, filed on Aug. 26, 1997, which issued as U.S. Pat. No. 6,119,099 on Sep. 12, 2000, entitled “METHOD AND SYSTEM FOR PROCESSING SUPPLEMENTARY PRODUCT SALES AT A POINT-OF-SALE TERMINAL”, and Applicant's co-pending U.S. patent application Ser. No. 09/603,677, filed Jun. 26, 2000, entitled “METHOD AND APPARATUS FOR SELECTING A SUPPLEMENTAL PRODUCT TO OFFER FOR SALE DURING A TRANSACTION”, the upsell concepts and descriptions of each being incorporated by reference herein for all purposes.

The following table (Table 5) illustrates an example of a rule that may be utilized to determine when dynamically priced mystery upsell promotion should be constructed. Such a rule may be stored, for example, in a rules database configured in accordance with either of the exemplary data structures 1200 and/or 1300 described in conjunction with any of FIG. 12 and FIG. 13.

TABLE 5
Exemplary Dynamically Priced Upsell Promotion Rule

| | |
|---|---|
| If | Consumer selects a non-flashing item from Combo Promotion |
| Or | Consumer selects any item while the system was engaged in NO |
| | OTHER Promotion |
| And | proximityToGoal is < 85% |
| And | Change Due from the first Transaction > minSellingPriceAll. |
| | Note: This infers that there was a first transaction (which can be |
| | defined as insertion of money and making a selection) to begin |
| | with. |
| And | OverridePromotion is null |
| And | The count of howManyPromotionsHaveBeenPresented < 3 |
| And | Result from Roundup query is > 4 records |
| Then | Construct Roundup Tactic |

### D. Fixed Price Upsell Promotions

In some embodiments, a fixed price mystery upsell promotion may be constructed and/or output. As stated, a fixed price upsell promotion is a promotion to a customer that purchases a first product for the purchase of an additional product for an additional amount that is not necessarily correlated to an amount of change due to the customer as a result of the customer's purchase of a first product. Thus, a fixed price mystery upsell promotion may provide a customer purchasing a first product with the opportunity to purchase an additional product for an amount equal to his change due plus an additional amount. In some embodiments, the ability to purchase an additional product for an amount equal to change due from a first transaction plus an additional amount may still reflect a discount when compared to the additional product's retail price.

For example, a customer may insert one dollar ($1.00) and select a soda priced at seventy-five cents ($0.75). The vending machine may, in turn, offer a fixed price mystery upsell promotion for a complementary product (e.g., a bag of potato chips and/or a snack) normally priced at seventy-five cents ($0.75) for fifty cents ($0.50), thereby requiring the customer to deposit an additional twenty-five cents ($0.25) to accept the fixed price mystery upsell promotion and realize the twenty-five cent ($0.25) discount.

The additional product or products that may be included in a fixed price mystery upsell promotion may be selected by the system according to the data parameters discussed with reference to dynamically priced mystery upsell promotions, and/or according to rules that may be stored in a rules database.

As in the case of dynamically priced mystery upsell promotions, fixed price mystery upsell promotions may be communicated to customers via one or more output devices, including LCD and LED displays.

The following table (Table 6) illsutrates an exemplary rule for determining when a fixed price mystery upsell promotion should be constructed. Such a rule may be stored, for example, in a rules database configured in accordance with either of the exemplary data structures 1200 and/or 1300 described in conjunction with any of FIG. 12 and FIG. 13.

TABLE 6
Exemplary Fixed Priced Upsell Promotion Rule

| | |
|---|---|
| If | Consumer selects a non-flashing item from Combo Promotion |
| Or | Consumer selects any item while the system was engaged in NO |
| | OTHER Promotion |
| And | proximityToGoal is < 85% |
| And | Change Due from the first Transaction < minSellingPriceAll |
| | Note: This infers that there was a first transaction (which can be |
| | defined as insertion of money and making a selection) to begin |
| | with. |
| And | OverridePromotion is null |
| And | The count of howManyPromotionsHaveBeenPresented < 3 |
| And | Result from Upsell query is > 4 records |
| Then | Construct Upsell Promotion |

### E. Alternate Product Promotions

In some embodiments, an alternate product mystery promotion may be constructed and/or output. That is, where a customer initiates a transaction to purchase a first product, the system may construct and output a promotion for an alternate mystery product in lieu of the initially-requested product. The system may determine which product, products, and/or product categories or types should be offered as substitutes by considering the actual product velocity of a product or products as compared to an ideal product velocity. Similarly, the current inventory to planned inventory ratio (as discussed herein) of a given product or product may be considered. Using such data, slow moving products can be promoted via alternate product offers.

Alternatively or additionally, the profit margins of one or more products may be considered by the system when determining alternate product offers so that higher margin products can be promoted via alternate product offers. Further, the system may consider the expiration date of perishable products (e.g., as may be recorded in a product inventory database), so that soon-to-expire products may be promoted via alternate product mystery promotions. Alternatively or additionally, the category of a product or products may be considered, so that a product within the same category as the product initially requested by the customer is offered as an alternate product (e.g., a soda from the “carbonated drinks” category is offered as an alternate product to a customer who selected Water Y).

Systems and methods for constructing, offering and processing alternate product promotions at vending machines are described in detail in Applicant's co-pending U.S. patent application Ser. No. 09/345,092, filed on Jun. 30, 1999, entitled “VENDING MACHINE SYSTEM AND METHOD FOR ENCOURAGING THE PURCHASE OF PROFITABLE ITEMS”, the alternate promotion concepts and descriptions of which are incorporated by reference herein for all purposes.

### VII. PROCESSES

As stated, one benefit of some embodiments is an increase in vending machine profits (e.g., per fill period). Applicants have recognized that by selling products at a lower margin, but at a sufficiently offsetting velocity or volume, the overall profitability of a vending machine can be increased. Accordingly, in some embodiments, a vending machine may be associated with a target product velocity for a given fill period, and the control system will execute the inventive methods to determine which, if any, mystery promotions are necessary in order to increase volume by an amount expected to yield increased profits by the end of the fill period.

Additionally, some embodiments may function to conserve coin inventory by executing one or more mystery promotions, as described herein. Further, a vending machine may be operable to intelligently dispense multiple products and/or mystery products may be selected to preserve the substantially unpredictable composition of mystery promotions.

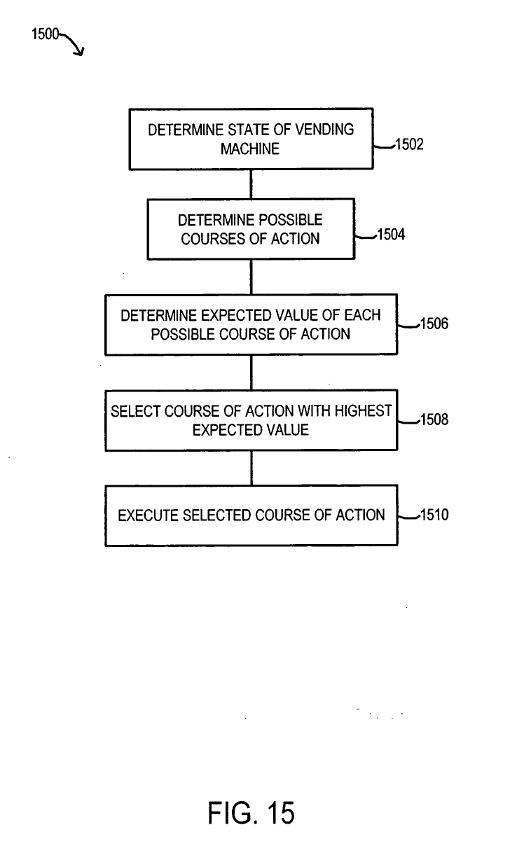

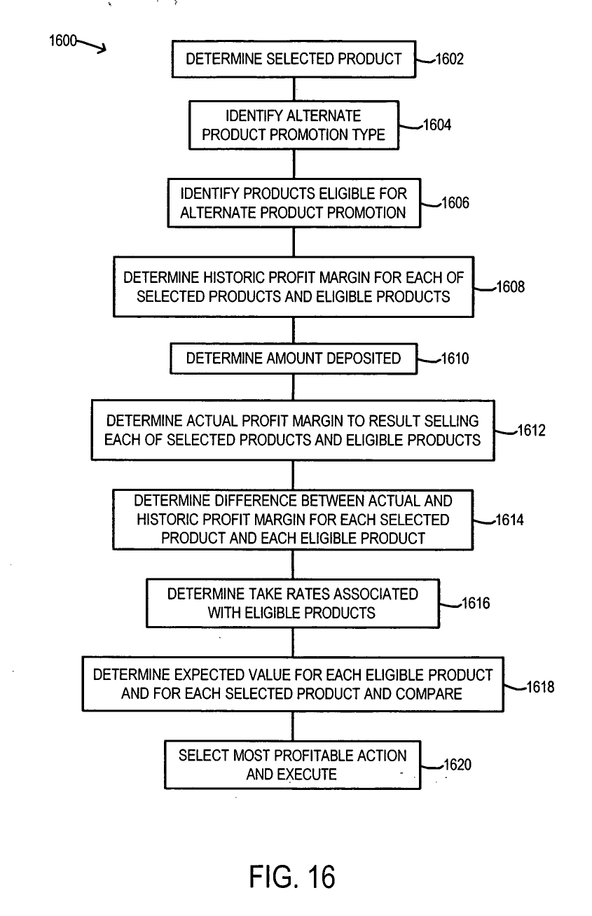

According to some embodiments, a general process designed to increase the profitability of a vending machine within a given fill period is stored in the memory of a vending machine and is executed by the control system (e.g., the processor, RAM, ROM, and/or software). The control system may be the control system of a vending machine 110, 210, 310, the control system of a peripheral device 250, the control system of a controller 202, the control system of a peripheral controller 260, and/or a control system of a combination of any or all of these devices. Generally, from the control system's perspective, the general process may include the three basic steps of (i) determining whether a mystery promotion should be output, based on information programmed to be pertinent to this determination; (ii) if a mystery promotion should be presented, determining the one or more mystery promotion types that are eligible for output, based on one or more eligibility rules; and (iii) determining, for the one or more eligible mystery promotion types, one or more specific mystery promotion instances that may result in an acceptable profit and/or result. The process may then further comprise outputting one or more of the determined mystery promotion instances (e.g., the one mystery promotion instance associated with the highest potential profit may be selected). More detailed explanations of exemplary processes are described below with reference to FIG. 14, FIG. 15, and FIG. 16.

Turning to FIG. 14, for example, a flow diagram of a method 1400 according to some embodiments is shown. The method 1400 may comprise, for example, a method for determining a mystery promotion instance for output to a customer of a vending machine. In some embodiments, the method 1400 (or portions thereof), and all other processes described herein unless expressly specified otherwise, may be performed, for example, by a vending machine 110, 210, 310, a peripheral device 250, a controller 202, a peripheral device controller 260, a user device, another computing device, and/or any combination thereof. Each of these devices is described in detail herein. Additionally, while some of the steps of a process may be performed by a first device, other steps may be performed by another device and/or a combination of devices. Further, the method 1400, and all other processes described herein unless expressly specified otherwise, may include steps in addition to those expressly depicted in the figures or described in the specification without departing from the spirit and scope of some embodiments. Similarly, the steps of the method 1400 and any other process described herein, unless expressly specified otherwise, may be performed in an order other than depicted in the figures or described in the specification, as is practicable and/or appropriate.

In some embodiments, the method 1400 may begins at step 1402, in which the control system evaluates current data in light of stored rules to identify eligible mystery promotion types. Step 1402 may be performed, for example, periodically, substantially continuously, and/or in response to a predetermined event. A predetermined event may comprise, for example, an occurrence of a predetermined time (e.g., a predetermined time from a previous performance of step 1402), an addition of a product to the vending machine, a dispensing of a product from the vending machine, an addition of coins to the vending machine (e.g., by a customer or by an operator), a dispensing of coins from the vending machine, an instruction from an operator, and/or an action of a customer (e.g., an initiation of a transaction, selection of a product and/or a request for a mystery promotion).

According to one embodiment, the method 1400 may be initiated periodically, randomly, upon the occurrence of a predetermined event or substantially continuously in an effort to form “proactive” mystery promotions (e.g., mystery package deals) that are offered to all customers, without regard to whether a first, triggering transaction has been initiated by a customer. Alternatively or additionally, the method 1400 may be initiated in response to a customer action in an effort to form a “reactive” mystery promotion (e.g., a dynamically priced mystery upsell offer) that is offered to a customer in response to the customer's purchase of a first product (i.e., a triggering transaction).

Many types of data accessible to the control system may be considered in making the determination of which, if any, mystery promotion types are eligible to be used as the basis for a mystery promotion. Such data includes, but is not limited to, data made available from (i) machine sensors (e.g., thermometers) or other peripherals (e.g., bill validators or coin acceptors for determining how much money has been deposited by a customer), and/or (ii) local and/or remote databases (e.g., storing product inventory information). For example, the control system may be able to access data indicative of: (a) the time left in a sales period (e.g., seventy-two (72) hours and forty-five (45) minutes to next scheduled restock), (b) current or actual product velocity of one or more products (e.g., average sales of four (4) units per day), and/or (c) product attributes, such as (i) the minimum selling price at which item can be sold, (ii) the full price of a product, (iii) the marginal cost of the item to the operator of the vending machine, (iv) a category description of the product (e.g., salty snack and/or diet beverage), and/or (v) the number of units of the product that are currently available (e.g., the in-stock inventory of the given product).

Thus, in an embodiment featuring a target product velocity (that is intended to increase profitability by increasing volume despite lower per item profit margins due to promotions), the control system may have access to the actual product velocity of some or all products in inventory. The control system may determine that based on the actual product velocity, the target product velocity for some or all products will not be reached based on current prices, mystery promotions, and the like. Accordingly, the control system may at this point determine that one or more mystery promotion types should be executed in an effort to reach the target product velocity.

In one embodiment, a basic calendar indicating holidays, school closings, and/or other periods during which sales may be relatively high or low may be accessible by the control system (e.g., via a database). Thus, the control system may adjust an ideal product velocity to account for such anticipated variations in demand during a sales period.

As stated, in one embodiment employing an ideal product velocity, the control system may determine mystery promotion types, construct and select mystery promotion instances, and output mystery promotions based on the difference between the actual product velocity and the ideal product velocity of one or more products. For example, if an actual product velocity for all products is greater than or equal to an ideal product velocity for all products, then the control system may determine that a mystery promotion is to be constructed and method 1400 may continue to step 1404. In the same example, if an actual product velocity for all products is less than an ideal product velocity for all products, the control system may determine that a mystery promotion is not to be determined and the method 1400 may end or the step 1402 may be repeated in loop form until it is determined that a mystery promotion is to be constructed.

At step 1404 it is determined whether at least one mystery promotion type is eligible to serve as a basis for construction of a mystery promotion instance. Such a determination may comprise, for example, accessing a rules database (e.g., exemplary structures 1200, 1300 of which may be illustrated in FIG. 12 and/or FIG. 13) and determining whether eligibility conditions associated with one or more mystery promotion types are satisfied by the current data. If it is determined, in step 1404, that no mystery promotion types are eligible, the method 1400 may return to step 1402. If it is determined, in step 1404, that at least one mystery promotion type is eligible, the method 1400 may continue to step 1406.

In step 1406 a mystery promotion instance is determined (e.g., constructed or received from another device) for each eligible mystery promotion type determined in step 1404. It should be noted that if, in step 1404, it is determined that more than one mystery promotion type is eligible to serve as a basis for the construction of a mystery promotion instance, each of the eligible mystery promotion types may be utilized in step 1406 (the construction of the mystery promotion instance). Alternatively, in one embodiment, a subset (e.g., one) of the eligible mystery promotion types may be selected (e.g., based on one or more stored rules) and only the subset of mystery promotion types may be utilized in step 1406.

In one embodiment, constructing a mystery promotion instance comprises populating one or more parameters of a mystery promotion type with a value. For example, a parameter of a mystery promotion type may be a product selection. The control system may populate this parameter by selecting one or more products to be the subject of the mystery promotion instance being created and populate this parameter with the product description of the one or more products selected. In another example, a parameter may comprise a price (e.g., a package price or a subscription price, depending on the mystery promotion type serving as the basis for the mystery promotion). In this example, the control system may populate this parameter by determining the price at which the product that is the subject of the mystery promotion is to be offered and inserting this value into the price parameter.

The determination of a value to be inserted into a particular parameter of a mystery promotion type may be performed based on one or more rules stored for such a purpose. In some embodiments, the determination of a value may be inherent in a previous step of method 1400. For example, assume that in step 1402 data is evaluated for each product being offered for sale at a vending machine and the result of the determination is that a particular product (e.g., Product X) is selling below an ideal product velocity. Assume further that in step 1404 it is determined that a combination promotion is an eligible mystery promotion type.

Accordingly, it may be inherent that Product X should be inserted into the product parameter of the combination promotion type (e.g., along with another product such as a product selected by a customer). Similarly, if it is determined in step 1404 that a subscription promotion is an eligible mystery promotion type, it may be inherent that Product X should be the value inserted into the product parameter of the subscription offer type. In another example, the change due from a first transaction may be selected as the price to be inserted into a price parameter of a dynamically priced mystery upsell promotion.

The mystery promotion instances constructed in step 1406 may, in one or more embodiments, be stored in temporary memory pending further evaluation (e.g., pending calculation of the “ExpectedPromotionProfit” for each mystery promotion instance and a comparison of the results of each calculation as described herein).

The following tables (Tables 7-10) illustrate exemplary rules that may be instituted in one or more embodiments for determining how to construct mystery promotion instances for various eligible mystery promotion type described herein.

TABLE 7
Exemplary Dynamically Priced Upsell Promotion Rule Set

| | |
|---|---|
| Query | Select (itemId, itemLocation, itemCategory) |
| | from productInventoryTable |
| | where amountChangeDue >= minSellingPriceItem |
| | and CI to PI Indicator > 10.00% |
| Evaluate | Evaluate the list and rank |
| | a) Ascending by (amountChangeDue − itemCost) − |
| | profit maximization |
| | b) Then by the items that are in the same category as the |
| | first item that was selected |
| | and select at most 6 from the top. |
| Construct | Provide the product list to the Application Control Service to |
| | display the proper promotion execution (e.g., appropriate |
| | promotion content) on LCD as well as to flash the LED's |

TABLE 8
Exemplary Fixed Priced Upsell Promotion Rule Set

| | |
|---|---|
| Query | Select (itemId, itemLocation, minSellingPriceItem, |
| | itemCategory) from productInventoryTable |
| | where minSellingPriceItem is between 25%-55% of first |
| | selection's price |
| | and CI to PI Indicator > 10.00% |
| Evaluate | Evaluate the list and rank |
| | a) Ascending by (minSellingPriceItem − itemCost) − |
| | profit maximization |
| | b) Then by the items that are in the same category as the |
| | first item that was selected |
| | and select at most 6 from the top. |
| Construct | Provide the item list to the Application Control Service to |
| | display the proper promotion execution (e.g., appropriate |
| | promotion content) on LCD as well as to flash the LED's |

TABLE 9
Exemplary Combination Promotion Rule Set

| | |
|---|---|
| Query | Select (itemId, itemLocation, itemCategory) |
| | from productInventoryTable |
| | where minSellingPriceItem <= ((1/targetValueComboCount) * |
| | targetValueComboPrice) |
| | and CI to PI Indicator > 10.00% |
| Evaluate | Evaluate the list and rank |
| | a) Ascending by (targetValueComboPrice − itemCost) − |
| | profit maximization |
| | b) Then by the items that are in the same category as the |
| | first item that was selected |
| | and select at most 6 from the top. |
| Construct | As many combo packages as possible using the items from |
| | the result, targetValueComboCount and |
| | targetValueComboPrice. While constructing the |
| | combo packages, make sure the (Σ item retail |
| | price <= Σ targetValueComboPrice) |
| | Provide the item list to the Application Control Service to |
| | display the proper promotion execution (e.g., appropriate |
| | promotion content) on LCD as well as to flash the LED's |

TABLE 10
Exemplary Subscription Promotion Rule Set

| | |
|---|---|
| Query | Select (itemId, itemLocation) |
| | from productInventoryTable |
| | where CI to PI Indicator > 40.00% |
| Evaluate | Select (itemId) from the result |
| | For each item, calculate bulkPurchaseCount = |
| | (targetBulkPrice − desiredProfit) / |
| | itemId.minSellingPriceItem. Round down to full number. |
| Construct | Bulk packages using the items from the result, |
| | targetValueComboCount and targetBulkPrice. While |
| | constructing the combo packages, make sure the (Σ |
| | item retail price <= Σ targetBulkPrice) |
| | Provide (itemId, itemId.bulkPurchasecount, |
| | itemId.targetBulkPrice) to the Application Control Service |
| | to display the proper promotion execution (e.g., appropriate |
| | offer content) on LCD. |

The above rules illustrate construction of a mystery promotion instance to a particular product. In other embodiments, a subscription may be offered to a broad category of goods (e.g., eight (8) candy bars for five dollars ($5.00), without specifying the candy bar, five (5) carbonated beverages, and/or five (5) beverages within a certain price category or of a certain size). The following table (Table 11) illustrates a rule of how a mystery promotion instance of a subscription to such a category of products may be constructed.

TABLE 11
Exemplary Category Subscription Promotion Rule Set

| | |
|---|---|
| Query | Select (itemId, itemLocation, itemCategory) |
| | from productInventoryTable |
| | where CI to PI Indicator > 40.00% |
| Evaluate | Select (itemCategory) from the result |
| | For each category, calculate bulkPurchaseCount = |
| | (targetBulkPrice − desiredProfit) / |
| | itemCategory.minSellingPriceCategory. |
| | Round down to full number. |
| Construct | Bulk packages using the items from the |
| | result, targetValueComboCount and |
| | targetBulkPrice. While constructing the |
| | combo packages, make sure the (Σ |
| | item retail price <= Σ targetBulkPrice) |
| | Provide (itemId, itemCategory.bulkPurchaseCount, |
| | itemCategory.targetBulkPrice) to the |
| | Application Control Service to display |
| | the proper promotion execution (e.g., |
| | appropriate promotion content) on LCD. |

Returning now to method 1400, at step 1408 the mystery promotion instances constructed in step 1406 are evaluated in light of stored rules and at least one mystery promotion instance is selected accordingly. In general, the stored rules that are considered in step 1408 may be used to determine which one or more mystery promotion instances will be output to one or more customers of a vending machine.

In one embodiment, the stored rules provide for a determination of which mystery promotion instance and/or instances may yield the highest profit margin when considering the rate at which customers have historically accepted such mystery promotion instances when offered. Thus, for each constructed mystery promotion instance, the “ExpectedPromotionProfit” as defined above (e.g., the profit margin of the item in the mystery promotion instance multiplied by the “take rate”, or historic rate at which customers have accepted the mystery promotion instance when previously offered) may be calculated.

Other methods may be employed for determining the projected profitability of several constructed mystery promotion instances, and selecting one or more based on such a determination. For example, a method may be employed that scores the constructed mystery promotion instances based on not only profit margin and “take rate”, but also based on the vending machine's coin inventory state, the available inventory of an item or items, certain arbitrarily imposed override” priorities or weights (e.g., certain products may be favored because of business relationships with product manufacturers), the difference between an ideal product velocity for a given item or group of items and the actual product velocity for the item or group of items, and the like.

Further, in some reactive mystery promotion embodiments, the profitability of an initially requested product may be considered. Thus, in such embodiments, the profitability of the initially requested product may be calculated by multiplying the item's profit margin (retail price minus cost) by the “take rate” of one hundred percent (100%), as the customer has indeed selected the item. The profitability of the initially requested product may then be compared to the expected profitability of mystery promotion instances, and the most profitable choice may be selected by the control system. Thus, it may be determined that the most profitable course of action is to let the customer proceed as initially requested, and not offer any mystery promotions to the customer.

Further still, in reactive mystery promotion embodiments featuring dynamically-priced mystery upsell promotions and/or fixed price mystery upsell promotions, the profitability calculation for a given dynamically-priced mystery upsell promotion instance and/or fixed price mystery upsell promotion instance can include not only the profit margin of one or more additional products, but also the profit margin of a first, triggering product that was initially requested by the customer. Thus, the profitability of a dynamically priced mystery upsell promotion instance may be calculated in accordance with the following formula (Formula 1):
[(Rr−Cr)+(Ch−Cu)]*TR+(Rr−Cr)*(1−TR) (1)

Where:
Rr=retail price of requested product
Cr=cost of requested product
Ch=amount of change due to the customer, as determined by subtracting the retail price of the requested product from the amount of currency deposited in the machine
Cu=cost of given upsell product
TR=number of times that the mystery promotion instance has been accepted divided by the number of times that the mystery promotion instance has been offered

In an alternate embodiment, rather than constructing and selecting mystery promotion instances based on stored rules that consider profitability of the individual mystery promotion instances, the control system may make a threshold profitability determination of the various, potentially eligible mystery promotion types, and proceed to construct mystery promotion instances only for those eligible mystery promotion types that are expected to yield a certain profit. In this embodiment, the processing otherwise required for constructing and evaluating individual mystery promotion instances may be reduced or avoided.

In one or more embodiments, a respective “income contribution factor” (also referred to as a “profit contribution factor”) of one or more products may be considered in constructing a mystery promotion instance. For example, a product may be selected to be the subject of a mystery promotion instance to be output to a customer based on the product's income contribution factor. In some embodiments, a product's income contribution factor may simply comprise the total amount of revenue or profit generated by the product in a certain time period (e.g., a fill period). In other embodiments, a product's income contribution factor may comprise a percentage, such as that which may be calculated by dividing the amount of profit generated by the product in a certain period of time by the total amount of profit generated by some or all products sold through the vending machine in the time period. For example, if a vending machine realized one hundred dollars ($100.00) in total profit during a fill period, and a certain product was responsible for generating twelve dollars ($12.00) of the profit, the product's income contribution factor would be twelve percent (12%).

Returning now to method 1400, at step 1410 the one or more mystery promotion instances selected in step 1408 are output to one or more customers of a vending machine via an output device. The output device may comprise an output device (such as the output devices 124, 324 described herein) of, for example, a vending machine 110, 210, 310, a peripheral device 250 associated with a vending machine, and or a user device (e.g., a cellular telephone).

As described, there are many means by which a mystery promotion may be output at a vending machine. For example, a combination promotion may be output to the customer through a combination of LCD and LED displays. Thus, in the case of a fixed combination offer, an LCD display located next to a keypad may read “Get three of the flashing items for $1.50—a 25% savings!”, and shelf-mounted LED displays located adjacent to the eligible items may flash. Alternatively, in the case of an open-ended combination offer, an LCD display may read “Get 2 of the red flashing items for $1.00”, and LED displays located proximately to several products may flash in red.

Further, as stated, customers who accept mystery subscription promotions may be issued, through a printer such as the one described herein, a printout containing mystery subscription information (e.g., an account identifier such as a customer selected PIN). Alternatively, customers who accept mystery subscription promotions may be provided with mystery subscription information via other output devices, such as LED or LCD displays (e.g., subscription codes may be provided on such displays), audio speakers, or the like.

Additionally, dynamically priced mystery upsell promotions may be output to the customer in several ways. In embodiments where the customer is provided with the opportunity to accept or reject the purchase of one, pre-selected mystery product category in exchange for their change due, the dynamically priced mystery upsell promotion may be communicated to the customer by outputting promotion content through one or more output devices, including touch screens and LED displays. In embodiments, where the customer is provided with the opportunity to select from a plurality of mystery product categories, the dynamically priced mystery upsell promotion may similarly be communicated to the customer on one or more output devices, including touch screens and LED displays. For example, a message may be output to a customer via a touch screen display reading “Get one of the 3 flashing items for your change due”, and shelf-mounted LED displays corresponding to the qualifying products may accordingly flash. Alternatively or additionally, prices of the qualifying products may be temporarily changed on corresponding LED displays to the amount of change due (i.e., the prices may be changed to the amount of change due until the customer selects a mystery upsell product, rejects the mystery upsell promotion, or does not respond for a threshold period of time, after which the prices would revert back to the corresponding items' retail prices).

Further, in one embodiment in which a dynamically priced mystery upsell promotion is selected for output, a customer may be provided with the opportunity to receive a coupon or voucher in exchange for their change due. Such a coupon or voucher could be printed via the printer described herein. In some embodiments, the coupn or voucher may be related to an undisclosed discount, purchase, or transaction. Instead of giving the customer a voucher for a free item, for example, the voucher may be operable to cause the vending machine to dispense one or more mystery items and/or may be redeemable at other POS devices (e.g., retail and/or grocery stores).

In one or more embodiments, a mystery promotion instance may be output via a user device (e.g., a cellular telephone, a pager, or a PC). For example, it may be determined that a combination promotion is to be output to all potential customers within a predetermined range of a vending machine (e.g., all potential customers located in a building that the vending machine is located in or all potential customers within two hundred feet of the vending machine). Accordingly, contact information for such potential customers may be determined and used to output mystery promotion content. For example, cellular telephone numbers and/or pager numbers for such potential customers may be retrieved from a database of available numbers and the proximate ones may be selected based on GPS information available to the system. In another example, electronic mail (e-mail) addresses of all such potential addresses may be retrieved from a database of available e-mail addresses (e.g., a list of e-mail addresses of all persons working in an office building or a particular portion of an office building) and a mystery promotion may be e-mailed to each of the e-mail addresses. In some embodiments, the mystery promotion may be broadcast to various customers. Short-range RF and/or Bluetooth® transmitters may be utilized, for example, to broadcast the mystery promotion to any user device capable of identifying and/or receiving the promotion signals (e.g., within an operational range). According to some embodiments, the broadcast and/or wireless transmission of the mystery promotion may be reactive. In other words, the mystery promotion may be transmitted to a used device upon detection of the user device in proximity to a vending machine (e.g., within several to several hundred feet of the vending machine).

In summary, mystery promotions that may be provided through the inventive system, including but not limited to combination promotions, subscription promotions, dynamically priced upsell promotions, fixed price upsell promotions, and alternate product promotions, may be output to customers via one or more output devices, including but not limited to, LED displays, LCD displays, audio speakers, CRT monitors, or any other suitable output device.

Returning now to method 1400, at step 1412 it is determined whether an acceptance signal has been received in response to the output mystery promotion instance. In other words, it is determined whether a customer has accepted a mystery promotion by so indicating via an input device (e.g., an input device of a vending machine, a peripheral device associated with a vending machine, or a user device). If an acceptance signal has been received, the process continues to step 1414. If an acceptance signal has not been received (e.g., a response indicating rejection of the mystery promotion has been received or no response has been received within a predetermined period of time), the method 1400 may continue to step 1416.

It should be noted that in proactive mystery promotion embodiments, a mystery promotion may be output via an output device of a vending machine and/or a peripheral device associated with a vending machine constantly and/or until another mystery promotion is determined or until it is determined that the mystery promotion is no longer appropriate. In such embodiments, it may be determined whether a customer conducting a transaction at the vending machine during the time that the mystery promotion is being output reacted to the mystery promotion by accepting it or rather whether the customer simply conducted a conventional transaction at the vending machine.

In step 1414 the transaction is processed in accordance with the mystery promotion. Thus, if a customer has accepted a mystery promotion by providing a signal via an input device (e.g., within a threshold amount of time in reactive promotion embodiments, such as by touching an “accept” field of a touch screen display within one (1) minute of the output of the mystery promotion) the following steps may be performed. First, payment may be processed (e.g., detect an amount deposited, compare such an amount to a price, dispense change, and/or request credit authorization from a remote computer). Second, a signal may be transmitted to an item dispensing apparatus to dispense one or more items (e.g., in the case of a combination promotion, several products would be dispensed). According to some embodiments, the dispense signal may comprise information related to intelligent dispensing of combination promotion component products. It may be determined, as described elsewhere herein, for example, which positions within the vending machine should be utilized to dispense multiple products in a manner configured toward avoiding product collisions and/or other interferences. More detailed descriptions regarding how to process various promotions are disclosed with reference to Applicants' various U.S. patents and U.S. patent applications disclosed herein.

It should be noted that, in embodiments where more than one mystery promotion is output to a customer, step 1414 may include an additional determination of which of the output mystery promotions the customer has accepted.

If, in embodiments where a mystery promotion is provided to a customer conducting a transaction at a vending machine, the customer rejects the mystery promotion (e.g., by touching a “reject” field of a touch screen display), the initially requested transaction may be processed in a conventional manner (e.g., processing payment, updating an inventory record in an inventory database, and actuating an item dispensing mechanism). Similarly, should the customer provide no response to the mystery promotion within a threshold period of time (e.g., one minute), it may be assumed, by default, that the customer has not accepted the mystery promotion and the transaction may be processed as it would if the customer had affirmatively rejected the promotion.

In an alternate embodiment, should the customer reject a mystery promotion (affirmatively or by not providing a response within a threshold time), another, alternative mystery promotion (and/or a non-mystery promotion) may be output to the customer (e.g., one with a lower expected profitability than the initially output mystery promotion).

In step 1416, the results of the mystery promotion instance are recorded in one or more databases (e.g., configured similar to the exemplary data structure 1000 and/or storing the promotion history data 138 described herein). For example, in a reactive mystery promotion embodiment, an indication of the mystery promotion instance may be stored in association with an indication of the customer's response to the mystery promotion, a time at which the mystery promotion had been output, and an indication of the product initially requested by the customer. In another example, in a proactive mystery promotion embodiment, an indication of each acceptance of the mystery promotion may be stored in association with a time of the acceptance and an indication of a product initially requested by the customer (if any).

For example, a customer may walk up to a vending machine at which a proactive mystery promotion is being output and simply accept the proactive mystery promotion, without first indicating an initially requested product. In another example, a customer may walk up to a vending machine and, after or while the customer is selecting a product, be presented with a proactive mystery promotion (a mystery promotion the output of which was triggered by the customer's selection of a product but which was not constructed based on information associated with the customer's transaction).

Step 1416 may include, according to some embodiments, the steps of (i) updating an inventory record in an product inventory database to reflect the vending of items, (ii) updating an inventory record in a coin inventory database to reflect a change in a coin inventory as a result of the transaction, (iii) creating or updating a transaction record in a transaction history database to indicate the acceptance or rejection of the mystery promotion, (iv) creating or updating an acceptance or “take” rate associated with a mystery promotion in a mystery promotion history database to reflect the acceptance or rejection of a mystery promotion, and/or (v) creating or updating a record in a rules database (e.g., creating and/or modifying the rules data 142 described herein). In an example of (v), a rule for selecting or constructing a mystery promotion instance may be modified or deleted if the mystery promotion is rejected a predetermined number of times, in an iterative process for refining the rule.

It should be noted that the step of updating of an acceptance or “take” rate associated with a mystery promotion in a promotion database is advantageous in that it provides updated market data that can be used in subsequent execution of the various processes described herein. For example, updated take rates may be used to identify possible mystery promotion types, construct mystery promotion instances for each possible mystery promotion type based on stored rules, and/or select mystery promotion instances based on stored rules. In this manner, the inventive system can adapt to its local market by identifying, constructing, and outputting mystery promotions that are successful in the local market, and by ceasing to offer those mystery promotions that are unsuccessful. For example, because a mystery promotion instance's take rate may be considered at 1408 when determining the projected profitability of a given mystery promotion instance, those mystery promotion instances with higher historical take rates may be more likely to be output as mystery promotions to customers in 1414 than those mystery promotion instances with relatively lower historical take rates.

The method 1400 may then, for example, return to step 1402. Alternatively, the method 1400 may end until an evaluation of current data is triggered. An evaluation of data, and thus the initiation of the method 1400, may be triggered by, for example, a predetermined event (e.g., the occurrence of a predetermined time from a previous evaluation of data, an addition of a product, a dispensing of a product, and/or a dispensing of change). In another example, the method 1400 may be triggered by an instruction from an operator. In yet another example, the method 1400 may be triggered by a request from a customer for a promotion (e.g., a mystery promotion).

### VIII. EXAMPLES

An example of the method 1400 will now be described. Reference will be made to the exemplary data structure 600 of FIG. 6A and FIG. 6B (e.g., representative of stored product inventory data 130), the exemplary data structure 700 of FIG. 7 (e.g., representative of stored dispensing data 132), the exemplary data structure 800 of FIG. 8 (e.g., representative of stored coin inventory data 134), the exemplary data structure 900 of FIG. 9 (e.g., representative of stored transaction history data 136), the exemplary data structure 1000 of FIG. 10 (e.g., representative of stored promotion history data 138), and the exemplary data structures 1200, 1300 of FIG. 12 and FIG. 13 (e.g., representative of stored rules data 142). For purposes of this example, it is assumed that a control system of a vending machine 110, 210, 310 and/or peripheral device 250 performs the steps of method 1400, unless expressly specified otherwise.

The control system may perform step 1402, for example, by (periodically, substantially continuously, and/or when triggered by a predetermined event) accessing either or both of the exemplary data structures 1200, 1300 and determining whether any of the conditions stored in the condition fields 1202, 1302 are satisfied by current data. For example, the control system may, every hour, determine whether or not less than three (3) days remain in the current fill period. The control system may further determine whether or not a transaction is currently in process and/or whether the average actual product velocity of all inventoried products is less than the average product item velocity of all inventoried products (i.e., determine whether or not overall sales are slow). Based on these determinations, the control system may determine which, if any, mystery promotion type is eligible for output to a customer.

Assume, for the present example, that the control system determines that (i) more than three (3) days remain in the fill period, and (ii) a customer initiated a first transaction (Transaction A), as follows:

(A) Bob Jones, a customer, inserted one dollar ($1.00) into the vending machine and elected to purchase one unit of Soda X for sixty-five cents ($0.65).

The control system may thus determine that a mystery package promotion is not an eligible mystery promotion type because the first set of conditions (i.e., the first record) of the condition field 1302 stored in the exemplary data structure 1300 of FIG. 13 are not satisfied by the current data. In other words, because more than three (3) days remain in the fill period, the mystery package promotion condition is not satisfied (as defined by the exemplary first rule stored in the condition field 1302 shown in FIG. 13). The control system may continue, for example, to perform step 1404 by determining whether a fixed price mystery upsell promotion, a dynamically priced mystery upsell promotion, or an alternate product mystery promotion is eligible based on whether the any of the conditions stored in the condition fields 1202, 1302 are satisfied by the current data. It should be noted that in some embodiments, other promotions in addition to or in place of mystery promotions may be considered and/or applied. Assume, for the present example, that the control system determines that the third set of conditions (i.e., the third row) stored in the condition field 1302 of the exemplary data structure 1300 of FIG. 13 are satisfied based on the following determinations.

The control system may first determine, for example, whether the average actual product velocity of all inventoried products is less than the average ideal product velocity of all inventoried products (i.e., determine whether or not sales are slow). Such a determination may be made, for example, by determining an average value for the metrics stored in the actual (current) product velocity field 616 of the exemplary data structure 600, determining an average value for the metrics stored in the desired product velocity field 618, and comparing the two determined averages.

The control system may then, for example, determine whether the coin inventory is sufficient to provide change for all anticipated transactions throughout the remainder of the fill period. The control system may determine this by evaluating stored transaction data (e.g., in the exemplary data structure 900 of FIG. 9) and the coin inventory state (e.g., as indicated by the data stored in the exemplary data structure 800 of FIG. 8). For example, the control system may (i) calculate an anticipated amount of change due throughout the remainder of the fill period by determining a projected transaction volume and an average change due per transaction, and (ii) compare the anticipated amount of change due to the amount of coins currently in the vending machine's hopper.

If the data in the exemplary data structure 900 of FIG. 9 were utilized for the above determination, it would be determined that the transaction volume is three transactions per day (3 transactions/day), with an average of thirty-five cents ($0.35) dispensed as change per day. Thus, the control system may reasonably anticipate that, assuming there are five (5) days left in the fill period, approximately one dollar and seventy-five cents ($1.75) in change will be needed to provide change to customers for the balance of the fill period (e.g., further assuming all future customers pay with dollar bills and no more coins are added to the hopper). It should be noted that alternative and additional methods of forecasting a future amount of change due are provided in International Patent Application Publication Number WO 98/58355, entitled “CURRENCY HANDLING APPARATUS”, published Dec. 23, 1998, the change and change forecasting concepts and descriptions of which are incorporated by reference herein.

If the data in the exemplary data structure 800 of FIG. 8 were utilized for the above determination, it would be determined that a coin total of one dollar and twenty-five cents ($1.25) exists in the coin hopper ((seven nickels*$0.05 value)+(four dimes*$0.10 value)+(two quarters*$0.25 value)). This is not sufficient to meet the anticipated one dollar and seventy-five cents ($1.75) in change needed for the remainder of the fill period.

It should also be noted that, rather than forecasting the ability of the vending machine to make correct change for the remainder of a fill period based on the change stored in the machine, in alternate embodiments a forecast of available change may be estimated based on the rate at which customers use particular denominations to make purchases. Thus, in such alternate embodiments, the control system may consider coins that it expects to receive in determining whether or not the machine will likely have sufficient coin inventory to provide future customers in the fill period with correct change.

Based on the above determinations, the control system may determine at step 1404 that dynamically priced mystery upsells and alternate product mystery promotions are eligible mystery promotion types. This is because the third conditions stored in the conditions fields 1202, 1302 of either or both of the exemplary data structures 1200, 1300 of FIG. 12 and/or FIG. 13 are satisfied by the current data. In other words, more than three (3) days remain in the fill period, the actual average product velocity of all inventoried products is less than the ideal average product velocity of all inventoried products, and the coin inventory is less than the forecast amount of coins necessary for providing change until the end of the fill period. It should be noted that dynamically priced mystery upsell promotions, as they function to offer customers additional products in exchange for their change due, provide a way for machines to engage in coin conservation when necessary, as is the case in the present example. Further, alternate product mystery promotions may always be desirable “reactive” mystery promotions because they function to encourage customers to purchase higher margin products than that which they initially selected (e.g., although they may not inherently preserve or enhance coin stock).

According to some embodiments, the control system may then continue at step 1406 to determine at least one mystery promotion instance for the eligible mystery promotion types based on the stored rules. For example, a mystery promotion construction rule for the alternate product mystery promotion type may provide that instances are to be created (and stored in temporary memory pending further evaluation) for every product within the same category as an initially selected product that (1) has a gross margin greater than the selected product (where gross margin=item retail price−marginal cost), (2) has a retail price equal to the initially selected product, and (3) has an actual product velocity less than its ideal product velocity. Further, a mystery promotion construction rule for the dynamically priced mystery upsell promotion type may provide that instances are to be created (and stored in temporary memory pending further evaluation) for every product that (1) has a different product category than that which was initially selected (e.g., a complementary product), (2) has a minimum selling price less than or equal to the change due to the customer from the first, triggering transaction, and (3) has an actual product velocity less than its ideal product velocity.

The control system may then, for example, determine a mystery promotion instance by, for example, constructing the mystery promotion instance or receiving a constructed mystery promotion instance from another device in response to a request from the control system. For example, the control system may access a rules database to determine a rule for constructing a combination promotion following stored promotion construction rules. It should be noted that, in some embodiments, the exemplary data structure 1300 of FIG. 13 may include one or more additional fields for each eligible mystery promotion type, the fields storing one or more rules for constructing the respective mystery promotion types. In other embodiments, one or more rules for constructing a mystery promotion type may be stored in another rules database or elsewhere in a memory accessible by the control system. For example, a control system of a peripheral device 250 may access (e.g., search) data stored on another device (e.g., a controller 202 and/or a peripheral device controller 260) to determine the rule or rules. Alternatively, the control system may determine the rule by transmitting a request to another device (e.g., a controller 202 and/or a peripheral device controller 260) for the rule.

In an alternate embodiment, the control system may determine one or more mystery promotion instances by transmitting an indication of the selected mystery promotion type to another device (e.g., a controller 202 and/or a peripheral device controller 260), requesting a construction of a mystery promotion instance and may receive, in response, one or more constructed mystery promotion instances. Assume, for purposes of the present example, that the control system itself constructs the one or more mystery promotion instances.

As described, a mystery promotion instance may be constructed by populating each parameter of a mystery promotion type with a respective value. The value may be selected based on the construction rule associated with the mystery promotion type.

The control system may, for example, first determine a mystery promotion instance for an alternate product mystery promotion type. In order to construct a mystery promotion instance for an alternate product mystery promotion, the control system may access a product inventory database, such as one configured in accordance with the exemplary data structure 600 of FIG. 6A and FIG. 6B. Assume, for this example, that the data in the exemplary data structure 600 is utilized to construct the one or more mystery promotion instances in step 1406. Based on this data and the data associated with Transaction A, the control system would determine, based on the above rule set for alternate product mystery promotions, that Soda Y could be potentially output as an item in an alternate product mystery promotion.

For example, Soda Y (i) is a product within the same category as the initially selected product (Soda), (ii) has a gross margin greater than the selected product (Soda Y's margin=$0.45, while Soda X's margin=$0.40), (iii) has a retail price equal to the initially selected product ($0.65), and (iv) has an actual item velocity less than its ideal item velocity (0/day is less than 2/day). Thus, Soda Y may be selected as the value for the product parameter of the alternate product mystery promotion instance.

The control system may then determine a mystery promotion instance for the dynamically priced mystery upsell promotion type, also using the data in the exemplary data structure 600. Based on this data and the data associated with Transaction A, the control system would determine, based on the rule set for dynamically priced mystery upsells, that Doritos® qualifies as a dynamically priced mystery upsell promotion instance because Doritos® (i) are from a different product category than that which was initially selected (Doritos® are from the “chips” category, whereas Soda X is from the “soda” category), (ii) have a minimum selling price less than or equal to the change due to the customer (Bob Jones) from Transaction A (here, $0.35 is due Bob Jones for his purchase of a $0.65 item with a $1.00 bill, while the minimum selling price of Doritos® is $0.25), and (iii) have an actual product velocity less than their ideal product velocity (0.5/day is less than two/day). Thus, Doritos® may be selected as the value for the product parameter of the dynamically priced mystery upsell product parameter.

The control system may then select one of the two mystery promotion instances constructed (step 1408). Assume, for the present example, the control system compares the two mystery promotion instances (alternate product mystery promotion of Soda Y vs. dynamically priced mystery upsell of Doritos®) to determine which is more profitable when considering the products' respective margins and the mystery promotion instances' respective “take” (i.e., acceptance) rates. As described above, the control system may compare the mystery promotion instances in such a manner by determining the “ExpectedPromotionProfit” as defined herein (i.e., the profit margin of the product in the mystery promotion instance multiplied by the “take” rate, or historic rate at which customers have accepted the mystery promotion instance and/or type, when previously offered). In some embodiments, such as in the case that take rates for various types of mystery promotions may be substantially similar and/or the same, an available mystery promotion type and/or instance may be randomly selected for output to the customer.

The respective profit margin for Soda Y and Doritos® can be determined from the data in the exemplary data structure 600. The data illustrates, for example, a forty-five cent ($0.45) margin for Soda Y (calculated as the sixty-five cent ($0.65) retail price of Soda Y minus the twenty cent ($0.20) cost of Soda Y) and a fifteen cent ($0.15) margin for Doritos® (calculated as the thirty-five cent ($0.35) price of the Doritos® in the dynamically priced mystery upsell offer minus the twenty cent ($0.20) cost of the Doritos®).

The take rate for each product, when offered in an alternate product mystery promotion or a dynamically priced mystery upsell promotion, respectively, can be determined from a promotion history database, such as a database configured in accordance with the exemplary data structure 1000 of FIG. 10. According to some embodiments, the take rates of mystery promotions may not be influenced by the specific products offered due to the fact that the customer (Bob) does not know which product(s) will be dispensed prior to accepting the mystery promotion. Accordingly, the take rate utilized for mystery promotion instance selection may simply comprise the take rates for the mystery promotion types or takes rates for product types (e.g., soda, snack, and/or candy). Assume the data in the exemplary data structure 1000 is used in the present example. Based on this data, the expected profitability of the instance “Mystery soda rather than Soda X?” (e.g., where the mystery soda is Soda Y) can be estimated as approximately thirty-one cents ($0.31=70% of $0.45). Also based on this data, the expected profitability of the instance “Mystery snack in addition to Soda X?” (e.g., where the mystery snack is Doritos®) can be estimated as fifty-four cents ($0.54=(95%*$0.15)+(100%*0.40)=($0.14+$0.40)). It should be noted that the calculation for the dynamically priced mystery upsell promotion “Mystery snack in addition to Soda X?” takes into account the profit margin for Soda X (forty cents ($0.40)) and the take rate for Soda X (one hundred percent (100%), since the customer has requested to purchase Soda X). Thus, the control system, based on the criteria in the present example, may select the instance “Mystery snack in addition to Soda X?” as the mystery promotion instance to be output.

Accordingly, in step 1410, the mystery promotion instance “Mystery snack in addition to Soda X?” is output to Bob Jones via an output device. For example, an LCD display may read “How about a Mystery snack in exchange for your $0.35 change due?”, or “How about a Mystery snack to go with your Soda, in exchange for your change due?”. Bob may decide whether to accept the mystery promotion or not, and the transaction will be completed as previously discussed with reference to the remaining steps 1412, 1414, 1416 illustrated in FIG. 14.

Referring now to FIG. 15, a flow diagram of a method 1500 according to some embodiments is shown. One embodiment illustrated by the method 1500 of FIG. 15 will be introduced before the steps of the method 1500 are described in detail.

In one or more embodiments, a vending machine may be regarded as having a number of possible “states”. A state may be defined by any one or more factors relevant to overall machine profitability or to some other metric of the vending machine. Examples of such factors include, but are not limited to: (i) a number of each type of product contained within the vending machine; (ii) a number of nickels, dimes, and/or quarters contained within the vending machine; (iii) a value of all the bills contained within the vending machine; (iv) a time remaining in the fill period; (v) a time of day; (vi) the weather; (vii) the season; and/or (viii) the date. For example, a first state may correspond to a vending machine that has six (6) Diet Cokes® remaining, nine (9) Cokes®, three (3) orange drinks, seven (7) bags of potato chips, twelve (12) Snickers® bars, four hundred and twenty-seven dollars and eighty-five cents ($427.85) in currency, and for which there are seventy-two (72) hours remaining in the fill period. Such a state description may be abbreviated, for example, as “S(6, 9, 3, 7, 12, $427.85, 72:00),” where it is understood that the first number represents the number of Diet Cokes® remaining, the second number represents the number of Cokes® remaining, and so on.

A vending machine may transition from one state to another, e.g., through the occurrence of a transaction, through the passage of time, through change in the weather, or through any other factor relevant to its state. For example, if a vending machine is in state “S(6, 9, 3, 7, 12, $427.85, 72:00)”, and five (5) minutes pass without any transaction occurring, the vending machine then reaches the state “S(6, 9, 3, 7, 12, $427.85, 71:55)”. The latter state is the same as the former in every respect except that in the latter state, only seventy-one (71) hours and fifty-five (55) minutes remain, versus seventy-two (72) hours in the former state. If a customer now buys a single Coke® from the vending machine for a price of one dollar ($1.00), in a transaction that lasts for one (1) minute, the new state of the vending machine after the transaction will be “S(6, 8, 3, 7, 12, $428.85, 71:54)”. As is apparent, the number of Cokes® has declined by one (1), the amount of currency in the vending machine has increased by one dollar ($1.00), and the amount of time remaining in the fill period has decreased by one (1) minute. Of course, numerous other state transitions are possible.

Each state “S” of the vending machine may be assigned, and/or may correspond to, a metric that may indicate, for example, the favorability of the state S. For instance, state “S(6, 8, 3, 7, 12, $428.85, 71:54)” may correspond to the metric “98742,” while state “S(5, 9, 3, 7, 12, $428.90, 71:54)” may correspond to the metric “98915.” If a higher value for the metric corresponds to a more favorable state of the vending machine, then the latter state is a more favorable state than the former, since the latter has the higher metric.

An exemplary “favorability” metric may comprise an expected value of the contents of a vending machine at the time of the next restock event. The expected value may be based on an actual value of the contents of the vending machine at the time of the next scheduled restock, which may be derived by the following formula (Formula 2):

$$actual value = value of currency in the machine + \sum k ( \# product k ) \times ( cost of product k ) , where “ k ” is taken over all products in the vending machine . \qquad ( 2 )$$

Prior to the end of the fill period, the actual value at the next restock event cannot be determined with certainty, since it may depend on unpredictable activities of customers. For example, the amount of currency in the machine at the next restock event will depend on the number of people that make purchases from the vending machine, the number of products they buy, and the prices they pay, none of which may be predicted with certainty. Therefore, the expected value of a vending machine at the next restock event may comprise a weighted average of various possible actual values that may occur at the time of the next restock event. The weightings of the actual values correspond to the probabilities with which each of the possible actual values may come to pass. The probabilities may be based on models of human behavior and based on the amount of time remaining to the next restock event.

To illustrate an exemplary determination of an expected value of the contents of a vending machine at the end of a fill period, a simplified vending machine will be assumed. The simplified vending machine has two products: Product A and Product B. Product A has a cost (i.e., to the vending machine operator) of thirty cents ($0.30), and Product B has a cost of twenty ($0.20). One (1) minute prior to end of the fill period, the simplified vending machine has one hundred dollars ($100.00) in currency, five (5) units of Product A in stock, and one (1) unit of Product B in stock. The state of the simplified vending machine may therefore be written, “S(5, 1, $100.00, 0:01)”. Assume, for this example, that the probability of no transactions occurring in the next minute is eight tenths (0.8), that the probability of one transaction occurring in the next minute is two tenths (0.2), and that the probability of more than one transaction occurring in the next minute is zero. Note that these probabilities may be derived from models based on historical data about transaction frequency at the vending machine.

If no transactions occur at the vending machine in the next minute, then at the end of the fill period, the state of the vending machine will be “S(5, 1, $100.00, 0:00)”, and the actual value of the vending machine will be:

“S(5, 1, $100.00, 0:00)”:
actual value=$100.00+5×$0.30+1×$0.20=$101.70.

Assuming there is one transaction in the next minute, further probabilities may be utilized. Assume that, in a given transaction, there is a probability of four tenths (0.4) that Product A is purchased for one dollar ($1.00), resulting in a state of “S(4, 1, $101.00, 0:00)”. Assume also that there is a probability of six tenths (0.6) that Product B is purchased for eighty cents ($0.80), resulting in a state of “S(5, 0, $100.80, 0:00)”. The actual values for each of these two resultant states are:

“S(4, 1, $101, 0:00)”:
actual value=$101.00+4×$0.30+1×$0.20=$102.40.

“S(5, 0, $100.80, 0:00)”:
actual value=$100.80+5×$0.30+0×$0.20=$102.30.

The expected value of the vending machine in state “S(5, 1, $100.00, 0:01)” may therefore be computed as:

$$“ S ( 5 , 1 , \$100 .00 , 0 \text{:} 01 ) ” \text{:}$$

$$\begin{matrix}expected value = \sum m ( probability of scenario m ) \times \\ ( actual value of state resulting from scenario m ) , \\ where “ m ” is taken over all possible scenarios . \\ = [ prob ( no transactions ) \times \\ actual value of S ( 5 , 1 , \$100 .00 , 0 \text{:} 00 ) ] + \\ [ prob ( 1 transaction with A sold for \$1 .00 ) \times \\ actual value of S ( 4 , 1 , \$101 .00 , 0 \text{:} 00 ) ] + \\ [ prob ( 1 transaction with B sold for \$0 .80 ) \times \\ actual value of S ( 5 , 0 , \$100 .80 , 0 \text{:} 00 ) ] \\ = [ prob ( no transactions ) \times \\ actual value of S ( 5 , 1 , \$100 .00 , 0 \text{:} 00 ) ] + \\ [ prob ( 1 transaction ) \times prob ( A sold for \$1 .00 ) \times \\ actual value of S ( 4 , 1 , \$101 .00 , 0 \text{:} 00 ) ] + \\ [ prob ( 1 transaction ) \times prob ( B sold for \$0 .80 ) \times \\ actual value of S ( 5 , 0 , \$100 .80 , 0 \text{:} 00 ) ] \\ = [ 0.8 \times \$101 .70 ] + [ 0.2 \times 0.4 \times \$102 .40 ] + \\ [ 0.2 \times 0.6 \times \$102 .30 ] \\ = \$101 .83 .\end{matrix}$$

Therefore, state “S(5, 1, $100.00, 0:01)” may correspond to the expected value of one hundred and one dollars and eighty-three cents ($101.83). As may be appreciated, expected values corresponding to a number of states with one (1) minute remaining until the next restock event may similarly be derived. For instance, “S(4, 2, $100.20, 0:01)” corresponds to an expected value of one hundred and one dollars and ninety-three cents ($101.93), since

$$“ S ( 4 , 2 , \$100 .20 , 0 \text{:} 00 ) ” \text{:}$$

$$actual value = \$100 .20 + 4 \times \$0 .30 + 2 \times \$0 .20 = \$101 .80 ;$$

$$“ S ( 3 , 2 , \$101 .20 , 0 \text{:} 00 ) ” \text{:}$$

$$actual value = \$101 .20 + 3 \times \$0 .30 + 2 \times \$0 .20 = \$102 .50 ; and$$

$$“ S ( 4 , 1 , \$101 .00 , 0 \text{:} 00 ) ” \text{:}$$

$$actual value = \$101 .00 + 4 \times \$0 .30 + 1 \times \$0 .20 = \$102 .40 ;$$

$$therefore , \\ \begin{matrix}Expected value = ( 0.8 \times \$101 .80 ) + ( 0.2 \times 0.4 \times \$102 .50 ) + \\ ( 0.2 \times 0.6 \times \$102 .40 ) \\ = \$101 .93 .\end{matrix}$$

Further, “S(5, 2, $99.20, 0:01)” corresponds to an expected value of one hundred and one dollars and twenty-three cents ($101.23), since

$$“ S ( 5 , 2 , \$99 .20 , 0 \text{:} 00 ) ” \text{:}$$

$$actual value = \$99 .20 + 5 \times \$0 .30 + 2 \times \$0 .20 = \$101 .10 ;$$

$$“ S ( 4 , 2 , \$100 .20 , 0 \text{:} 00 ) ” \text{:}$$

$$actual value = \$100 .20 + 4 \times \$0 .30 + 2 \times \$0 .20 = \$101 .80 ; and$$

$$“ S ( 5 , 1 , \$100 .00 , 0 \text{:} 00 ) ” \text{:}$$

$$actual value = \$100 .00 + 5 \times \$0 .30 + 1 \times \$0 .20 = \$101 .70 ;$$

$$therefore , \\ \begin{matrix}Expected value = ( 0.8 \times \$101 .10 ) + ( 0.2 \times 0.4 \times \$101 .80 ) + \\ ( 0.2 \times 0.6 \times \$101 .70 ) \\ = \$101 .23 .\end{matrix}$$

Now, suppose the state of the vending machine is “S(5, 2, $99.20, 0:02)”. Unlike the prior examples, this state now involves two (2) minutes until the end of the fill period. However, the expected value for “S(5, 2, $99.20, 0:02)” may be derived with reference to the expected values of states in which only one (1) minute remains until the end of the fill period. For instance, suppose as before, that in the next minute, the probability of no transactions occurring is eight tenths (0.8), the probability of exactly one transaction occurring is two tenths (0.2), and, if there is a transaction, the probability that Product A will be bought for one dollar ($1.00) is four tenths (0.4), and the probability that Product B will be bought is six tenths (0.6). In the case that no transaction occurs, after one (1) minute the state of the vending machine will be “S(5, 2, $99.20, 0:01)”, a state whose expected value has been derived above as one hundred and one dollars and twenty-three cents ($101.23). In the case that Product A is bought in the next minute, the state of the vending machine will be “S(4, 2, $100.20, 0:01)”, a state whose expected value was derived above as one hundred and one dollars and ninety-three cents ($101.93). In the case that Product B is bought in the next minute, the state of the vending machine will be “S(5, 1, $100.00, 0:01)”, a state whose expected value was derived above as one hundred and one dollars and eighty-three cents ($101.83). Now therefore,

$$“ S ( 5 , 2 , \$99 .20 , 0 \text{:} 02 ) ” \text{:}$$

$$\begin{matrix}Expected value = [ prob ( no transaction ) ⋆ expected value of S \\ ( 5 , 2 , \$99 .20 , 0 \text{:} 01 ) ] + \\ [ prob ( A bought for \$1 .00 ) ⋆ expected value of S \\ ( 4 , 2 , \$100 .20 , 0 \text{:} 01 ) ] + \\ [ prob ( B bought for \$0 .80 ) ⋆ \\ expected value of S ( 5 , 1 , \$100 .00 , 0 \text{:} 01 ) ] \\ = [ 0.8 \times \$101 .23 ] + [ 0.2 \times 0.4 \times \$101 .93 ] + \\ [ 0.2 \times 0.6 \times \$101 .83 ] \\ = \$101 .36 .\end{matrix}$$

Thus, expected values of states with one (1) minute remaining until the end of the fill period have been derived by reference to actual values of the contents of a vending machine at the end of the fill period. In turn, an expected value of a state with two (2) minutes remaining until route pickup has been derived by reference to the expected value of states with one (1) minute until the end of the fill period. In general, for “a”, “b”, and “y” greater than zero (>0), “S(a, b, $x, y min)”:
expected value=[prob(no transaction)*expected value of S(a, b, $x, y−1 min)]+[prob(A bought for $1.00)*expected value of S(a−1, b, $x+$1, y−1 min)]+[prob(B bought for $0.80)*expected value of S(a, b−1, $x+$0.80, y−1 min)].

It will be appreciated, that this procedure may be carried out by the control system recursively to generate expected values of states in which there are three (3) minutes remaining until the end of a fill period based on the expected values of states in which there are two (2) minutes remaining; to generate expected values for states in which there are four (4) minutes remaining based on states in which three (3) minutes are remaining, and so on. In this manner, in principle, an expected value for each possible state of the vending machine may be derived using a model of the number of transactions possible in a given minute, and the likelihood of various types of transactions occurring. Of course, the derivation may be extended to involve a vending machine with many more products, to incorporate states that indicate the number of seconds remaining until the end of the fill period (rather than just the number of minutes), and so on. The model may also or alternatively incorporate the possibility that a single transaction may take more than a minute, that a single transaction may involve more than one (1) product, and so on. The model may additionally incorporate time varying probabilities. For instance, the likelihood of a transaction occurring during any given minute may change based on whether it is daytime or nighttime.

A mystery promotion may thus be determined in accordance with the above-described embodiments (i.e., based on a state of the vending machine). For instance, if a customer inserts a one dollar ($1.00) bill and selects a Coke® to purchase, an alternate product mystery promotion may be output to the customer, suggesting that the customer instead purchase a mystery drink. As another example, a customer may purchase an item priced at seventy cents ($0.70) by inserting a one dollar ($1.00) bill. The customer may then be asked whether the customer would like to receive thirty cents ($0.30) change, or whether he would like to receive an additional bag of chips (e.g., of an undisclosed brand and/or specific type or flavor) instead of his change (i.e., a dynamically priced mystery upsell promotion, as defined herein).

In one example, the actual value of the vending machine at the end of a fill period may be equal to the total costs of the products remaining plus the amount of currency in the machine. Assuming again the simplified vending machine described above, the following actual values for three different states may be derived: “S(5, 1, $100.00, 0:00)”:
actual value $100.00+(5×$0.30)+(1×$0.20)=$101.70

“S(4, 1, $100.65, 0:00)”:
actual value=$100.65+(4×$0.30)+(1×$0.20)=$102.05

“S(5, 0, $100.60, 0:00)”:
actual value=$100.60+(5×$0.30)+(0×$0.20)=$102.10

“S(3, 1, $101.00, 0:00)”:
actual value=$101.00+(3×$0.30)+(1×$0.20)=$102.10

“S(4, 0, $101.00, 0:00)”:
actual value=$101.00+4×$0.30+0×$0.20=$102.20.

Assume, again, that the probability of no transaction occurring in a given minute is eight tenths (0.8), that the probability of a customer selecting Product A during a given transaction is four tenths (0.4), and that the probability of the customer selecting Product B during a given transaction is six tenths (0.6). Assume further that Product A has a posted price of sixty-five ($0.65) and Product B has a posted price of sixty ($0.60). Assume further still that, when a customer inserts a one dollar ($1.00) bill into a vending machine, and selects Product A or Product B to purchase, the vending machine may offer, based on rules stored in a rules database (such as a database configured in accordance with the exemplary data structures 1200, 1300 of FIG. 12 and/or FIG. 13), to provide an additional mystery product in return for what would otherwise be the customers change. In other words, a rule for selecting a mystery promotion from a list of constructed mystery promotions may specify that (i) a customer who selects Product A is to be provided with a dynamically priced mystery upsell promotion for either an additional unit of Product A or a unit Product B, and (ii) a customer who selects Product B is to be provided with an alternate product mystery promotion for a unit of Product A. Thus, a customer might insert one dollar ($1.00) and, by accepting a dynamically priced mystery upsell promotion, receive (i) a first unit of Product A for sixty-five cents ($0.65) and a mystery additional unit of Product A for thirty-five cents ($0.35), (ii) a first unit of Product A for sixty-five cents ($0.65) and a mystery unit of Product B for thirty-five cents ($0.35), (iii) a unit of Product B for sixty cents ($0.60) and a mystery additional unit of Product B for forty cents ($0.40), and/or (iv) a unit of Product B for sixty cents ($0.60) and a mystery unit of Product A for forty cents ($0.40).

Returning to FIG. 15, the method 1500 will now be described with reference to an example. The method 1500 may begin, according to some embodiments, with step 1502, in which a current state of a vending machine is determined, as described above. Assume, for the example illustrating method 1500, that the current state of a vending machine is determined to be “S(5, 1, $100.00, 0:01)”.

At step 1504, possible courses of action are determined. For example, step 1504 may comprise determining whether a mystery promotion is to be output. Step 1504 may further comprise determining the type of mystery promotion or promotions that may be output and a construction of at least one mystery promotion instance. Alternatively, step 1504 may further comprise selecting a pre-constructed mystery promotion instance from a list of stored mystery promotion instances. Eligible mystery promotion types and/or construction of mystery promotions may be conducted in manners similar to those described with respect to the method 1400 of FIG. 14.

For example, assume a customer inserts a one dollar ($1.00) bill and selects Product A to purchase for sixty-five cents ($0.65). One possible course of action may be to not output any mystery promotion. In that case, Product A and thirty-five cents ($0.35) change may be provided to the customer. Assume further that two other courses of action identified are to either provide the customer with a dynamically priced mystery upsell promotion for an additional mystery unit of Product A or to provide the customer with a dynamically priced mystery upsell promotion for a mystery unit of Product B.

In step 1506 an expected value is determined for each course of action determined in step 1504. In the example, each of these possibilities has an associated expected value for the contents of the vending machine at the end of the fill period, and the task of the vending machine will be to determine which of the possibilities to choose in order to yield the maximum expected value.

If the first possibility is chosen (no promotion), then the vending machine will reach state “S(4, 1, $100.65, 0:00)”. This state has an actual value of one hundred and two dollars and five cents ($102.05).

If the second possibility is chosen (dynamically priced mystery upsell promotion for a mystery additional unit of Product A), then an additional probability must be incorporated. Let prob(accept A)” be the probability that the customer will accept the mystery promotion (that will ultimately result in the customer receiving an additional unit of Product A) for his change of thirty-five cents ($0.35). If the customer accepts the mystery promotion, the vending machine will reach state “S(3, 1, $101.00, 0:00)”, with an actual value of one hundred and two dollars and ten cents ($102.10). If the customer declines the mystery promotion, where the probability of his declining is “1-prob(accept A)”, then the vending machine will again reach state “S(4, 1, $100.65, 0:00)”, with an actual value of one hundred and two dollars and five cents ($102.05).

If the third possibility is chosen (dynamically priced mystery upsell promotion for a mystery unit of Product B), then another probability, “prob(accept B)” may be incorporated to indicate the probability that the customer will accept the mystery promotion (that will ultimately result in the customer receiving a mystery unit of Product B). If the customer accepts the mystery promotion, the vending machine will reach state “S(4, 0, $101.00, 0:00)” with an actual value of one hundred and two dollars and twenty cents ($102.20). If the customer declines the mystery promotion, where the probability of his declining is “1-prob(accept B)”, then the vending machine will again reach state “S(4, 1, $100.65, 0:00)”, with an actual value of one hundred and two dollars and five cents ($102.05).

It should be noted that “prob(accept A)” and “prob(accept B)” may be determined from models of human behavior based on, e.g., the historical responses of customers to the vending machine's mystery promotions (i.e., “take rates”, as defined herein). For the present example, assume that “prob(accept A)”=seven tenths (0.7) and “prob(accept B)”=five tenths (0.5). The expected value for the contents of the vending machine at the end of the fill period for each of the three possibilities may therefore be determined as follows:

$$\begin{matrix}\begin{matrix}1 ) expected value = actual value S ( 4 , 1 , \$100 .65 , 0 \text{:} 00 ) \\ = \$102 .05 .\end{matrix} & \\ 2 ) \begin{matrix}expected value = prob ( accept A ) \times actual value S \\ ( 3 , 1 , \$101 .00 , 0 \text{:} 00 ) + \\ ( 1 - prob ( accept A ) ) \times actual value S \\ ( 4 , 1 , \$100 .65 , 0 \text{:} 00 ) \\ = 0.7 \times \$102 .10 + ( 1 - 0.7 ) \times \$102 .05 \\ = \$102 .09 .\end{matrix} & \\ 3 ) \begin{matrix}expected value = prob ( accept B ) \times actual value S \\ ( 4 , 0 , \$101 .00 , 0 \text{:} 00 ) + \\ ( 1 - prob ( accept B ) ) \times actual value S \\ ( 4 , 1 , \$100 .65 , 0 \text{:} 00 ) \\ = 0.5 \times \$102 .20 + ( 1 - 0.5 \times \$102 .05 ) \\ = \$102 .13 .\end{matrix} & \end{matrix}$$

In step 1508, the possible course of action with the highest expected value is selected. Therefore, in the present example, if the simplified vending machine is in state “S(5, 1, $100.00, 0:01)”, and a customer inserts a dollar bill and chooses to purchase Product A, the third possible course of action (i.e., the dynamically priced mystery upsell promotion that results in dispensing of a mystery unit of product B) should be selected. That is, the customer should be offered a mystery product (which the machine picks to be a unit of Product B) in lieu of his change, since such a mystery promotion instance results in the highest expected value for the vending machine of the three possible courses of action. Since, with optimum choice, the vending machine can realize an expected value of one hundred and two dollars and thirteen cents ($102.13) for state “S(5, 1, $100.00, 0:01)”, the state may be assigned the expected value of one hundred and two dollars and thirteen cents ($102.13). Therefore, in embodiments where there is a choice of several mystery promotions, an expected value may be assigned to states based on the assumption that an optimum choice of mystery promotion instances in every subsequent state.

In step 1510, the course of action selected in step 1508 is executed. This may comprise, for example, outputting the selected mystery promotion (if the selected course of action includes outputting a mystery promotion) and processing the transaction based on the customer's response to the mystery promotion. If the selected course of action comprises not outputting any mystery promotion, step 1510 may comprise processing the transaction in a conventional manner.

In summary, it should be appreciated that many possible courses of action may be identified in step 1510. In general, a determination may be made for each possible course of action as to the states that might result, and as to the likelihood of reaching each of those states based on, e.g., the likelihood of a customer accepting a mystery promotion (“take rates”). An expected value may then be assigned to each possible course of action based on the expected values of each state in which the possible course of action may result, and based on the probability of reaching each such state given the possible course of action. The course of action (e.g., mystery promotion instance) with the highest associated expected value may then be selected. It will be appreciated that, using a recursive procedure, an expected value for every conceivable state may be derived. Then, during any given transaction, all possible courses of action may be enumerated, the expected value determined for each, and the course of action with the highest expected value may be chosen.

To illustrate using the following formula (Formula 3), the expected value of a state “S(a, b, $x, y min)” may be determined as follows:

“S(a, b, $x, y min)”:
expected value=[prob(no tansaction)×expected value of S(a, b, $x, y−1 min)]+[Σⱼ prob(transaction j initiated)×(expected value of output with the maximum expected value given transaction j initiated)]. (3)

where the index “j” is taken over all possible transactions that may be initiated and where the expected values of possible courses of action (e.g., offer instances) are determined based on the expected values of the states that would result from such courses of action, and based on probabilities with which a customer would respond in various ways to such courses of action (e.g., acceptance or “take” rates).

In other words:
expected value of output given transaction j initiated Σₚ prob(response p)]×(expected value of state that would result from response p)

where the index “p” is taken over all possible responses given transaction j has been initiated.

In an alternate embodiment, the profitability of alternate product mystery promotion instances may be calculated by considering not only the profit margin of the product to be included in the mystery promotion instance multiplied by the take rate, but also by considering the historic profit margin of the possible alternate product(s) given the difference between the actual product velocity and the ideal product velocity. In such an embodiment, a database accessible to the control system may provide for different historic profit margins of various products that correlate with different levels of demand for the products. For example, the variation in historic profit margins may reflect the degree to which a given product will be sold for less than its suggested retail price if the product is selling at less than its ideal product velocity. A tabular representation of an exemplary database is depicted in Table 12, as follows:

TABLE 12
Example Historic Profit Margin Database

| | Product A | Product B | Product C |
|---|---|---|---|
| | (cost = $0.65; | (cost = $0.50; | (cost = $0.50; |
| | suggested retail | suggested retail | suggested retail |
| Velocity State | price = $.75) | price = $.80) | price = $.80) |
| If actual product | Then historic profit | Then historic | Then historic |
| velocity < ideal | margin = $0.05 | profit | profit |
| product velocity | | margin = $0.25 | margin = $0.10 |
| If actual product | Then historic profit | Then historic | Then historic |
| velocity = ideal | margin = $0.07 | profit | profit |
| product velocity | | margin = $0.30 | margin = $0.25 |
| If actual product | Then historic profit | Then historic | Then historic |
| velocity > ideal | margin = $0.10 | profit | profit |
| product velocity | | margin = $0.35 | margin = $0.30 |

Referring now to FIG. 16, a flow diagram of a method 1600, according to some embodiments is shown. The method 1600 may be performed, for example, by a control system of one or more devices (e.g., a vending machine 110, 210, 310, a peripheral device 250, a controller 202, a peripheral device controller 260, and/or any combination thereof). The method 1600 will be described with continued reference to the previously described example, for purposes of illustrating an exemplary usage of the method 1600.

The method 1600 may begin at step 1602, for example, in which a product selected by a customer for purchase at a vending machine is determined. Assume, for purposes of the example, that it is determined that Product A has been selected for purchase.

In step 1604, an alternate product promotion type is identified as an eligible promotion type. This may be done, for example, using a rules database such as that represented by the exemplary data structures 1200, 1300 described with reference to any of FIG. 12 and/or FIG. 13.

In step 1606, products eligible to be included in the alternate product mystery promotion type are identified. In other words, the alternate product mystery promotion type includes a product parameter and the values for the parameter are determined. Such a determination may be made, for example, by accessing a rule for constructing an alternate product mystery promotion type. Continuing with the example, assuming that a customer selected Product A, the control system may determine that Product B and Product C are potentially eligible to be included in an alternate product mystery promotion type (e.g., because they are products within the same category, such as “soda”).

In step 1608, the control system may determine the historic profit margin for each of the product selected for purchase by the customer and the products selected in step 1606. Continuing with the example, the historic profit margin may be determined for both Product B and Product C, as well as for Product A. Assuming that Product B is selling at its ideal product velocity, the historic profit margin would be thirty cents ($0.30). Assuming that Product C is selling at less than its ideal product velocity, the historic profit margin would be ten cents ($0.10). Assuming that Product A—the initially requested product—is selling at higher than its ideal product velocity, the historic profit margin would be ten cents ($0.10).

In step 1610, the monetary amount deposited by the customer into the vending machine as payment for the initially selected product is determined. Continuing with the example, assuming that the underlying transaction that triggered the alternate product mystery promotion required a deposit of seventy-five cents ($0.75) and that the customer deposited the exact amount required (i.e., seventy-five cents ($0.75)).

In step 1612, the actual profit margin that is expected is determined for each of the products selected for purchase by the customer and the products selected in step 1606. Continuing with the example, the control system may determine the actual profit margin that would result if the customer were offered a different product for the amount deposited. Thus, for Product B, which has a cost of fifty cents ($0.50), the actual profit margin would be twenty-five cents ($0.25) (the seventy-five cents ($0.75) deposited−the fifty cent ($0.50) cost=twenty-five cents ($0.25)). For Product C, which also has a cost of fifty cents ($0.50), the actual profit margin would again be twenty-five cents ($0.25) (the seventy-five cents ($0.75) deposited−the fifty cent ($0.50) cost=twenty-five cents ($0.25)). Note that, in this event, Products B and C would be selling for seventy-five cents ($0.75) each, a discount from the products' suggested retail prices (eighty cents per unit ($0.80/unit) for each of Products B and C), thereby presenting an opportunity for the customer to purchase the products at a discount. The control system may also determine the actual profit margin for the initially requested product. Thus, for Product A—the product initially selected by the customer—the actual profit margin would be ten cents ($0.10) (the seventy-five cents ($0.75) deposited−the sixty-five cent ($0.65) cost=ten cents ($0.10)).

In step 1614, the difference between the actual profit margin and the historic profit margin is determined for each of the products initially selected by the customer and the products selected in step 1606. The differences would reflect the value of the present opportunities available for a given unit of each possible alternate product, without regard to take rates. Thus, continuing with the example, for Product B, the difference would be negative five cents (−$0.05) (twenty-five cents ($0.25)−thirty cents ($0.30)=negative five cents (−$0.05)). For Product C, the difference would be fifteen cents ($0.15) (twenty-five cents ($0.25)−ten cents ($0.10)=fifteen cents ($0.15)).

In step 1616, the take rates associated with each of the products selected in step 1606 (i.e., the take rates associated with alternate product mystery promotions specifying the selected products) are determined. This may comprise retrieving the take rates from a database.

In step 1618, the expected value for each eligible alternate product mystery promotion instance is determined. The expected value of processing the transaction as initially requested (i.e., dispense the initially requested product and offer no promotion) is also determined. These determined expected values are then compared to one another.

Continuing with the example, assuming that the take rate for alternate product mystery promotions offering Product B (or a type of product associated with Product B, or simply the specific type of mystery promotion) when Product A is initially requested is fifty percent (50%), the expected value of the mystery promotion instance in which Product B is offered in lieu of Product A is two and one half cents ($0.025), calculated as follows:
(negative five cent (−$0.05) difference between actual and historic profit margin for Product B*fifty percent (50%) take rate)+(ten cent ($0.10) actual profit margin for Product A*fifty percent (50%) chance that customer will reject the alternate mystery product offer and thereby purchase Product A).

Assuming that the take rate for alternate product mystery promotions offering Product C (or a product type associated with Product C) when Product A is initially requested is eighty percent (80%), the expected value of the mystery promotion instance in which Product C is offered in lieu of Product A is fourteen cents ($0.14), calculated as follows:
(the fifteen cent ($0.15) difference between actual and historic profit margin for Product C*eighty percent (80%) take rate)+(ten cent ($0.10) actual profit margin for Product A*twenty percent (20%) chance that customer will reject the alternate product mystery promotion and thereby purchase Product A).

The probability of selling Product A, assuming that no alternate mystery product is offered, is one hundred percent (100%) because the customer has already indicated his willingness and ability to purchase the product. Thus, the expected value for proceeding with the transaction as initially requested is ten cents ($0.10), calculated as follows:
The ten cent ($0.10) actual profit margin for Product A*one hundred percent (100%) take rate.

In step 1620, the most profitable course of action is selected and executed. In other words, the course of action associated with the highest expected value is selected and executed. Continuing with the example, the most profitable course of action is to output an alternate product mystery promotion for Product C (and/or for a mystery promotion for a product of a type associated with Product C).

Thus, the vending machine may realize a greater gain on the transaction than otherwise would have happened had the transaction simply been processed as the customer initially requested. Further, the vending machine may realize a greater gain on a distressed product (i.e., Product C) than reasonably could have been expected given the relatively low historic profit margin that corresponds with a relatively low level of demand. Additionally, the customer benefits from the ability to purchase an alternate mystery product at a discount (here, Product C at a five cent ($0.05) discount). Also, the vending machine benefits from the ability to offer such distressed inventory at a discount without suffering from the effects of dilution. That is, because the customer has indicated an initial willingness to purchase Product A, it can reasonably be assumed that the customer was not willing to purchase Product C for eighty cents ($0.80), its suggested retail price. Thus, Product C may be sold to the customer for seventy-five cents ($0.75) without sacrificing five cents ($0.05) that may have otherwise been gained if the customer was indeed willing to purchase Product C for eighty cents ($0.80).

Executing the selected course of action may comprise processing the transaction in a conventional manner if the selected course of action is to offer no mystery promotion (and/or no promotion at all). Alternatively, executing the selected course of action may comprise outputting a mystery promotion instance and determining a customers response to the mystery promotion instance, if the selected course of action is a mystery promotion.

As described above, in one or more embodiments, a device (e.g., a vending machine 110, 210, 310, a peripheral device 250, a controller 202, a peripheral device controller 260, and/or any combination thereof) may determine a mystery promotion instance by selecting a pre-constructed mystery promotion from a list of available mystery promotions.

In FIG. 17, a flow diagram of a method 1700 according to some embodiments is shown. The method 1700 may begin, for example, at step 1702, in which it is determined whether any condition(s) for outputting a mystery promotion have been satisfied. For example, referring to the exemplary data structure 1100 of FIG. 11 (an embodiment of an available promotions data 140), a control system may determine whether the condition(s) for output 1106 of any record of the table are satisfied by current data. Step 1702 may be performed substantially continuously, periodically, in response to a predetermined event, or otherwise as appropriate.

If it is determined, in step 1702, that condition(s) for outputting a mystery promotion have been satisfied, the mystery promotion corresponding to the satisfied condition(s) is output as a mystery promotion instance in step 1704. For example, referring again to the exemplary data structure 1100, if it is determined that the actual product velocity of Soda X is less than a minimum threshold (which may be stored in the exemplary data structure 1100 or elsewhere in a memory accessible by the control system) and that the number of units of Snack W in inventory is greater than ten (10), the promotion “P-10-321” may be output. A mystery promotion instance may be output via any of the methods described herein.

It should be noted that, in the embodiment of FIG. 17 and in other embodiments described herein, a mystery promotion may be associated with a mystery promotion identifier that uniquely identifies the mystery promotion. Such an identifier may be used, for example, to retrieve data associated with the mystery promotion. The data may be stored in various memories or storage devices of one or more devices. For example, an image file (e.g., that stores graphics to be displayed when the mystery promotion is output) and/or audio file (e.g., that stores one or more sounds to be output when the mystery promotion is output) associated with the mystery promotion may be retrieved based on the mystery promotion identifier. The retrieved image file and/or audio file may be utilized in outputting the mystery promotion.

In one or more embodiments, a control system may customize a pre-constructed mystery promotion by inserting data relevant to a transaction associated with the output of the mystery promotion instance. For example, referring again to the exemplary data structure 1100, assume it is determined that the condition(s) for output of mystery promotion “P-30-528” have been satisfied. In outputting the mystery promotion “P-30-528”, the actual and specific amount of change due to the customer of the transaction associated with the output of the mystery promotion may be inserted into the text of the output mystery promotion instance. For example, assuming a customer inserted one dollar ($1.00) into a vending machine and selected a sixty-five cent ($0.65) product for purchase, the output of the mystery promotion instance to the customer may read “Get a Mystery Snack for your $0.35 in change!”.

In conclusion, while the methods and apparatus of some embodiments have been described in particular terms, those skilled in the art will recognize, after reading the present disclosure, that embodiments may be practiced with modification and alteration without departing from the teachings disclosed herein.

### IX. ADDITIONAL EXAMPLES AND EMBODIMENTS

Some additional embodiments and concepts, most of which have been introduced previously herein, will be described in more detail with reference to the following example processes.

### A. Proactive Inventory Grouping Embodiments

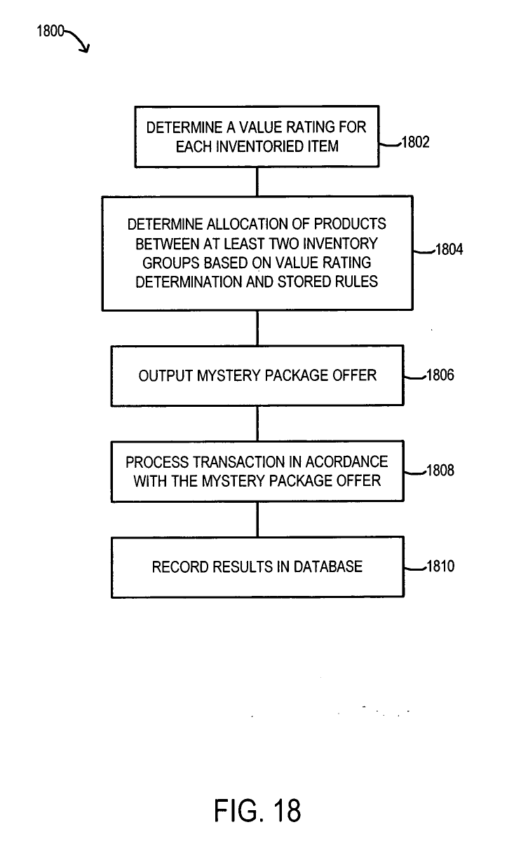

Referring to FIG. 18, a flow diagram of a method 1800 according to some embodiments is shown. The method 1800 may, for example, illustrate one proactive inventory grouping embodiment. According to some embodiments, the method 1800 may function to, among other things, allocate products available for sale to inventory groups based on (i) the relative value ratings of the products, and (ii) stored rules for determining, among other things, whether products should be included in mystery package offers.

In some embodiments, the method 1800 may begin at 1802 to determine value ratings for each inventoried item (e.g., each product available for sale via a vending machine 110, 210, 310). The vending machine may determine a value rating of products by, for example, accessing an inventory database (such as the exemplary data structure 600 of FIG. 6A and/or FIG. 6B, and/or a database storing product inventory data 130) to determine, among other things, products in inventory and characteristics thereof. The value ratings of products may be used, for example, to determine the products which various inventory groups include. For example, each product that a first inventory group includes may have a rating that is not less than a rating of any product that the second inventory group includes. As another example, a first inventory group may include a certain portion of the highest rated products (e.g., the products with the five highest value ratings; the highest fifty percent (50%), by value rating, of all products).

Table 13, immediately below, illustrates an exemplary inventory database:

TABLE 13
Exemplary Inventory Database

| | | | | | | | Actual | Ideal |
|---|---|---|---|---|---|---|---|---|
| | | | Retail | | | Quantity | Sales | Sales |
| Product Name | Row | Type | Price | Cost | Margin | Begin/Now | Rate | Rate |
| Coca-Cola ® | A1 | Drink | $.75 | $.35 | $.40 | 20/8 | 1.2 | 1.3 |
| Diet Coke ® | A2 | Drink | $.75 | $.30 | $.45 | 20/6 | 1.4 | 1.3 |
| A&W Root | A3 | Drink | $.65 | $.35 | $.30 | 20/9 | 1.1 | 1.3 |
| Beer ® | | | | | | | | |
| Doritos ® | B1 | Snack | $.50 | $.30 | $.20 | 25/11 | 1.4 | 1.6 |
| Lay's ® Potato | B2 | Snack | $.75 | $.30 | $.45 | 25/7 | 1.8 | 1.6 |
| Chips | | | | | | | | |
| Cheetos ® | B3 | Snack | $.60 | $.30 | $.30 | 25/17 | 0.8 | 1.6 |
| Double-Mint ® | C1 | Gum | $.35 | $.20 | $.15 | 40/18 | 2.2 | 2.6 |
| Juicy Fruit ® | C2 | Gum | $.35 | $.20 | $.15 | 40/23 | 1.7 | 2.6 |
| Dentyne ® | C3 | Gum | $.40 | $.20 | $.20 | 40/36 | 1.1 | 2.6 |

As the above inventory database illustrates (Table 13), for each product, a corresponding product location, product type or category, retail price, cost, margin, quantity at the beginning of the fill period, quantity remaining as of the current date/time, actual sales rate, and ideal sales rate is shown. The data stored by such a database may be entered by an operator (e.g., who restocks the vending machine), determined by the vending machine with its peripheral devices (e.g., data indicating that a product has been sold, that an amount of money has been received), set randomly, and/or calculated from available data (e.g., other data stored by the inventory database or another database).

The exemplary data in the above inventory database (Table 13) assumes that the beginning of the fill period was Jun. 15, 2003 (6/15/03), and that the current date is Jun. 25, 2003 (06/25/03) (i.e., 10 days into the fill period). Further, the exemplary data in the above inventory database will be referred to throughout the remaining discussion of this exemplary method 1800 to illustrate steps of the example proactive inventory grouping embodiment in which the value rating of individual products are considered. For the purpose of this ongoing example, it shall be assumed that a mystery package offer to a customer will include two products which may be purchased together for one dollar ($1.00), in which one product is included in a first (“green”) inventory group, and one product is included in a second (“red”) inventory group. The “green” and “red” inventory gruopo identifiers are used in this example to represent the case where two inventory groups are shown to the customer (e.g., via green and red LED and/or other devices, respectively). It should be understood that fewer or more inventory groups may be utilized and/or that the population of products defining an inventory group may be kept secret from the customer (e.g., as a more complete “mystery” experience).

As mentioned, at step 1802, a value rating is determined for each inventoried product. There are many ways that value ratings could be represented and many ways that value ratings could be determined.

A value rating may be represented as a numerical quantity, a set of numerical quantities (e.g., a vector and/or a matrix), or any other quantity that may be used for purposes of comparison and/or evaluation. A value rating may also be qualitative, such as “high”, “medium”, or “low”. In one or more embodiments, the value rating of one or more products may be determined by considering one or more of (i) the time remaining until a restock date, (ii) the time remaining until an expiration date of a product or products, (iii) an actual sales rate of a product or products, (iv) a target or ideal sales rate of a product or products, (v) the cost of a product or products, (vi) the retail price of an individual unit of a product or products, (vii) the retail profit margin of a product or products when sold for the retail price, (viii) the historical acceptance rate of a mystery package instance (e.g., comprising a given combination of products), and/or (ix) one or more products' income or profit contribution factor(s).

Thus, a value rating may be determined using a formula in which any of the above criteria (i) through (ix) may serve as variables. For example, in one embodiment, a value rating is determined by identifying a product's retail profit margin (as determined by subtracting the product's cost from the product's retail price). For example, following the exemplary data in the above inventory database (Table 13), the vending machine control system would determine that a Diet Coke® soda has a margin of forty-five cents ($0.45). The value rating of each product margin may be that product's margin, some proportion of the margin, or some other variation of the margin.

In another embodiment, value ratings may be determined by multiplying a product's margin by its actual sales rate expressed as a percentage of the product's ideal sales rate. By using a product's actual sales rate as a basis for predicting future sales, the vending machine control system can determine the likelihood (e.g., as a percentage) that the particular product will sell at the products ideal sales rate. In turn, by multiplying this percentage by the product's margin, a value rating can be determined. Note, however, at the beginning of a fill period, a vending machine may determine a product's sales rate to be zero, as no sales data for that period has yet been collected, or may determine the product's sales rate based on data obtained from a prior fill period. The table immediately below (Table 14) illustrates such an embodiment in the context of the ongoing example. In the illustrated embodiment, the value rating of each product (as described above in the inventory database of Table 13) is calculated by multiplying each product's margin by a percentage that reflects the product's actual sales rate divided by the product's ideal sales rate:

TABLE 14
Exemplary Value Rating Calculations

| | | Actual | | Percent | |
|---|---|---|---|---|---|
| | | Sales | Ideal Sales | of Ideal | Value |
| Product Name | Margin | Rate | Rate | Rate | Rating |
| Coca-Cola ® | $.40 | 1.2 | 1.3 | 92% | $.37 |
| Diet Coke ® | $.45 | 1.4 | 1.3 | 107% | $.48 |
| A&W Root Beer ® | $.30 | 1.1 | 1.3 | 85% | $.26 |
| Doritos ® | $.20 | 1.4 | 1.6 | 88% | $.18 |
| Lay's ® Potato Chips | $.45 | 1.8 | 1.6 | 113% | $.51 |
| Cheetos ® | $.30 | 0.8 | 1.6 | 50% | $.15 |
| Double-Mint ® | $.15 | 2.2 | 2.6 | 85% | $.13 |
| Juicy Fruit ® | $.15 | 1.7 | 2.6 | 65% | $.10 |
| Dentyne ® | $.20 | 1.1 | 2.6 | 42% | $.08 |

In various embodiments, products can be scored, sorted and/or ranked based on their relative value ratings, and such data can be stored in RAM pending further steps, at which point the scoring, sorting and/or ranking may be considered in the allocation of products to inventory groups. Thus, following the ongoing example (in which the value rating of each product in the above inventory database was calculated by multiplying each product's margin by its actual sales rate as a percentage of its ideal sales rate), inventoried products can be sorted (and/or ranked) in descending order based on their relative value ratings, as illustrated by Table 15 immediately below:

TABLE 15
Exemplary Value Rating Sorting

| | | Actual | | Percent | |
|---|---|---|---|---|---|
| | | Sales | Ideal Sales | of Ideal | Value |
| Product Name | Margin | Rate | Rate | Rate | Rating |
| Lay's ® Potato Chips | $.45 | 1.8 | 1.6 | 113% | $.51 |
| Diet Coke ® | $.45 | 1.4 | 1.3 | 107% | $.48 |
| Coca-Cola ® | $.40 | 1.2 | 1.3 | 92% | $.37 |
| A&W Root Beer ® | $.30 | 1.1 | 1.3 | 85% | $.26 |
| Doritos ® | $.20 | 1.4 | 1.6 | 88% | $.18 |
| Cheetos ® | $.30 | 0.8 | 1.6 | 50% | $.15 |
| Double-Mint ® | $.15 | 2.2 | 2.6 | 85% | $.13 |
| Juicy Fruit ® | $.15 | 1.7 | 2.6 | 65% | $.10 |
| Dentyne ® | $.20 | 1.1 | 2.6 | 42% | $.08 |

In embodiments where value ratings of products are determined based on profit contribution factors, such products might be ranked and/or sorted according to their relative profit contribution percentages. For example, if a vending machine which sold only Product A, Product B, and Product C during a fill period realized a total of one hundred dollars ($100) in profit, forty-five dollars ($45) of which was generated through the sale of Product A, forty dollars ($40) through Product B, and fifteen dollars ($15) through Product C, then the products would be sorted in the order of Product A (forty-five percent (45%) of the total profit), Product B (forty percent (40%) of the total profit), and Product C (fifteen percent (15%) of the total profit). Further, in some embodiments, only those products that remain in inventory (i.e., are available for sale) at the time when step 1802 is executed are considered in the ranking or sorting, and thus, in the subsequent allocation procedure of step 1804, which defines one or more inventory groups.

The method 1800 may continue, for example, at step 1804 to determine allocation of products to inventory groups based on value rating determination and stored rules. The value rating associated with each product may be used in assigning products to inventory groups. In one embodiment, an inventory group may define a given number of component product “slots”, or a designated number of products that may be allocated to that inventory group. In other words, an inventory group may be defined in part according to how many products the inventory group should include.

For example, a vending machine may be configured to have two inventory groups, such as “green” group and “red” group, in which the red group has three (3) component product slots and the green group has six (6) component product slots. Thus a customer might be offered one mystery product from the three (3) red slots (i.e., one (1) product from the three (3) possible products) and one (1) component from the six (6) green slots (i.e., one (1) product from the six (6) possible products). The slots of a group may be “filled” according to value ratings of products. For example, the three (3) products having the highest profit contribution factors may be allocated to the “green” inventory group, and the six (6) with the lowest profit contribution factors may be allocated to the “red” inventory group. As described above, two or more groups may include the same product, and no group may include certain products. Thus, where a green group includes three (3) products and a red group includes six (6) products, there may be nine (9) products available for sale, or more or less than nine (9) products.

In another embodiment, a predetermined percentage of the products (or of only the products which are available for sale) may be allocated to each group so that, for example, fifty percent (50%) of the products will be allocated to the “red” group and the remaining fifty percent (50%) of products will be allocated to the “green” group. In particular, it can be advantageous to allocate similar products to a group. For example, the top fifty percent (50%) (e.g., by value rating) of products are allocated to one group, and the remaining products are allocated to another group. In another embodiment, all products having a value rating over a certain threshold (e.g., over twenty-five cents ($0.25)) may be placed in a particular inventory group (e.g., in the “red” inventory group).

In some embodiments, each inventory group may be associated with a rule (e.g., a stored value rating-based allocation rule) defining the products that are allocated to the inventory group. For example, in an embodiment where three (3) component product slots are “red” and six (6) component product slots are “green”, a profitability-based allocation rule may provide that (i) the three (3) inventoried products having the highest value ratings are to be allocated to the “red” inventory group, and (ii) the six (6) inventoried products having the lowest value ratings are to be allocated to the “green” inventory group. Thus, continuing with the ongoing example, Lay's® Potato Chips, Diet Coke® and Coca-Cola® would be allocated to the red inventory group; and A&W Root Beer®, Doritos®, Cheetos®, Double-Mint®, Juicy Fruit® and Dentyne® would be allocated to the green inventory group. Accordingly, a mystery package offer may provide that a customer may purchase a mystery package comprising one mystery product from the red group and one mystery product from the green group for one dollar ($1.00). Note, that as mentioned elsewhere herein, either or both of the green and red inventory groups (or other inventory groups) may either be made known or kept secret from the customer, as is desirable and/or practicable.

In an alternate embodiment, rather than having a fixed number of inventory slots or a percentage-based division of products among inventory groups, the number of slots in each inventory group may be determined randomly and/or pursuant to a genetic algorithm, whereby a given slot configuration is tested randomly and evaluated against other configurations. In some embodiments, as described elsewhere herein, certain products may be prevented from allocation to certain inventory groups to substantial avoid providing identical and/or similar mystery products, particular to a repeat mystery customer. In such a manner, for example, the unpredictable nature of the mystery package composition may be preserved and the customer may be more likely to purchase mystery promotions and/or mystery package promotions on a repeat basis.

Further, a set of package offer rules may also be employed in determining how to allocate products to different inventory groups. An exemplary package offer rules database is represented in Table 16, immediately below:

TABLE 16
Exemplary Package Rules Database

| Package | |
|---|---|
| Offer Rule | |
| Number | Rule |
| 1 | Products from “drink” category |
| | cannot be in same inventory grouping as |
| | products from “gum” category. |
| 2 | Total margin of mystery package |
| | instance based on one dollar ($1.00) |
| | mystery package price cannot be equal |
| | to or less than fifty percent (50%) |
| | of the sum of the individual |
| | component products' margins. |
| 3 | Do not allocate to inventory groups those |
| | products selling at greater than |
| | one hundred and ten percent |
| | (>110%) of ideal sales rate. |
| 4 | Do not allocate products sold as |
| | mystery products to Customer A in the |
| | past month to either inventory group. |
| 5 | Cheetos ® must be both in red |
| | and green inventory groups. |

Although rules may be represented as being stored in a database for reference, such rules may be implemented in an wide variety of manners, such as (i) “hard coded” into software, firmware, and/or hardware, and/or (ii) coded in software and/or hardware with reference to parameters which are stored in a database or other memory structure.

Such a database (as shown in Table 16) may, according to some embodiments, provide one or more rules that govern the allocation of products to inventory groups, whether or not with reference to the value ratings of the products. The exemplary data in the above database of Table 16 depicts several rules. For example, as demonstrated by package offer rule number one (1), a package offer rule may provide that products from certain categories may or may not be packaged with products from other categories. Such a rule may be desirable to ensure that only certain combinations of products are offered and/or so that certain combinations of products are not offered. For example, it may be decided (e.g., by an operator) that certain products complement each other, as may a drink and a snack. Conversely, it may be decided (e.g., by an operator) that certain products should not be included in a mystery package offer (e.g., as in package offer rule number one (1), “drinks” cannot be included in mystery package offers with “gum”). Products that are affected by such rules (e.g., whether a product is a “drink”) can be determined by appropriate notation or data stored in an inventory database. For example, all products that are “drinks” can be indicated as such by a flag in the corresponding record of the product. Alternatively, the rule that refers to drinks can in fact directly refer to a specific plurality of products (e.g., each identified by a respective product code).

Further, as demonstrated by package offer rule number two (2), a package offer rule may provide that the total margin of a mystery package instance, based on a given mystery package price, cannot be equal to or less than a certain percent of the sum of the individual component product's margins (based on their respective individual retail prices).

Similarly, a package offer rule may provide that the total margin of a mystery package instance, based on a given mystery package price, cannot be less than the margin that would result from a sale of the individual products at their retail prices, unless a threshold volume of sales (e.g., as measured by units sold, or units sold per time period) for one or more of the component products is likely to be achieved. Such a rule may be desirable to ensure that any discounts offered by way of mystery package offers are sufficiently offset by an increase in sales volume. For example, by requiring that a certain mystery package instance have a certain historic acceptance rate, operators can rest assured that a discount offered for the products by virtue of a mystery package price that is less than the sum of the component products' individual retail prices will not likely result in a decrease in profits.

Further still, a package offer rule may provide that products selling above or below a given actual sales rate may or may not be included in certain inventory groups (or in any inventory group). For example, package offer rule number three (3) illustrates a rule that provides that a product having an actual sales rate above a certain threshold is not to be included in inventory groups (e.g., to any inventory group which might be used in a mystery package offer). Such a rule can be useful in preventing price dilution that may otherwise result when very popular products are sold on promotion through mystery package offers. As is known, price dilution generally involves the negative effect on profitability that can ensue when a product is sold for a price lower than a customer otherwise would have paid for the product.

Some embodiments can reduce or eliminate the effects of dilution that may otherwise result when mystery package prices are less than the sum of the individual component products' retail prices. In other words, because very popular products are highly likely to sell at their current retail prices, it may be decided (e.g., by an operator) that very popular products should not ever be sold at a discount, even for purposes of promoting the sale of additional (relatively less popular) products through mystery package offers. Alternatively, it may be desirable to package together only products having actual sales rates above a certain threshold with products having actual sales rates below a certain threshold. In this manner, an operator may attempt to leverage the popularity of a given product to sell additional, relatively less popular products.

Further still, an inventory group may be defined to include a particular set of products based on a what product the customers first selects (e.g., if Product A1 is selected, then the second inventory group is defined to include Products B1, B2 and B3).

In some embodiments, as described elsewhere herein, a package offer rule may be configured to maintain the “mystery” of a mystery promotion (such as a mystery package promotion). For example, package offer rule number four (4) illustrates a rule that provides that a product sold to a customer (e.g., a particular customer such as Customer A) as a mystery product within the past month may not be included in any inventory control groups (e.g., may not be included in a mystery package promotion). This may, for example, facilitate the actual and/or perceived unpredictability of the population of component products into mystery packages. Such a rule may be particularly useful in the case that a particular vending machine experiences sales that result in the same or similar products otherwise frequently being included in mystery promotions. Assume for purposes of this example, that

Moreover, a rule may provide that particular products are to be included in some, all or no inventory groups. For example, package offer rule number five (5), illustrates an example rule that requires Cheetos® to be included in both green and red inventory groups, regardless of value rating.

Thus, continuing with the ongoing example, Table 17, immediately below, illustrates the effect of the example package offer rules on the inventory group allocations:

TABLE 17
Exemplary Effect of Package Offer Rules

| | Percent | | | | |
|---|---|---|---|---|---|
| | of Ideal | Value | Initial | Rule | Applied |
| Product Name | Rate | Rating | Grouping | Results | Rule |
| Lay's ® Potato Chips | 113% | $.51 | Red | Neither | 3 |
| Diet Coke ® | 107% | $.48 | Red | Red | N/A |
| Coca-Cola ® | 92% | $.37 | Red | Neither | 4 |
| A&W Root Beer ® | 85% | $.26 | Green | Neither | 1 |
| Doritos ® | 88% | $.18 | Green | Red | N/A |
| Cheetos ® | 50% | $.15 | Green | Both | 5 |
| Double-Mint ® | 85% | $.13 | Green | Green | N/A |
| Juicy Fruit ® | 65% | $.10 | Green | Green | N/A |
| Dentyne ® | 42% | $.08 | Green | Green | N/A |

As shown, package offer rule number three (3), which functions to prevent packaging of products which have sales rates greater or equal to one hundred and ten percent (110%) of their target sales rates, precludes the inclusion in any package offer of Lay's® potato chips, which has an actual sales rate of one hundred and thirteen percent (113%) of its target sales rate (thus, Lay's® is included in “Neither” group). Also, Coca-Cola® is included in “Neither” group due to package offer rule number four (4), which prevents previsouly sold mystery items from being again sold as mystery items (e.g., to preserve actual and/or perceived “mystery”). Further, pursuant to package offer rule number five (5), Cheetos® is allocated to “Both” the red and green inventory groups, despite the initial value rating-based grouping of Cheetos® solely to the green inventory group. Additionally, considering package offer rule number one (1), A&W Root Beer®, a drink, cannot be included in the green inventory grouping because gum products preliminarily exist in the green inventory grouping as a result of the above-illustrated allocation based on value rating.

Thus, without yet considering package offer rule number two (2), the possible combinations of component products (i.e., the mystery package instances) are illustrated in Table 18, immediately below:

TABLE 18
Exemplary Possible Mystery Package Instances

| Product 1 (Red) | Product 2 (Green) |
|---|---|
| Diet Coke ® | Cheetos ® |
| Diet Coke ® | Double-Mint ® |
| Diet Coke ® | Juicy Fruit ® |
| Diet Coke ® | Dentyne ® |
| Cheetos ® | Cheetos ® |
| Cheetos ® | Double-Mint ® |
| Cheetos ® | Juicy Fruit ® |
| Cheetos ® | Dentyne ® |
| Doritos ® | Cheetos ® |
| Doritos ® | Double-Mint ® |
| Doritos ® | Juicy Fruit ® |
| Doritos ® | Dentyne ® |

Package offer rule number two (2), however, provides that the total margin of a package instance based on a one dollar ($1.00) package price cannot be equal to or less than fifty percent (50%) of the sum of the individual component product's margins. Analyzing all possible mystery package instances reveals, in the present example, that no possible mystery package instance violates rule number two (2). If Coca-Cola® had not been excluded under rule number four (40, however, the potential instance of Coca-Cola® and Cheetos® would violate rule number two (2) and thus be excluded. Thus, the vending control system would make an adjustment to the inventory group allocations so that Coca-Cola® is not offered with Cheetos®. Because, in this example, rule number five (5) provides that Cheetos® must be included in both the green and red inventory groups, Coca-Cola® may be removed from the red inventory group (e.g., if it hadn‘t’ been already due to rule number four (4)) so that Coca-Cola® cannot be dispensed to a customer along with Cheetos®, a green inventory product, pursuant to a mystery package promotion. Thus, in this ongoing example, Coca-Cola® would not be assigned to either inventory group (for violation of one or more rules). Accordingly, Coca-Cola® would not be included in any mystery promotion that is defined solely by inventory groups, and thus could not be selected by a customer as a component product pursuant to such a mystery package offer (e.g., such as via reactive grouping embodiments).

Thus, after preliminarily allocating the inventoried products in the ongoing example to red and/or green inventory groups based on their relative value ratings and then considering all the package offer rules in the exemplary package offer rules database (Table 16), the possible package instances, and the component products' inventory groupings in each instance, are as shown in Table 18, above.

According to some embodiments, the method 1800 may continue to output a mystery package offer at step 1806. After the inventoried products have been allocated to the inventory group(s), for example, the vending machine may output a mystery package offer to customers via one or more output devices. For example, an LCD display may read “Pick one red product and you will get one green product, both for $1.00!” or “For $1.00 get a mystery red product and a mystery green product”, and LED displays located proximately to several products may illuminate or flash in red and/or green as determined by the inventory groups. Following the ongoing example, the LED displays located proximately to the following products would flash in red: Diet Coke®, Doritos®, and Cheetos®. Additionally, the LED displays located proximately to the following products would flash in green: Dentyne®, Cheetos®, Double-Mint®, and Juicy Fruit®. Many methods are contemplated for communicating offers via output devices. For example, in one embodiment, mystery package offers may be communicated entirely through an LCD display (e.g., through digital icons representing the qualifying products). Alternatively, in another embodiment, a mystery package offer may be communicated through a combination of static displays (e.g., painted or printed signage reading “Get two mystery products for $1.00”) and LED displays located proximately to qualifying component products (e.g., LED devices next to qualifying products may flash in red and/or green as appropriate).

In some embodiments, the method 1800 may continue to process a transaction in accordance with the mystery package offer, at 1808. After a mystery package offer is output to a customer, a customer may accept such a package offer. Accordingly, at step 1808, the vending machine may receive, through an input device, an indication of a customer's acceptance of a mystery package offer. Such an indication may comprise the receipt of payment (e.g., currency, a payment identifier such as a credit card number) through payment processing mechanisms such as coin acceptors, bill validators and/or card readers.

In embodiments where a customer has prepaid for products, the “receipt of payment” for the offered products may comprise a command by the customer to redeem prepaid credit, units or the like. For example, the customer could enter, via a touch screen, a code that uniquely identifies his previous prepayment for a certain number of products (e.g., five units of any product and/or six units of any drink). Additionally or alternatively, the prepayment could be identified by a magnetic strip card or bar code that is read by a peripheral of the vending machine.

Alternatively or additionally, an indication of acceptance of the offer may comprise a signal, received through an input device such as a keypad or touch screen, indicating that the customer desires to purchase a combination of products pursuant to a mystery package offer (e.g., clicking a “YES” button on a touch screen).

In accordance with step 1808, a machine selects at least one product from one of at least two inventory groups. Following the ongoing example, the machine may select from the red inventory group either Diet Coke®, Doritos®, or Cheetos® by indicating a row position identifier A2, B1 or B3, respectively (from Table 13). After the machine selects a first product from the first inventory group, the machine may automatically determine a second product from a second inventory group. Following the ongoing example, the vending machine may select, from the green inventory group, a mystery product of either Dentyne®, Cheetos®, Double-Mint®, or Juicy Fruit® (e.g., by sending a signal indicating row position identifier C3, B3, C1 or C2, respectively).

At step 1808, the vending machine may also process payment in a conventional manner such as by (i) detecting an amount that is deposited, rendered, and/or provided, comparing that amount to a (mystery package) price, and dispensing change due if appropriate, or (ii) requesting a credit authorization from a remote computer, such as a computer operated by a credit card transaction processing company (e.g., First Data Corporation™).

Payment may have been previously rendered (e.g., five dollars ($5) was previously paid for the right to purchase five pairs of mystery products in the future). If so, and if the products pursuant to such prepayment are being redeemed in the transaction, many well known processes may be employed to debit the prepaid account for the redeemed products.

Further, at step 1808, depending on which products were selected by the machine, the vending machine control system may, in a manner known in the art, transmit one or more signals to a product dispensing apparatus to dispense the at least two (mystery) products. In one embodiment, dispensing signals are sent to corresponding product dispensing actuators and/or motors after the selection of a component product. In another embodiment, such dispensing signals are sent to corresponding product actuators and/or motors substantially immediately after each component product is determined, so that products are made available immediately following a selection and/or acceptance of the mystery package promotion.

In some embodiments, the method 1800 may continue at step 1810 to record results in a database. The vending machine may record results of the transaction in a database or similar memory structure. Step 1810 may include, for example, the step of (i) updating one or more inventory records in an inventory database to reflect the vending of products (i.e., the quantity available of products sold is decreased to account for sales of units of the products), and/or (ii) updating an acceptance or sales rate associated with a product or products to reflect the sale of a product or products (e.g., recording the units sold, the time of the sale and/or the date of the sale). Following the ongoing example, assuming that a customer on Jun. 25, 2003 (6/25/03) purchased, for a one dollar ($1.00) mystery package price, two mystery products that comprised one (1) can of Diet Coke® and one (1) package of Double-Mint® gum, then the inventory database would be updated to reflect that five (5) units of Diet Coke® and seventeen (17) units of Double-Mint® gum remain in inventory and available for sale. Likewise, the actual sales rates of Diet Coke® would be updated from one and two tenths products per day (1.2/day) to one and three tenths products per day (1.3/day), and/or the actual sales rate of Double-Mint® gum would be updated from two and two tenths products per day (2.2/day) to two and three tenths products per day (2.3/day). Thus, through the mystery package promotion, Diet Coke® would have reached its ideal sales rate of one and three tenths products per day (1.3/day), and the actual sales rate of Double-Mint® gum would have moved significantly closer to its ideal sales rate of two and six tenths products per day (2.6/day).

Updating inventory amounts and sales rate data advantageously provides the vending machine with updated market data (e.g., supply and demand data) that can be fruitfully exploited in subsequent executions of the processes of various embodiments. In other words, such updated inventory amounts and sales rates can be referenced subsequently by the vending machine control system in subsequently making definitions of inventory group (such as may be executed and/or utilized at any of steps 1802 and/or 1804, supra).

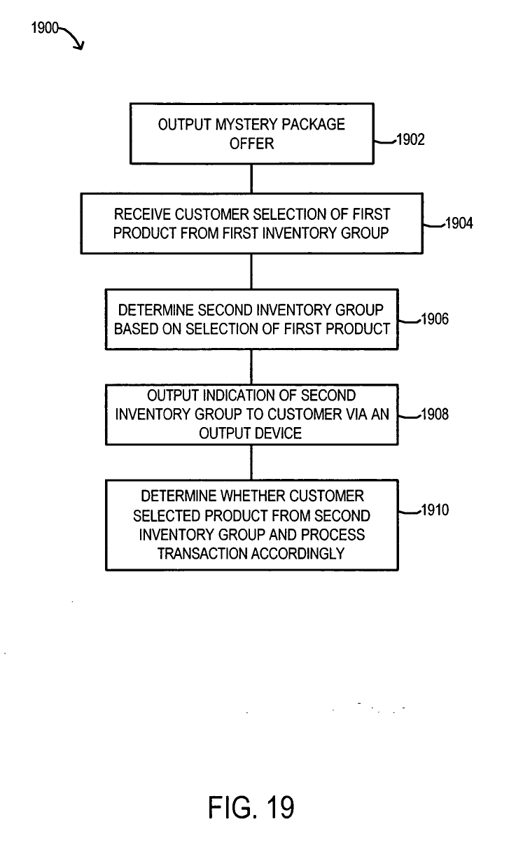

In another example of inventory grouping to form mystery package instances, a reactive inventory-grouping embodiment is described. Turning to FIG. 19, for example, a flow diagram of a method 1900 according to some embodiments is shown. The method 1900 may, for example, illustrate an exemplary reactive inventory grouping process. Of course, steps performed in a reactive inventory-grouping embodiment do not imply that those steps may only be performed in a reactive inventory-grouping embodiment.

### B. Reactive Inventory Grouping Embodiments

In some embodiments, the method 1900 may begin at 1902 to output a mystery package offer. The vending machine may output a mystery package offer to the customer, for example, regarding the availability of a mystery package deal. For example, an LCD display may output a message reading “Get 2 items for $1. Pick any item, and then a mystery product will be dispensed.” Alternatively, such a message may be provided through a static means (e.g., painted or printed signage).

According to some embodiments, the method 1900 may continue to receive customer selection of a first product from a first inventory group, at 1904. The vending machine control system may receive, via one or more input devices for example, a signal indicating a customers selection of a first product, and that product is determined to be included in a first inventory group. In some embodiments, this step may be accompanied or preceded by payment processing steps, including the receipt of currency.

According to some embodiments, the selection of a product by a customer may be determined to not be included in a requisite inventory group. If so, then subsequent steps of the instant process might not be performed and/or the customer may be promoted to re-select an appropriate product.

According to one embodiment, the first inventory group may comprise all inventoried products. Thus, according to such an embodiment, a customer may select any product in inventory as the first product. Thus the product selected might make no difference as to which products are included in the second inventory group.

However, according to another embodiment, the first inventory group may not include all products. In one embodiment, such a subset may be predetermined (e.g., defined by an operator and/or stored in a memory accessible to the vending machine control system). In another embodiment, the first inventory group may be determined (e.g., determined dynamically) to include products according to sale and/or cost data (and possibly stored rules or other logic mechanisms). Thus, for example, stored rules may provide that only those products selling at or less than a particular actual sales rate are to be included in the first inventory group. In this manner, the vending machine may be programmed to promote certain products in mystery and/or partial mystery package promotions (e.g., upon selection of a product which is not selling as well as desired).

In some embodiments, the method 1900 may continue to determine second inventory group based on selection of first product, at 1906. The vending machine may define, for example, a second inventory group based the customer's selection of a first product. In some embodiments, the vending machine employs one or more rules (e.g., stored package offer rules) to determine which products are potentially eligible to be included in the second inventory group based on the first product (which was selected by the customer, or which was selected automatically by the vending machine, as described herein). For example, a package offer rule may provide that products from competing manufacturers cannot be purchased together pursuant to a mystery package offer. Accordingly, the second inventory group would not include products that are manufactured by competitors of the manufacturer of the first, selected product. Alternatively or additionally, another package offer rule may provide that the second inventory group includes only products from categories that are “complementary” to the category of the first product. For example, if a customer were to select a drink as his first product, the vending machine second group may only include products from the snack and/or gum categories.

Further, a package offer rule may provide that, if the first selected product's actual sales rate is above a certain threshold, only products selling at or less than a predetermined actual sales rate are to be included in the second inventory group. In this manner, vending machines according to various embodiments may exploit the popularity of a well-selling product to promote the sale of (relatively) less popular products.

Conversely, a package offer rule may provide that, if the first selected product's actual sales rate is below a certain threshold, only products selling above a predetermined actual sales rate are to be included in the second inventory group. In this manner, vending machines according to various embodiments may prompt customers to choose a less popular product in the hopes of a good deal on a more popular product, with an element of chance involved.

Alternatively or additionally, a value rating of each possible second product may be considered, as described above. For example, the vending machine control system may determine the value rating of one or more products and determine, based on stored rules, that only the five (5) products having the highest value ratings may be included in the second inventory group. As in the case of the above-described proactive inventory grouping embodiments, the value rating of each possible second product may be determined, e.g., based on: (i) the product's margin, and/or (ii) the product's margin multiplied by its actual sales rate expressed as a percentage of its ideal sales rate.

In an embodiment, the second inventory group may determined before the customer selects the first product, but the second inventory group may generally only be revealed to the customer after the first product is selected.

In an embodiment, a plurality of second inventory groups may be determined. Thus, selection of a product included in any of the second inventory groups would be acceptable. Depending on which of the second groups the second product is included in, different actions may be taken (e.g., awarding bonus products or credits, providing entertaining displays or sounds). Thus an entertaining set of interactions can result from differentiating between acceptable second products.

According to some embodiments, the method 1900 may continue at step 1908 to output an indication of the second inventory group to the customer via output device. After the second inventory group is determined, for example, an indication of the products included in the second inventory group is output at step 1908 to the customer via one or more output devices. For example, LED devices located proximately to the products may illuminate or flash. Alternatively or additionally, an LCD device may output graphical icons representing the qualifying products included in the second inventory group. In some embodiments, step 1908 may not be required and/or desired. Since the customer may automatically receive a mystery product from the second inventory group, for example, it may not be necessary to display the composition of the group to the customer. In embodiments that include the following step 1910, however, it may be advantageous to display the group composition to the customer.

In step 1910, for example, the vending machine may determine whether the customer selected a second product from second inventory group, and process the transaction accordingly. While the step 1910 may certainly not be practiced in the case that a mystery product from the second (and/or first inventory group) is automatically selected for and provided to the customer, it may be desirable to cause the customer to believe that the customer's input is utilized in determining a mystery product. In the case that the customer is provided with an indication of the composition of the second (and/or first) inventory group, for example, the customer may be presented with an interface, such as a game interface, with which the customer may make a selection.

Accordingly, at step 1910, it is determined whether the customer selected the second product from the second inventory group. If the customer has selected a second product from the second inventory group by, for example, transmitting a signal to the vending machine processor via an input device such as a keypad, then the vending machine processor may utilize such information to, for example, seed a random number generator that will determine which product from the second inventory group will be provided to the customer. In some embodiments, the customer's input may not be utilized at all, and stored rules may instead be fully utilized to select a second mystery product.

The vending machine may then, for example, actuate a product dispensing apparatus to dispense units of the first and second products. Alternatively, the vending machine control system may dispense a unit of the first product upon its selection at step 1904, and dispense a unit of the second product at step 1910, once it has been determined which product from the second inventory group will be dispensed.

In some embodiments, step 1910 may be accompanied by payment processing steps, such as the receipt of payment and the dispensing of appropriate change (e.g., based on the difference between any payment tendered and the mystery package price). It should be noted that such an embodiment would allow customers to select first products before depositing any currency, and then see which products are available as second (mystery) products before committing to purchase any products whatsoever. In this manner, any anxiety caused to customers by virtue of the uncertain composition of the second inventory group can be reduced or eliminated.

If any products are dispensed at step 1910 (and/or earlier in the method 1900, according to some embodiments), the vending machine may, as described above, record results of the transaction in a database or similar memory structure (e.g., update inventory records), as appropriate.

### C. Alternate Embodiments

1. Expected Profitability Grouping

In another proactive inventory grouping embodiment, products are allocated to inventory groups based on the expected or predicted profitability of each possible “inventory allocation”. In other words, unlike the some previously-described embodiments in which there are a predetermined or fixed number of product “slots” in each inventory group (e.g., per a stored rule), this embodiment allocates products to inventory groups by evaluating the expected profitability of each possible allocation of products (e.g., to at least two inventory groups).

For example, in a vending machine configured to sell four (4) products (e.g., Products A, B, C and D) in mystery package deals from two (2) inventory groups (e.g., red and green), in which all products are allocated to exactly one (1) inventory group and an inventory group must contain at least one (1) product, there are fourteen (14) possible inventory allocations, as illustrated by Table 19, immediately below:

TABLE 19
Exemplary Inventory Group Allocations

| Allocation Number | Group 1 (Red) | Group 2 (Green) |
|---|---|---|
| 1 | A | B, C, D |
| 2 | A, B | C, D |
| 3 | A, C | B, D |
| 4 | A, D | B, C |
| 5 | A, B, C | D |
| 6 | A, B, D | C |
| 7 | A, C, D | B |
| 8 | B | A, C, D |
| 9 | B, C | A, D |
| 10 | B, D | A, C |
| 11 | B, C, D | A |
| 12 | C | A, B, D |
| 13 | C, D | A, B |
| 14 | D | A, B, C |

As stated, the expected profitability of each possible allocation would be determined. Then, the vending machine control system would select the possible allocation with the highest expected profitability, and communicate a mystery package offer accordingly. For example, if it was determined that allocation number fourteen (14) (in which product D is in the red inventory group and products A, B and C are in the green inventory group) is expected to be the most profitable, the vending machine may flash LED proximately located to each of the corresponding products in the appropriate colors to indicate that allocation of products to the two inventory groups. In a case such as the present example where groups may comprise few products and a “mystery” selection of product would therefore be relatively easily determinable by a customer, other products in addition to those actually included in the groups may be displayed as potential group members to the customer to facilitate the preservation of the “mystery”. Similarly, as described herein, the customer may not be provided with grouping information, such that the dispensed products are likely to be relatively unpredictable to the customer.

There are many ways that the expected profitability of an allocation may be determined. According to one embodiment, the expected profitability of a given allocation may be determined by summing the expected profitability of each possible combination instance within that particular allocation. Thus, in the allocation in which Product D is in the red inventory group and Products A, B and C are in the green inventory group, the expected profitability for the instances “D with A”, “D with B”, and “D with C” would be individually determined and then added together to determine the total expected profitability of the allocation.

To determine the expected profitability of each instance within a given allocation, a variety of techniques may be employed. According to one embodiment, the expected profitability of a given instance is determined by multiplying the probability that the instance will be accepted within a given period (e.g., within twenty-four (24) hours) by the margin of the mystery package instance (e.g., the mystery package price less the cost of the component products). In such an embodiment, the probability that a given instance will be selected may be determined based on a stored, received or calculated “acceptance rate” for the instance.

2. Multiple Package Offers

In some proactive inventory grouping embodiments, vending machines may be configured to simultaneously (or substantially simultaneously) output a plurality of mystery package offers. Thus, after inventory groups are defined, the vending machine may output mystery package offers that apply to the inventory groups. For example, for particular inventory groups, an offer may provide customers with the ability to choose which of the following to purchase:

(a) two (2) products for a first inventory group for a first package price (e.g., two (2) products from a “snack” inventory group for one dollar and fifty cents ($1.50)),

(b) one (1) product from a first inventory group and one (1) product from a second inventory group for a second package price (e.g., one (1) product from a “snack” inventory group and one (1) product from a “drink” inventory group for one dollar and twenty-five cents ($1.25)), and/or

(c) two (2) products from a second inventory group for a third package price (e.g., two (2) products from a “drink” inventory group for one dollar ($1.00)).

Any number of offers for mystery promotions may be output simultaneously or substantially simultaneously.

In one embodiment, offers are not output simultaneously, but are instead triggered by an event. For example, a single offer may be output after a customer provides payment (e.g., inserts currency). If the customer does not select any product within a certain amount of time (e.g., within twenty (20) seconds of inserting currency and/or within twenty (20) seconds of the offer being provided) then additional offers may be provided. In such an embodiment, the initial offer may be the most profitable but possibly less desirable to the typical customer (e.g., a relatively high package price and/or comprising high margin component products), and subsequent offers are less profitable, but more desirable to the customer (e.g., a relatively low package price with low margin component products). In one embodiment, different sets of offers may be output at different times, according to various desirable factors described herein.

3. Cross-Machine Promotions

As stated, various embodiments can be configured to work in conjunction with two or more vending machines. Thus, according to some embodiments, pursuant to a mystery package promotion, customers may purchase two or more (mystery) products for a single price, and may select and/or retrieve products from two or more vending machines.

Thus, a customer may view the inventory of two machines (which may be proximately-located), and may accept an offer output from a first machine or output from a peripheral device. The peripheral device may be stand-alone or integrated with one or more of the vending machines. The peripheral may communicate with one or more of the vending machines in any of a number of well-known manners.

The vending machine or peripheral device may output a code, password, Personal Identification Number (PIN), receipt or other substantially unique identifier to the customer. This identifier may be redeemed at a participating vending machine, allowing the customer to retrieve products from one or more of the participating machines.

For example, after allocating inventoried products to at least two inventory groups spanning at least two machines using the above-disclosed methods, a first vending machine may output an offer reading “2 for $1! Get 1 mystery product from this machine AND any 1 mystery product from the adjoining machine, for $1.” LED devices located proximately to the qualifying products may flash (e.g., after acceptance of the mystery promotion), according to some embodiments. While in some embodiments, the entire inventory of each machine (and/or of the machines collectively may define the groups from which products may be selected and/or from which the customer is aware that products may be selected). A customer may then (e.g., after seeing the flashing products) decide to accept the mystery package offer and deposit one dollar ($1.00) into the first machine. The machine may then select a first product from the first vending machine (or one may be picked by the customer), and the first vending machine may then output a (substantially-unique) bar code on a piece of paper (e.g., printed by an on-board printer, preprinted stock dispensed by a dispensing device).

The customer could then be instructed, through the first vending machine's output device, to insert the piece of paper into a reader (e.g., ticket reader, bill acceptor, card reader, bar code reader) which is attached to or in communication with the second machine when the customer is ready to receive the second (mystery) product. Upon presenting the piece of paper (e.g., into the card reader), the second vending machine's processor would validate the code by querying either a local database (e.g., of previously agreed-upon codes) or a remote database (e.g., created and stored by the first machine). The second vending machine could then present to the customer the same inventory group as originally advertised at the time of the offer. Thus, the customer may return to receive the second product at a later time (even after the second vending machines inventory has been reallocated to new inventory groupings), and the second vending machine could revert back to or recall the previous inventory grouping in effect at the time of the offer. This would allow the customer to take advantage of any options that were originally presented (e.g., the products that were previously flashing in red are returned to red status upon presentment of the bar code identifier). In some embodiments, the vending machines may be in communication and/or may store a customer identifier or a code identifier (e.g., associated with the promotion accepted by the customer) such that the customer may simply need to provide identification indicia to one of the machines to trigger the dispensing of the second product (and/or to perform other actions associated with previous purchases, payment options, etc.).

An apparatus and method for processing the sale of two products from two vending machines for a single price is disclosed with reference to U.S. Pat. No. 6,059,142 (to Wittern, Jr., et al.), such concepts and descriptions of which are incorporated herein.

4. Display of Retail Prices

In an embodiment, retail prices are not automatically communicated by output devices to customers. Instead, a customer must affirmatively inquire as to the retail price of a particular product. In this manner, customers are encouraged to accept mystery (and/or other) package offers, which are actively promoted by the vending machine's output devices. However, in other embodiments, the retail prices of the individual products may be communicated contemporaneously with the presentation of mystery package offers.

In an embodiment, customers may be permitted or required to select between various modes, such as “retail”, “package”, and/or “mystery” modes, before transacting with the vending machine. That is, before selecting and purchasing any products, a customer may press a button on a touch screen or otherwise indicate whether the customer would like to (i) purchase a package (e.g., two (2) products for one dollar ($1.00)), (ii) purchase one (1) product for that product's retail price, and/or (iii) purchase one or more mystery products for a pre-defined price (such as equivalent to the value of the customer's change due).

5. Inventory Group Opt-Out

In an embodiment, customers may be offered the option to pay a premium so that they can purchase two or more products from the same inventory group, rather than one from each. For example, a message on a vending machine's touch screen might read: “Want two red items? Add $0.25.” In essence, such an embodiment would give the customer the ability to buy themselves out of the predefined inventory groups and would thereby ensure that customers are given more choice (and/or more perceived choice).

6. Transaction Status

In an embodiment in which customers are permitted to choose one or more products associated with a mystery package price, one or more output devices may be configured to communicate the status of a transaction to a customer. For example, after a customer selects a first product, an indication of the first product may be communicated to the customer via an output device (e.g., an icon of the selected first product may appear on an LCD display). Further, instructions regarding the selection of a second product, if such selection is allowed and/or practicable, may be communicated through such output devices. That is, after a customer has selected a first product from a first inventory group, a message may be output to the customer that the machine will select a second product from a second inventory group. For example, after selecting a product from a first inventory group (e.g., a product on a first shelf; a product indicated by a “green” flashing light), the machine may pick a product from a second inventory group (e.g., a product on a second shelf; a product indicated by a “red” flashing light). Similarly, in the case where the customer is allowed to pick a first product (such as from a first inventory group) and then allowed to pick one of a plurality secondary inventory groups from which a mystery product will be automatically selected, the customer may be instructed how to proceed to select an available mystery group.

7. Mystery Package Offer Row

In an embodiment, a vending machine may be configured to dispense two (2), or more, products from a particular row or other particular location for a single price. Thus, one or more rows of a vending machine may be designated as a “mystery package offer” row, and the vending machine may be configured to consecutively dispense, from such a row, units of two (2), or more, products upon tender of a mystery package price and/or selection of a corresponding row identifier (e.g., “A1” may correspond to a mystery package offer row which provides one unit of a Snickers® candy bar and one unit of a mystery product—presumably hidden by the candy bar—for one dollar ($1.00)). Further, such “mystery package offer” rows may be configured to prevent the dispensing of single units of product for retail prices (i.e., such rows may be exclusively used for mystery package offers).

A mystery package offer row may be stocked with alternating and/or varying types of products. For example, a Snickers® candy bar may be followed by a Milky Way® candy bar, which is followed by a Three Musketeers® candy bar, etc. Thus, purchasing from such a mystery package offer row can allow diverse combinations of products. Further, such combinations may be hidden from the customer (e.g., only the first product may be displayed) to facilitate the “mystery” of a package deal.

In such embodiments, a vending machine may be configured to dispense two (2), or more, products from a first row for a single price, while dispensing only one (1) product from a second row for a single price. Alternatively, every row in a vending machine may be configured as a “mystery package offer” row.

8. Package Compositions

While the examples herein have primarily described standard vending machine products such as snacks and drinks, it should be understood that any type or configuration of product or service that is or becomes known or practicable may be provided by vending machines operating in accordance with embodiments described herein. Various promotions may, for example, comprise a combination of product types. A customer may accept a partial mystery promotion, for example, where the customer selects a drink and receives a “Top 40” music file for a single package price. Similarly, a mystery, partial mystery, and/or non-mystery package may comprise any number of snacks, drinks, candy, electronic media, toys, objects, and/or services. In some embodiments, packages may comprise free game plays, such as may be redeemable at a game interface provided by the vending machine, in an arcade (e.g., near the vending machine), and/or at a professional gaming establishment (casino, etc.). In the mystery product and/or package context, the customer may not even know the type of mystery product to be received. A mystery package may comprise, for example, a soda and a music download, two drinks, a candy bar and a free spin at a game interface, and/or other combinations, that may be revealed only after the purchase of the package for one dollar ($1.00),

### X. RULES OF INTERPRETATION

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention that must be present in all embodiments.

Neither the Title (set forth at the beginning of the first page of this patent application) nor the Abstract (set forth at the end of this patent application) is to be taken as limiting in any way as the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices which are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this patent application and the title of this patent application are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” means any one or more microprocessors, CPU devices, computing devices, microcontrollers, digital signal processors, or like devices.

The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
determining a mystery package, wherein the mystery package comprises at least two mystery products having individual respective prices, and wherein the at least two mystery products are selected based at least in part on sales data associated with a plurality of products sold via a vending machine;
determining a price for the mystery package, wherein the price for the mystery package is different than the sum of the individual respective prices of the at least two mystery products;
offering the mystery package for the determined mystery package price to a customer of the vending machine, wherein the identities of the at least two mystery products comprising the mystery package are concealed from the customer;
receiving an indication of an acceptance of the mystery package offer by the customer; and
dispensing the at least two mystery products to the customer.

2. The method of claim 1, further comprising:
determining first and second positions, respectively, of the at least two mystery products within the vending machine; and
determining a relation between the first and second positions.

3. The method of claim 2, wherein the relation between the first and second positions comprises at least one of a distance or an orientation.

4. The method of claim 2, wherein in the case that the relation satisfies a pre-defined condition, the dispensing comprises:
dispensing a first one of the at least two mystery products from the first position;
determining the occurrence of an event; and
dispensing, based at least upon the occurrence of the event, a second one of the at least two mystery products from the second position.

5. The method of claim 4, wherein the event comprises at least one of (i) a dispensing of the first one of the at least two mystery products into a product hopper, (ii) a removal of the first one of the at least two mystery products from the product hopper, (iii) an elapse of a pre-determined amount of time, and (iv) receipt of an indication from the customer.

6. The method of claim 4, wherein the pre-defined condition comprises at least one of (i) a minimum distance between the first and second positions, (ii) a maximum distance between the first and second positions, (iii) a range of distances between the first and second positions, (iv) one or more pre-determined orientations between the first and second positions, and (v) a likelihood that the at least two mystery products will collide in the case they are dispensed from the first and second positions.

7. The method of claim 2, wherein in the case that the relation satisfies a pre-defined condition, the dispensing comprises:
determining a third position associated with a first one of the at least two mystery products;
dispensing the first one of the at least two mystery products from the third position; and
dispensing a second one of the at least two mystery products from the second position.

8. The method of claim 1, wherein the at least two mystery products are selected based on a sales metric comprising at least one of (i) a profitability metric, (ii) a revenue metric, (iii) a minimum acceptable product price metric, (iv) a product demand metric, (v) a sales rate metric, (vi) an inventory metric, and (vii) an expiration date metric.

9. The method of claim 8, wherein the plurality of products sold via the vending machine are ranked according to the sales metric and wherein a first one of the at least two mystery products is selected from a top tier of the sales metric ranking and a second one of the at least two mystery products is selected from a bottom tier of the sales metric ranking.

10. The method of claim 9, wherein the first one of the at least two mystery products is selected randomly from the top tier of the sales metric ranking.

11. The method of claim 9, wherein the second one of the at least two mystery products is selected randomly from the bottom tier of the sales metric ranking.

12. The method of claim 9, wherein the first one of the at least two mystery products is selected in a round-robin fashion from the top tier of the sales metric ranking.

13. The method of claim 9, wherein the second one of the at least two mystery products is selected in a round-robin fashion from the bottom tier of the sales metric ranking.

14. The method of claim 9, wherein the sales metric comprises the profitability metric and the ranking comprises a profitability ranking.

15. The method of claim 14, wherein the top tier of the profitability ranking comprises a first portion of the plurality of products that are associated with approximately forty-percent of the highest profitability rankings and the bottom tier of the profitability ranking comprises a second portion of the plurality of products that are associated with approximately forty-percent of the lowest profitability rankings

16. The method of claim 1, wherein one of the at least two mystery products comprises a game play.

17. The method of claim 16, wherein the game play comprises a play of a game, the game comprising at least one of (i) a game of skill, (ii) a game of chance, or (iii) a combined game of skill and chance.

18. The method of claim 17, wherein the game may be played by the customer via the vending machine.

19. The method of claim 1, wherein one of the at least two mystery products comprises a music file download.

20. The method of claim 1, wherein the at least two mystery products are individually packaged.

21. The method of claim 1, further comprising:
selecting the at least two mystery products from the plurality of products sold via the vending machine.

22. The method of claim 21, further comprising:
determining an identity of the customer.

23. The method of claim 22, wherein the determining of the identity of the customer comprises:
receiving an indication of at least one of a code associated with the customer and biometric information associated with the customer.

24. The method of claim 22, wherein a first one of the at least two mystery products is selected based at least in part on the identity of the customer.

25. The method of claim 24, wherein the first one of the at least two mystery products is selected based on at least one of (i) a previous purchase made by the customer, (ii) a previous product selection made by the customer, (iii) a demographic of the customer, and (iv) an environmental factor.

26. The method of claim 22, further comprising:
determining one or more previous mystery products supplied to the customer; and
preventing the one or more previously supplied mystery products from being included in the mystery package.

27. A method, comprising:
determining a mystery package, wherein the mystery package comprises a first mystery product and a second mystery product;
determining a price for the mystery package;
offering the mystery package for the determined mystery package price to a customer of a vending machine, wherein the identity of the first and second mystery products comprising the mystery package is concealed from the customer;
receiving an indication of an acceptance of the mystery package offer by the customer;
determining a first position within the vending machine of the first mystery product and a second position within the vending machine of the second mystery product; and
determining whether a relation between the first and second positions satisfies a pre-determined condition.

28. The method of claim 27, further comprising:
dispensing the first and second mystery products to the customer.

29. The method of claim 28, wherein the relation between the first and second positions comprises at least one of a distance or an orientation.

30. The method of claim 28, wherein in the case that the relation is determined to satisfy the pre-defined condition, the dispensing comprises:
dispensing the first mystery product from the first position;
determining the occurrence of an event; and
dispensing, based at least upon the occurrence of the event, the second mystery product from the second position.

31. The method of claim 30, wherein the event comprises at least one of (i) a dispensing of the first mystery product into a product hopper, (ii) a removal of the first mystery product from the product hopper, (iii) an elapse of a pre-determined amount of time, and (iv) receipt of an indication from the customer.

32. The method of claim 30, wherein the pre-defined condition comprises at least one of (i) a minimum distance between the first and second positions, (ii) a maximum distance between the first and second positions, (iii) a range of distances between the first and second positions, (iv) one or more pre-determined orientations between the first and second positions, and (v) a likelihood that the first and second mystery products will collide in the case they are dispensed from the first and second positions.

33. The method of claim 28, further comprising:
determining a third position associated with the first mystery product.

34. The method of claim 33, wherein the determining of whether the relation between the first and second positions satisfies the pre-determined condition comprises:
determining a first probability of whether the first and second mystery products will collide when dispensed from the first and second positions, respectively;
determining a second probability of whether the first and second mystery products will collide when dispensed from the third and second positions, respectively; and
selecting one of the first and third positions which is associated with the smallest of the first and second probabilities, respectively.

35. The method of claim 34, wherein the dispensing, comprises:
dispensing the first mystery product from the selected position; and
dispensing the second mystery product from the second position.

36. A method, comprising:
determining a mystery package, wherein the mystery package comprises a first mystery product and a second mystery product, the first and second mystery products selected based at least in part on sales data associated with a plurality of products sold via a vending machine;
determining a price for the mystery package;
offering the mystery package for the determined mystery package price to a customer of the vending machine, wherein the identities of the first and second mystery products comprising the mystery package are concealed from the customer;
receiving an indication of an acceptance of the mystery package offer by the customer; and
dispensing the first and second mystery products to the customer.

37. The method of claim 36, wherein the first and second mystery products are selected based on a sales metric comprising at least one of (i) a profitability metric, (ii) a revenue metric, (iii) a minimum acceptable product price metric, (iv) a product demand metric, (v) a sales rate metric, (vi) an inventory metric, and (vii) an expiration date metric.

38. The method of claim 37, wherein the plurality of products sold via the vending machine are ranked according to the sales metric and wherein first mystery product is selected from a top tier of the sales metric ranking and the second mystery product is selected from a bottom tier of the sales metric ranking.

39. The method of claim 38, wherein the first mystery product is selected randomly from the top tier of the sales metric ranking.

40. The method of claim 38, wherein the second mystery product is selected randomly from the bottom tier of the sales metric ranking.

41. The method of claim 38, wherein the first mystery product is selected in a round-robin fashion from the top tier of the sales metric ranking.

42. The method of claim 38, wherein the second mystery product is selected in a round-robin fashion from the bottom tier of the sales metric ranking.

43. The method of claim 38, wherein the sales metric comprises the profitability metric and the ranking comprises a profitability ranking.

44. The method of claim 43, wherein the top tier of the profitability ranking comprises a first portion of the plurality of products that are associated with approximately forty-percent of the highest profitability rankings and the bottom tier of the profitability ranking comprises a second portion of the plurality of products that are associated with approximately forty-percent of the lowest profitability rankings.

45. The method of claim 36, wherein the first mystery product comprises a game play.

46. The method of claim 45, wherein the game play comprises a play of a game, the game comprising at least one of (i) a game of skill, (ii) a game of chance, or (iii) a combined game of skill and chance.

47. The method of claim 46, wherein the game may be played by the customer via the vending machine.

48. The method of claim 36, wherein the first mystery product comprises a music file download.

49. The method of claim 36, wherein the first and second mystery products are individually packaged.

50. The method of claim 36, further comprising:
selecting the first and second mystery products from the plurality of products sold via the vending machine.

51. The method of claim 50, further comprising:
determining an identity of the customer.

52. The method of claim 51, wherein the determining of the identity of the customer comprises:
receiving an indication of at least one of a code associated with the customer and biometric information associated with the customer.

53. The method of claim 51, wherein the first mystery product is selected based at least in part on the identity of the customer.

54. The method of claim 53, wherein the first mystery product is selected based on at least one of (i) a previous purchase made by the customer, (ii) a previous product selection made by the customer, (iii) a demographic of the customer, and (iv) an environmental factor.

55. The method of claim 51, further comprising:
determining one or more previous mystery products supplied to the customer; and
preventing the one or more previously supplied mystery products from being included in the mystery package.

56. The method of claim 36, wherein the dispensing reveals the identifies of the first and second mystery products to the customer.
